(19) United States
(12) Patent Application Publication
(10) Pub. No.: US 2010/0251691 A1
(43) Pub. Date: Oct. 7, 2010

(54) FIFTH-FORCE APPARATUS AND METHOD FOR PROPULSION

(76) Inventor: Randell L. Mills, Princeton, NJ (US)

Correspondence Address: LAHIVE & COCKFIELD, LLP;FLOOR 30, SUITE 3000, ONE POST OFFICE SQUARE, BOSTON, MA, 02109, US

(21) Appl. No.: 12/669,117

(22) PCT Filed: Oct. 22, 2007
(86) PCT No.: PCT/US07/82074

§ 371 Date: Jan. 14, 2010

Related U.S. Application Data
(60) Provisional application No. 60/956,443, filed on Aug. 17, 2007.
(60) Provisional application No. 60/957,568, filed on Aug. 23, 2007.
(60) Provisional application No. 60/970,062, filed on Sep. 5, 2007.
(60) Provisional application No. 60/980,872, filed on Oct. 18, 2007.

(51) Int. Cl. F03H 99/00

(52) U.S. Cl. 60/202

(57) ABSTRACT

A method and means to produce a force for propulsion comprises a source of electrons and a means to produce hyperbolic electrons; whereas, a gravitating body such as the Earth provides a repulsive fifth force on the hyperbolic electrons. Hyperbolic electrons are produced by elastically scattering the electrons of an electron beam from atoms or molecules at specific energies. The emerging beam of hyperbolic electrons experiences a fifth force away from the Earth, and the beam moves upward (away from the Earth). To use this invention for propulsion, the repulsive fifth force on the hyperbolic-electron beam is transferred to a negatively charged plate. The Coulombic repulsion between the beam of hyperbolic electrons and the negatively charged plate causes the plate (and anything connected to the plate) to lift. The craft may additionally gain angular momentum from the fifth force along an axis defined by the gravitational force, and the craft may be tilted to move the vector away from the axis such that a component of acceleration tangential to the surface of a gravitating body is achieved via conservation of the angular momentum.

### BACKGROUND OF THE INVENTION

1. Field of the Invention

This invention relates to methods and apparatus for providing propulsion, in particular methods and apparatus for providing propulsion using a scattered electron beam at specific energies to create a fifth force on said electrons.

### REFERENCE TO EQUATIONS FIGURES AND SECTIONS

The equations other than those beginning with the prefix 35 (i.e. of the form Eq. (35.#) figures with a prefix number (i.e. of the form #.#) and sections other than those disclosed herein refer to those of Mills GUT [R. Mills, The Grand Unified Theory of Classical Quantum Mechanics; October 2007 Edition, posted at http://www.blacklightpower.com/theory/bookdownload.shtml] which is herein incorporated by reference in its entirety.

### GENERAL CONSIDERATIONS

The physical basis of the equivalence of inertial and gravitational mass of fundamental particles is given in the Equivalence of Inertial and Gravitational Masses Due to Absolute Space and Absolute Light Velocity section wherein spacetime is Riemannian due to a relativistic correction to spacetime with particle production. The Schwarzschild metric gives the relationship whereby matter causes relativistic corrections to spacetime that determines the curvature of spacetime and is the origin of gravity. Matter arises during particle production from a photon and comprises mass and charge confined a two dimensional surface. Matter of fundamental particles such as an electron has zero thickness. But, in order that the speed of light is a constant maximum in any frame including that of the gravitational field that propagates out as a light-wave front at particle production, the production event gives rise to a spacetime dilation equal to 2π times the Newtonian gravitational or Schwarzschild radius

$${r}_{g} = \frac{2 {Gm}_{e}}{{c}^{2}} = 1.3525 \times {10}^{- 57} m$$

of the particle according to Eqs. (32.36) and (32.140b) and the discussion at the footnote after Eq. (32.40). For the electron, this corresponds to a spacetime dilation of 8.4980×10⁻⁵⁷ m or 2.8346×10⁻⁶⁵ s. Although the electron does not occupy space in the third spatial dimension, its mass discontinuity effectively “displaces” spacetime wherein the spacetime dilation can be considered a “thickness” associated with its gravitational field. Matter and the motion of matter effects the curvature of spacetime which in turn influences the motion of matter. Consider the angular motion of matter of a fundamental particle. The angular momentum of the photon is . An electron is formed from a photon, and it can only change its bound states in discrete quantized steps caused a photon at each step. Thus, the electron angular momentum is always quantized in terms of . But this intrinsic motion comprises a two-dimensional velocity surface of the motion of the matter through space that may be positively curved, flat, or negatively curved. The first and second cases correspond to the bound and free electron, respectively. The third case corresponds to an extraordinary state of matter called a hyperbolic electron given infra. Due to interplay between the motion of matter and spacetime in terms of their respective geometries, only in the first case is the inertial and gravitational masses of the electron equivalent. In the second case, the gravitational mass is zero, and in the third case, the gravitational mass is negative in the equations of extrinsic or translational motion. The negative gravitational mass of a fundamental particle is the basis of and is manifested as a fifth force that acts on the fundamental particle in the presence of a gravitating body in a direction opposite to that of the gravitational force with far greater magnitude.

The two-dimensional nature of matter permits the unification of subatomic, atomic, and cosmological gravitation. The theory of gravitation that applies on all scales from quarks to cosmos as shown in the Gravity section is derived by first establishing a metric. A space in which the curvature tensor has the following form:

R_{μv,αβ}=K·(g_{vα}g_{μβ}−g_{μα}g_{vβ}) (35.1)

is called a space of constant curvature; it is a four-dimensional generalization of Friedmann-Lobachevsky space. The constant K is called the constant of curvature. The curvature of spacetime results from a discontinuity of matter having curvature confined to two spatial dimensions. This is the property of all matter at the fundamental-particle scale. Consider an isolated bound electron comprising an orbitsphere with a radius rₙ as given in the One-Electron Atom section. For radial distances, r, from its center with r<rₙ, there is no mass; thus, spacetime is flat or Euclidean. The curvature tensor applies to all space of the inertial frame considered; thus, for r<rₙ, K=0. At r=rₙ there exists a discontinuity of mass in constant motion within the orbitsphere as a positively curved surface. This results in a discontinuity in the curvature tensor for radial distances ≧rₙ. The discontinuity requires relativistic corrections to spacetime itself. It requires radial length contraction and time dilation corresponding to the curvature of spacetime. The gravitational radius of the orbitsphere and infinitesimal temporal displacement corresponding to the contribution to the curvature in spacetime caused by the presence of the orbitsphere are derived in the Gravity section.

The Schwarzschild metric gives the relationship whereby matter causes relativistic corrections to spacetime that determines the curvature of spacetime and is the origin of gravity. The correction is based on the boundary conditions that no signal can travel faster than the speed of light including the gravitational field that propagates following particle production from a photon wherein the particle has a finite gravitational velocity given by Newton's Law of Gravitation. The separation of proper time between two events x^{μ} and x^{μ}+dx^{μ} given by Eq. (32.38), the Schwarzschild metric [1-2], is

$$d {τ}^{2} = ( 1 - \frac{2 {Gm}_{0}}{{c}^{2} r} ) {dt}^{2} - \frac{1}{{c}^{2}} [ \begin{matrix}{( 1 - \frac{2 {Gm}_{0}}{{c}^{2} r} )}^{- 1} {dr}^{2} + \\ {r}^{2} d {θ}^{2} + {r}^{2} {sin}^{2} θ d {φ}^{2}\end{matrix} ] \qquad ( 35.2 )$$

Eq. (35.2) can be reduced to Newton's Law of Gravitation for r_{g}, the gravitational radius of the particle, much less than r_{α}*, the radius of the particle at production

$$( \frac{{r}_{g}}{{r}_{a}^{*}} << 1 ) ,$$

where the radius of the particle is its Compton wavelength bar (rₐ*=λ_{c}):

$$F = \frac{{Gm}_{1} {m}_{2}}{{r}^{2}} \qquad ( 35.3 )$$

where G is the Newtonian gravitational constant. Eq. (35.2) relativistically corrects Newton's gravitational theory. In an analogous manner, Lorentz transformations correct Newton's laws of mechanics.

The effects of gravity preclude the existence of inertial frames in a large region, and only local inertial frames, between which relationships are determined by gravity are possible. In short, the effects of gravity are only in the determination of the local inertial frames. The frames depend on gravity, and the frames describe the spacetime background of the motion of matter. Therefore, differing from other kinds of forces, gravity which influences the motion of matter by determining the properties of spacetime is itself described by the metric of spacetime. It was demonstrated in the Gravity section that gravity arises from the two spatial dimensional mass-density functions of the fundamental particles.

It is demonstrated in the One-Electron Atom section that a bound electron is a two-dimensional spherical shell—an orbitsphere. On the atomic scale, the curvature, K, is given by

$$\frac{1}{{r}_{n}^{2}} ,$$

where rₙ is the radius of the radial delta function of the orbitsphere. The velocity of the electron is a constant on this two-dimensional sphere. It is this local, positive curvature of the electron that causes gravity due to the corresponding physical contraction of spacetime due to its presence as shown in the Gravity section. It is worth noting that all ordinary matter, comprised of leptons and quarks, has positive curvature. Euclidean plane geometry asserts that (in a plane) the sum of the angles of a triangle equals 180°. In fact, this is the definition of a flat surface. For a triangle on an orbitsphere the sum of the angles is greater than 180°, and the orbitsphere has positive curvature. For some surfaces the sum of the angles of a triangle is less than 180°; these are said to have negative curvature.

| sum of angles of triangles | type of surface |
|---|---|
| >180° | positive curvature |
| =180° | flat |
| <180° | negative curvature |

The measure of Gaussian curvature, K, at a point on a two-dimensional surface is

$$K = \frac{1}{{r}_{1} {r}_{2}} \qquad ( 35.4 )$$

the inverse product of the radius of the maximum and minimum circles, r₁ and r₂, which fit the surface at the point, and the radii are normal to the surface at the point. By a theorem of Euler, these two circles lie in orthogonal planes. For a sphere, the radii of the two circles of curvature are the same at every point and are equivalent to the radius of a great circle of the sphere. Thus, the sphere is a surface of constant curvature;

$$K = \frac{1}{{r}^{2}} \qquad ( 35.5 )$$

at every point. In case of positive curvature of which the sphere is an example, the circles fall on the same side of the surface, but when the circles are on opposite sides, the curve has negative curvature. A saddle, a cantenoid, and a pseudosphere are negatively curved. The general equation of a saddle is

$$z = \frac{{x}^{2}}{{a}^{2}} - \frac{{y}^{2}}{{b}^{2}} \qquad ( 35.6 )$$

where a and b are constants. The curvature of the surface of Eq. (35.6) is

$$K = {\frac{- 1}{4 {a}^{2} {b}^{2}} [ \frac{{x}^{2}}{{a}^{4}} + \frac{{y}^{2}}{{b}^{4}} + \frac{1}{4} ]}^{- 2} \qquad ( 35.7 )$$

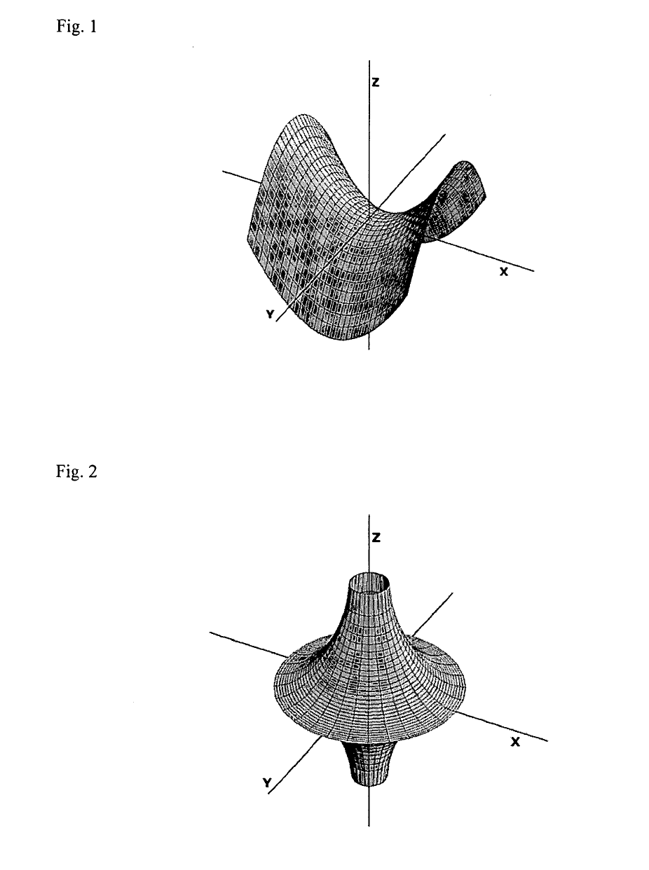

A saddle is shown schematically in FIG. 1. A pseudosphere is constructed by revolving the tractrix about its asymptote. For the tractrix, the length of any tangent measured from the point of tangency to the x-axis is equal to the height R of the curve from its asymptote—in this case the x-axis. The pseudosphere is a surface of constant negative curvature. The curvature, K

$$K = \frac{- 1}{{r}_{1} {r}_{2}} = \frac{- 1}{{R}^{2}} \qquad ( 35.8 )$$

given by the product of the two principal curvatures on opposite sides of the surface is equal to the inverse of R squared at every point where R is the equitangent. R is also known as the radius of the pseudosphere. A pseudosphere is shown schematically in FIG. 2.

In the case of a sphere, surfaces of constant potential are concentric spherical shells. The general law of potential for surfaces of constant curvature is

$$V = \frac{1}{4 {πɛ}_{o}} \sqrt{\frac{1}{{r}_{1} {r}_{2}}} = \frac{1}{4 {πɛ}_{o} R} \qquad ( 35.9 )$$

In the case of a pseudosphere the radii r₁ and r₂, the two principal curvatures, represent the distances measured along the normal from the negative potential surface to the two sheets of its evolute, envelop of normals (cantenoid and x-axis). The force is given as the gradient of the potential that is proportional to

$$\frac{1}{{r}^{2}}$$

in the case of a sphere.

All matter is comprised of fundamental particles, and all fundamental particles exist as mass confined to two spatial dimensions. The particle's velocity surface is positively curved in the case of an orbitsphere, flat in the case of a free electron, and negatively curved in the case of an electron as a hyperboloid (hereafter called a hyperbolic electron given in the Hyperbolic Electrons section). The effect of this “local” curvature on the non-local spacetime is to cause it to be Riemannian in the case of an orbitsphere, or hyperbolic, in the case of a hyperbolic electron, as opposed to Euclidean in the case of the free electron. Each curvature is manifest as a gravitational field, a repulsive gravitational field, or the absence of a gravitational field, respectively. Thus, the spacetime is curved with constant spherical curvature in the case of an orbitsphere, or spacetime is curved with hyperbolic curvature in the case of a hyperbolic electron.

The relativistic correction for spacetime dilation and contraction due to the production of a particle with positive curvature is given by Eq. (32.17):

$$f ( r ) = ( 1 - {( \frac{{v}_{g}}{c} )}^{2} ) \qquad ( 35.10 )$$

The derivation of the relativistic correction factor of spacetime was based on the constant maximum velocity of light and a finite positive Newtonian gravitational velocity v_{g} of the particle given by

$${v}_{g} = \sqrt{\frac{2 {Gm}_{0}}{r}} = \sqrt{\frac{2 {Gm}_{0}}{{\overline{λ}}_{C}}} \qquad ( 35.11 )$$

Consider a Newtonian gravitational radius, r_{g}, of each orbitsphere of the particle production event, each of mass m₀

$${r}_{g} = \frac{2 {Gm}_{0}}{{c}^{2}} \qquad ( 35.12 )$$

where G is the Newtonian gravitational constant. The substitution of each of Eq. (35.11) and Eq. (35.12) into the Schwarzschild metric Eq. (35.2) gives

$$\begin{matrix}d {τ}^{2} = ( 1 - {( \frac{{v}_{g}}{c} )}^{2} ) {dt}^{2} - \frac{1}{{c}^{2}} [ \begin{matrix}{( 1 - {( \frac{{v}_{g}}{c} )}^{2} )}^{- 1} {dr}^{2} + \\ {r}^{2} d {θ}^{2} + {r}^{2} {sin}^{2} θ d {φ}^{2}\end{matrix} ] \\ and & ( 35.13 ) \\ d {τ}^{2} = ( 1 - \frac{{r}_{g}}{r} ) {dt}^{2} - \frac{1}{{c}^{2}} [ \begin{matrix}{( 1 - \frac{{r}_{g}}{r} )}^{- 1} {dr}^{2} + \\ {r}^{2} d {θ}^{2} + {r}^{2} {sin}^{2} θ d {φ}^{2}\end{matrix} ] & ( 35.14 )\end{matrix}$$

respectively. The solutions for the Schwarzschild metric exist wherein the relativistic correction to the gravitational velocity v_{g} and the gravitational radius r_{g} are of the opposite sign (i.e. negative). In these cases, the Schwarzschild metric (Eq. (35.2)) is

$$\begin{matrix}d {τ}^{2} = ( 1 + {( \frac{{v}_{g}}{c} )}^{2} ) {dt}^{2} - \frac{1}{{c}^{2}} [ \begin{matrix}{( 1 + {( \frac{{v}_{g}}{c} )}^{2} )}^{- 1} {dr}^{2} + \\ {r}^{2} d {θ}^{2} + {r}^{2} {sin}^{2} θ d {φ}^{2}\end{matrix} ] \\ and & ( 35.15 ) \\ d {τ}^{2} = ( 1 + \frac{{r}_{g}}{r} ) {dt}^{2} - \frac{1}{{c}^{2}} [ \begin{matrix}{( 1 + \frac{{r}_{g}}{r} )}^{- 1} {dr}^{2} + \\ {r}^{2} d {θ}^{2} + {r}^{2} {sin}^{2} θ d {φ}^{2}\end{matrix} ] & ( 35.16 )\end{matrix}$$

The metric given by Eqs. (35.13-35.14) corresponds to positive curvature. The metric given by Eqs. (35.15-35.16) corresponds to negative curvature. The negative solution arises naturally as a match to the boundary condition of matter with a velocity function having negative curvature. Consider the case of pair production given in the Gravity section. The photon equation given in the Equation of the Photon section is equivalent to the electron and positron functions given in the One-Electron Atom section. The velocity of any point on the positively curved electron orbitsphere is constant which corresponds to the equations of time-harmonic constant motion, the generation matrices, and convolution operators given in the Orbitsphere Equation of Motion for l=0 Based on the Current Vector Field (CVF) and subsequent sections. At particle production, the relativistic corrections to spacetime due to the constant gravitational velocity v_{g} are given by Eqs. (35.13-35.14). In the case of negative curvature, the electron velocity as a function of position is not constant. It may be described by a harmonic variation which corresponds to an imaginary velocity. The positively curved surface given in Eqs. (1.68-1.81) becomes a hyperbolic function (e.g. cosh) in the case of a negatively curved electron. Substitution of an imaginary velocity with respect to a gravitating body into Eq. (35.13) gives Eq. (35.15). Substitution of a negative radius of curvature with respect to a gravitating body into Eq. (35.14) gives Eq. (35.16). Thus, negative gravity (fifth force) can be created by forcing matter into negative curvature of the velocity surface. A fundamental particle with negative curvature of the velocity surface would experience a central but repulsive force with a gravitating body comprised of matter of positive curvature of the velocity surface. Unlike the electric and magnetic forces where the vector corresponding to the opposite sign of charge or opposite magnetic pole has the same magnitude, the magnitude of the fifth force acting on a fundamental particle is much greater than the gravitational force acting on the same inertial mass when the inertial and gravitational masses are equivalent. Hyperbolic electrons can be formed by scattering of free electrons at special resonant energies for their formation. In this case, the fifth force deflects the free electron upward during the transition such that the hyperbolic electron has the translational kinetic energy that cause the coordinate and proper times to be equivalent according to the Schwarzschild metric. The upward acceleration from a gravitating body to the required electron velocity give by Eq. (35.157) is a condition for the production wherein the body is sufficiently massive to meet the boundary condition that the production radius (Eq. (35.158)) is larger than that of the hyperbolic electron to support hyperbolic-electron production.

### BRIEF DESCRIPTION OF THE FIGURES

These and further features of the present invention will be better understood by reading the following Detailed Description of the Invention taken together with the Drawing, wherein:

FIG. 1. A saddle.

FIG. 2. A pseudosphere.

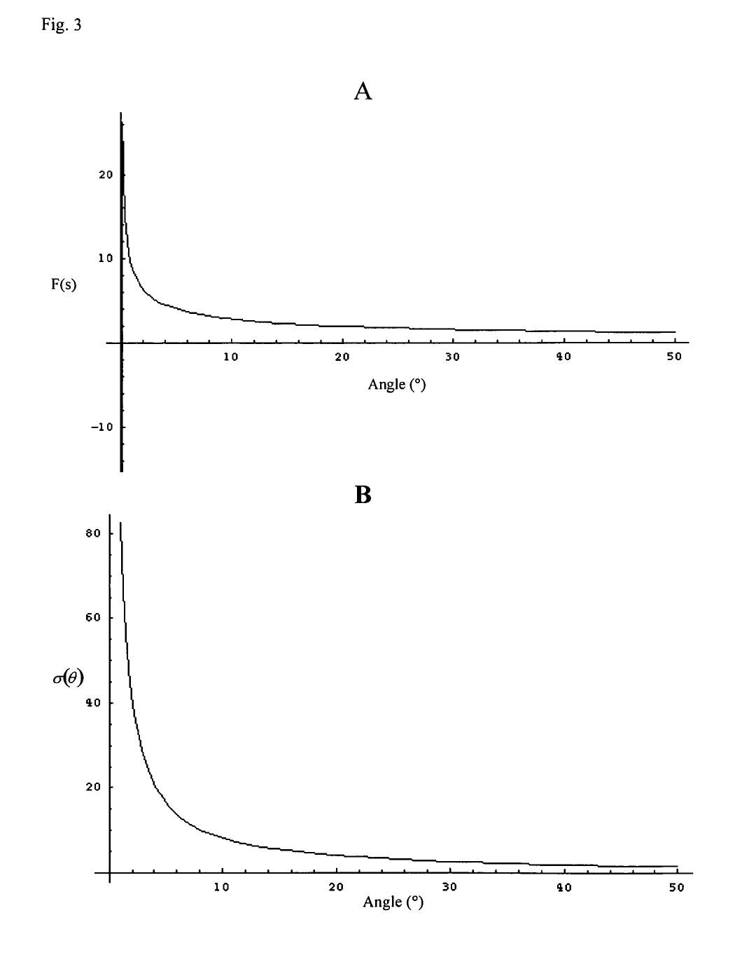

FIG. 3. Hyperbolic-electron-production angular distribution. (A) The relative scattering amplitude function, F(s), of 42.3 eV electrons as a function of angle (Eq. (35.55)). (B) The relative differential cross section, σ(θ), for the elastic scattering of 42.3 eV electrons to form hyperbolic electrons as a function of angle (Eq. (35.56)).

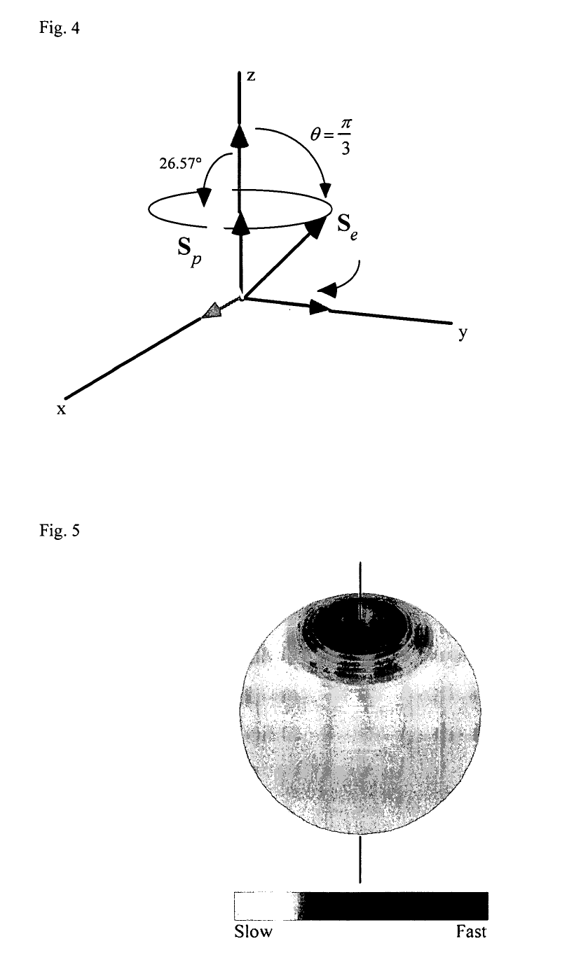

FIG. 4. The angular momentum components (vectors of

$$\frac{ℏ}{4} and \frac{ℏ}{2} ,$$

on the X and Z-axis, respectively) of Sₚ (vector of

$$\frac{\sqrt{5}}{4} ℏ )$$

having the same angular momentum components as the orbitsphere and Sₑ (vector of with Z and Y projections of

$$\frac{ℏ}{2}$$

and of

$$\sqrt{\frac{3}{4} ℏ} ,$$

respectively) in the stationary coordinate system. Sₑ, Sₚ, and the components in the XY-plane precess at the Larmor frequency about the Z-axis.

FIG. 5. The hyperbolic electron is a two-dimensional spherical shell of mass (charge)-density having a velocity function that is maximum at the ±z-axis with θ=0 and θ=π and minimum at the in the xy-plane at θ=π/2.

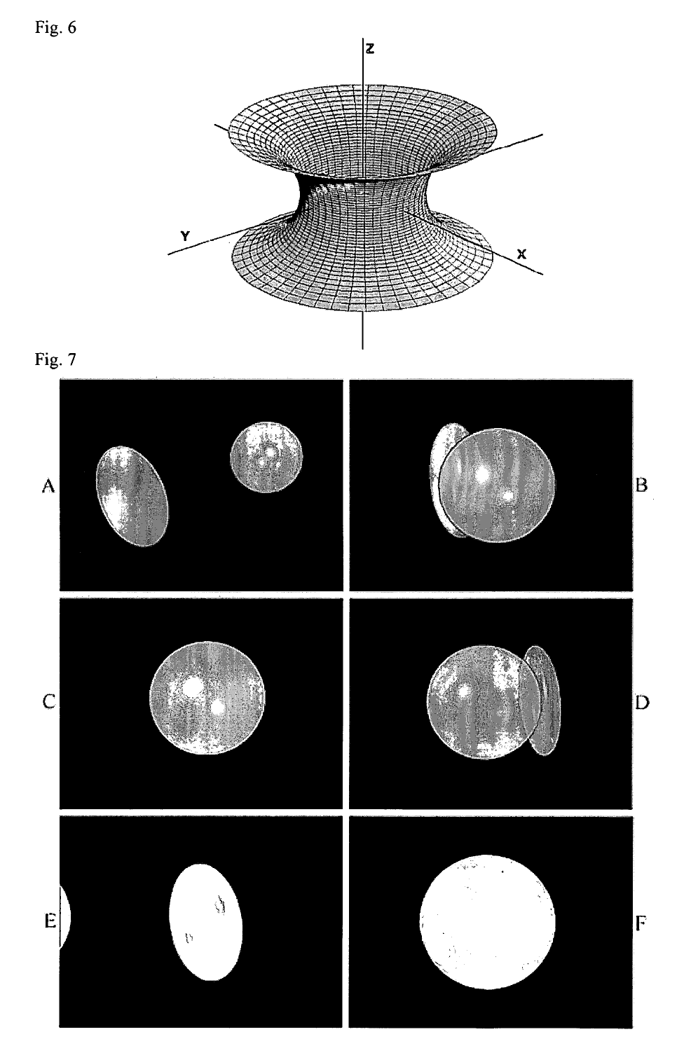

FIG. 6. The magnitude of the velocity distribution (|v_{φ}|) on a two-dimensional sphere along the z-axis (vertical axis) of a hyperbolic electron.

FIG. 7. Formation of a hyperbolic electron by free-electron having an energy of 42.3 eV elastically scattering from an atom. (A) The energy of the incoming electron is equal to 42.3 eV. (B) and (C) The electron is spherically distorted by the atom. (D) and (E) Momentum is conserved when each point of the surface acts as point source of the scattered electron according to Huygens's Principle. (F) The scattered electron called a hyperbolic electron comprises a spherical shell of mass (charge) density (Eqs. (35.72) and (35.73)) and has a velocity function whose magnitude is a hyperboloid (Eq. (35.67) or Eq. (35.75)). The velocity is shown in grayscale with increasing velocity shown from light to dark.

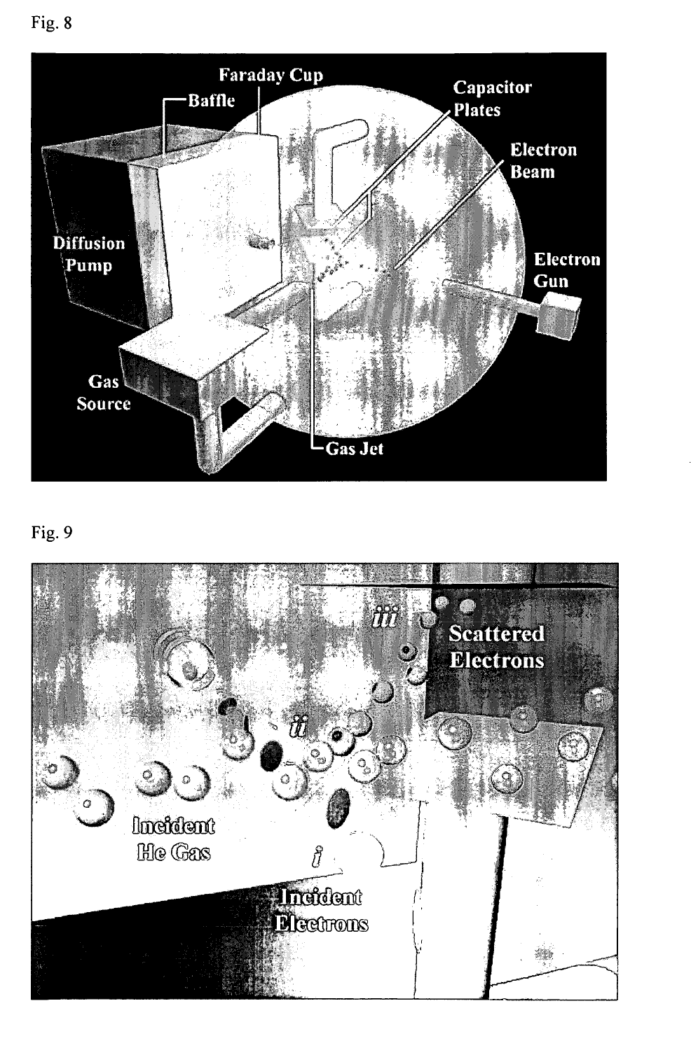

FIG. 8. Schematic of the components of the system of a device that forms hyperbolic electrons by free-electron scattering and uses the Coulombic force of the gravitationally repelled electrons to act repulsively on a negatively-charged plate to transfer the fifth force to create lift. The system comprises an electron gun that ejects a beam of electrons which intersects an atomic beam from a gas source, a capacitor structurally attached to the craft to be lifted that receives the scattered hyperbolic electrons, a diffusion pump that collects and recirculates the atoms to the atomic beam, and a Faraday cup that collects and recirculates the electrons back to the electron beam.

FIG. 9. Schematic of the operation of a device that forms hyperbolic electrons by free-electron scattering and uses the Coulombic force of the fifth-force repelled electrons to act repulsively on a negatively-charged plate to transfer the fifth force to create lift. (i) A beam of electrons is generated and directed to the neutral atomic beam. (ii) Scattering of the electrons of the electron beam by the neutral atomic beam gives the electrons negative curvature of their velocity surfaces, and the electrons experience a fifth force (upward away from the Earth). (iii) The electrons, which would normally bend down toward the positive plate, but do not because of the fifth force, repel the negative plate and attract the positive plate, and transfer the fifth force, a repulsive relative to the gravitational force, to the object to be lifted.

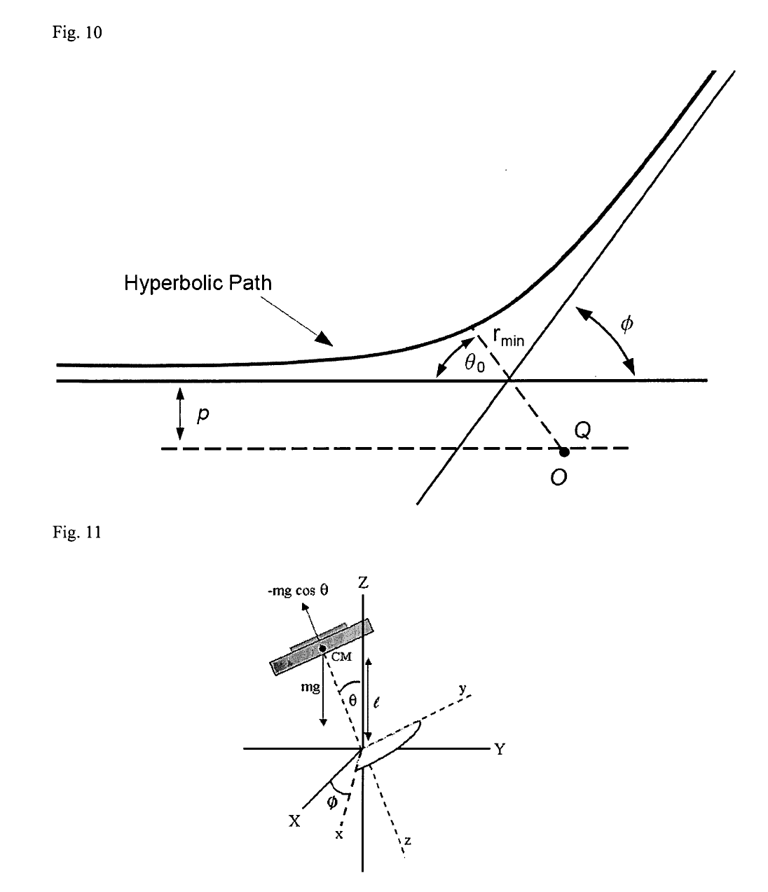

FIG. 10. Hyperbolic path of a hyperbolic electron of mass m in an inverse-square repulsive field of a gravitating body comprised of matter of positive curvature of the velocity surface of total mass M.

FIG. 11. Schematic of the forces on a spinning craft which is caused to tilt.

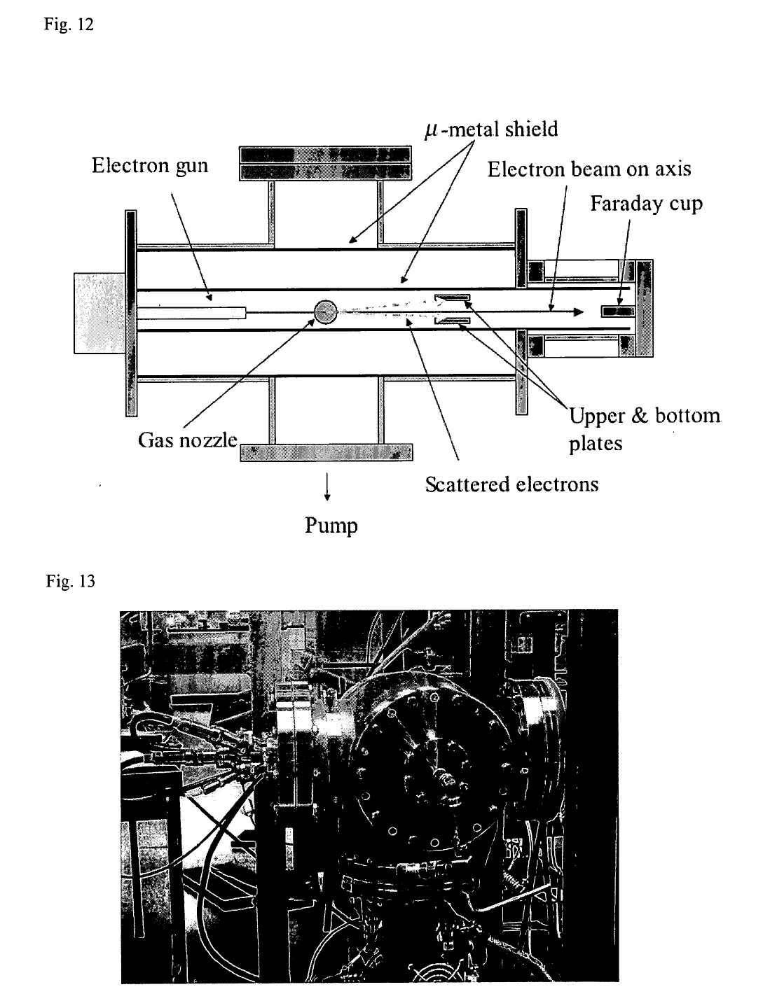

FIG. 12. Schematic of the apparatus for scattering an electron beam from a crossed atomic or molecular beam and measuring the fifth-force deflected beam as the normalized current at a top electrode relative to a bottom electrode.

FIG. 13. Side view of the apparatus for scattering an electron beam from a crossed atomic or molecular beam and measuring the fifth-force deflected beam.

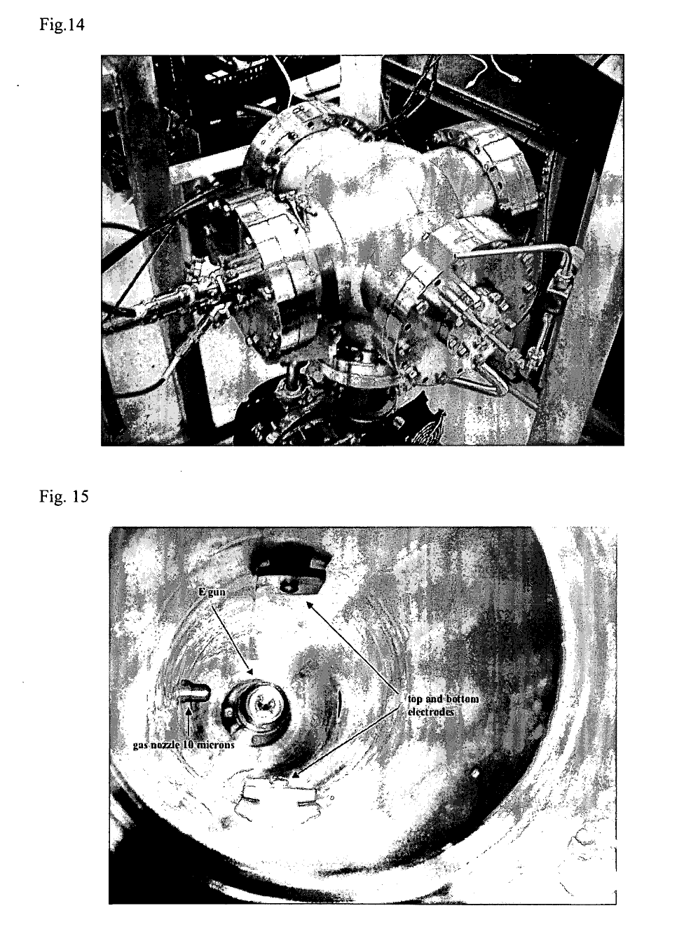

FIG. 14. Top view of the apparatus for scattering an electron beam from a crossed atomic or molecular beam and measuring the fifth-force deflected beam.

FIG. 15. Inside view of the apparatus for scattering an electron beam from a crossed atomic or molecular beam and measuring the fifth-force deflected beam showing the electron gun, gas nozzle, and top and bottom electrodes.

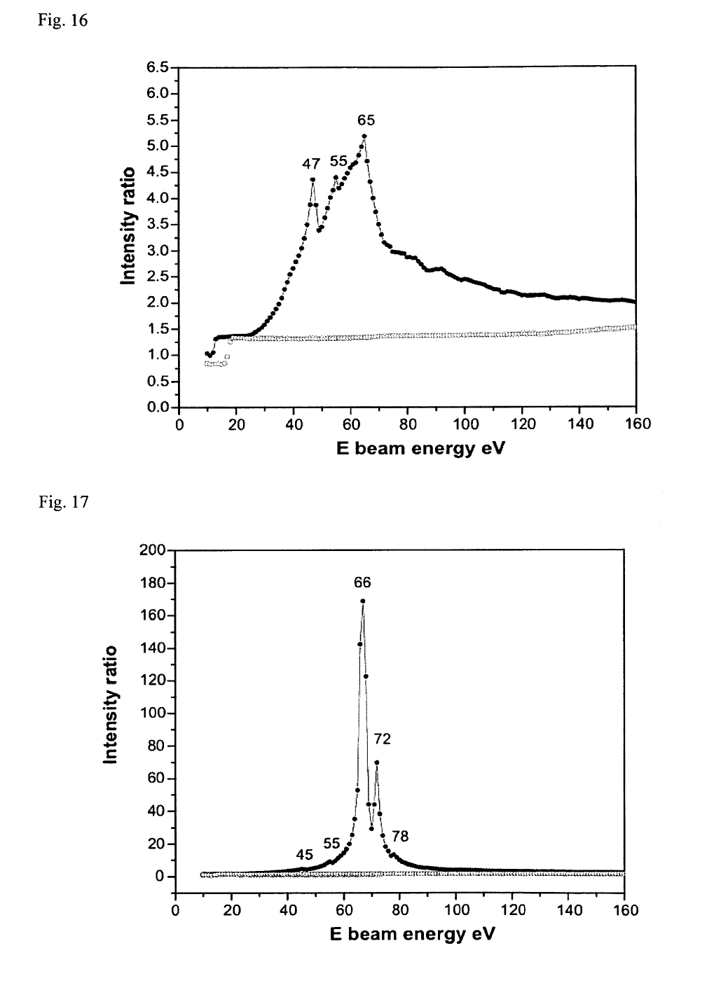

FIG. 16. The current at the top electrode divided by that at the bottom for the scattering an electron beam from a crossed helium beam (top curve) compared to the same ratio in the absence of the helium atomic beam (bottom curve) at a flight distance of 100 mm. A significant fifth-force effect was observed.

FIG. 17. The current at the top electrode divided by that at the bottom for the scattering an electron beam from a crossed neon beam (top curve) compared to the same ratio in the absence of the neon atomic beam (bottom curve) at a flight distance of 100 mm. A significant fifth-force effect was observed. The Sₚ hyperbolic-electronic state at 66 eV dominated the spectrum indicating that the neon atom's electronic transitions do not interfere significantly with the resonant production of hyperbolic electrons of this state at the corresponding energy.

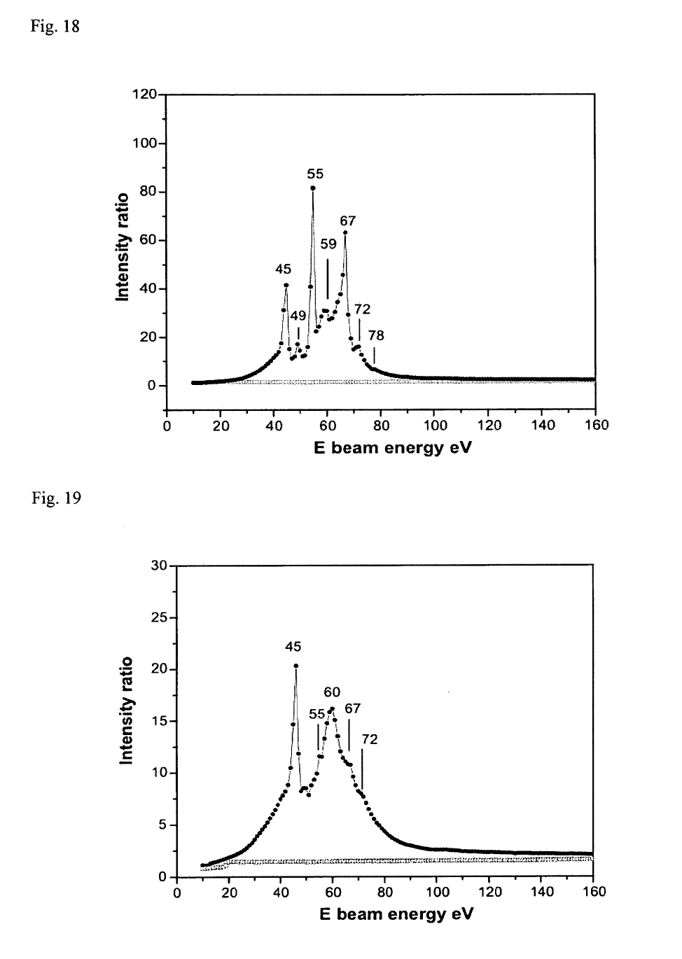

FIG. 18. The current at the top electrode divided by that at the bottom for the scattering an electron beam from a crossed argon beam (top curve) compared to the same ratio in the absence of the argon atomic beam (bottom curve) at a flight distance of 100 mm. A significant fifth-force effect was observed. All of the lower-energy hyperbolic-electronic-state transitions of Table 2 were observed at their anticipated relative intensities indicating that the argon atom's electronic transitions do not interfere significantly with the resonant production of hyperbolic electrons.

FIG. 19. The current at the top electrode divided by that at the bottom for the scattering an electron beam from a crossed krypton atomic beam (top curve) compared to the same ratio in the absence of the atomic beam (bottom curve) at a flight distance of 100 mm. A significant fifth-force effect was observed as a dominant peak corresponding to the minimum energy hyperbolic-electronic state.

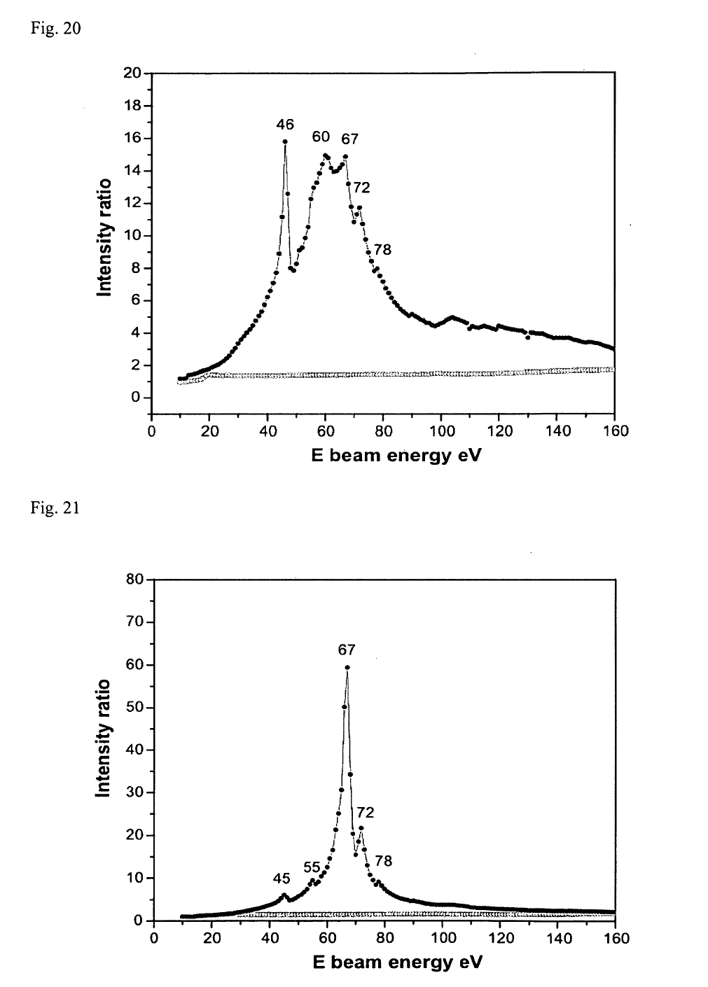

FIG. 20. The current at the top electrode divided by that at the bottom for the scattering an electron beam from a crossed xenon beam (top curve) compared to the same ratio in the absence of the xenon atomic beam (bottom curve) at a flight distance of 100 mm. As in the case with krypton, a significant fifth-force effect was observed as a dominant peak corresponding to the minimum energy hyperbolic-electronic state.

FIG. 21. The current at the top electrode divided by that at the bottom for the scattering an electron beam from a crossed hydrogen molecular beam (top curve) compared to the same ratio in the absence of the H₂ molecular beam (bottom curve) at a flight distance of 100 mm. The Sₚ hyperbolic-electronic state at 67 eV dominated the spectrum similar to the case of neon.

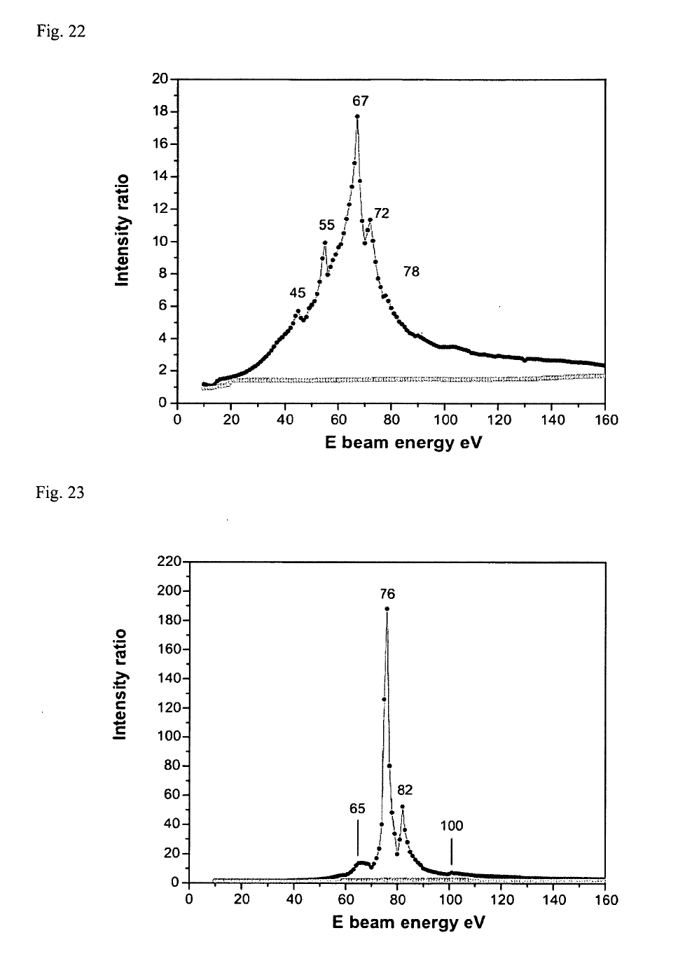

FIG. 22. The current at the top electrode divided by that at the bottom for the scattering an electron beam from a crossed nitrogen molecular beam (top curve) compared to the same ratio in the absence of the N₂ molecular beam (bottom curve) at a flight distance of 100 mm. As in the case of neon and H₂, a significant fifth-force effect was observed with the Sₚ hyperbolic-electronic state at 67 eV dominating the spectrum.

FIG. 23. The current at the top electrode divided by that at the bottom for the scattering an electron beam from a crossed helium beam (top curve) compared to the same ratio in the absence of the helium atomic beam (bottom curve) at a flight distance of 50 mm. A significant fifth-force effect was observed. The high-energy (Sₚ+l=1 mₗ=1)+(l=1 mₗ=0) state was observed at 100 eV, and intense peaks corresponding to the l=1 mₗ=1, and (Sₚ+l=1 mₗ=0)+(l=1 mₗ=0) hyperbolic-electronic states were observed at 76 eV and 82 eV, respectively, indicating that the higher energy states dominate the spectrum in the near field.

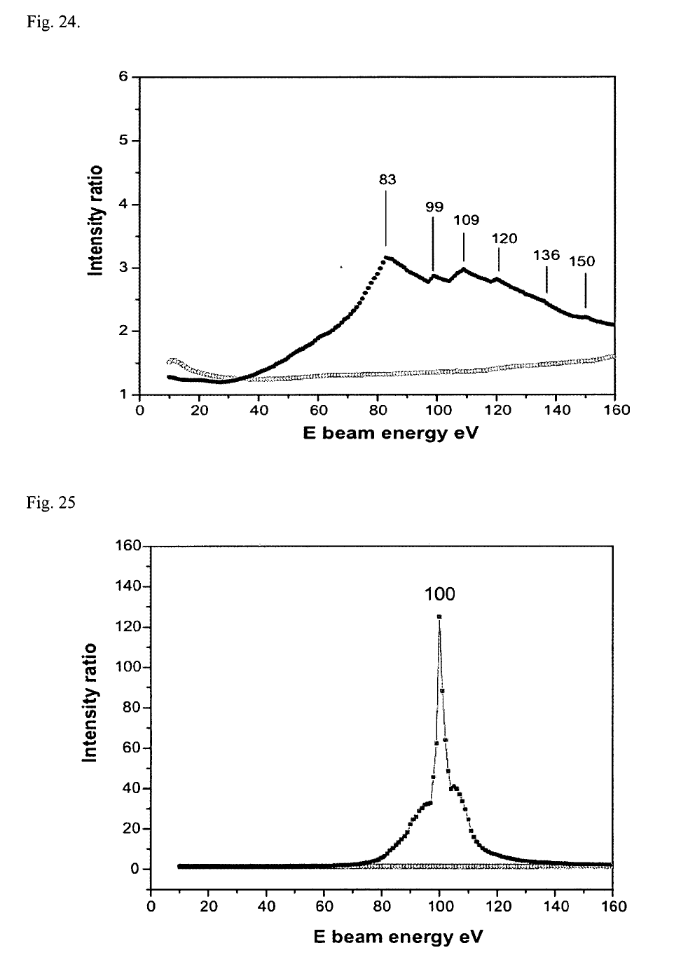

FIG. 24. The current at the top electrode divided by that at the bottom for the scattering an electron beam from a crossed neon beam (top curve) compared to the same ratio in the absence of the neon atomic beam (bottom curve) at a flight distance of 50 mm. A significant fifth-force effect was observed. The spectrum was very similar to that of H₂ and N₂ showing the series of the highest-energy states from 83 eV to 150 eV in the near field.

FIG. 25. The current at the top electrode divided by that at the bottom for the scattering an electron beam from a crossed neon beam (top curve) compared to the same ratio in the absence of the neon atomic beam (bottom curve) at a flight distance of 50 mm. The chamber was cleared by extensive pumping with flow to obtain a scan showing a strong resonance at 100 eV corresponding to the (Sₚ+l=1 mₗ=1)+(l=1 mₗ=0) hyperbolic-electronic state that dominated other peaks in the spectrum.

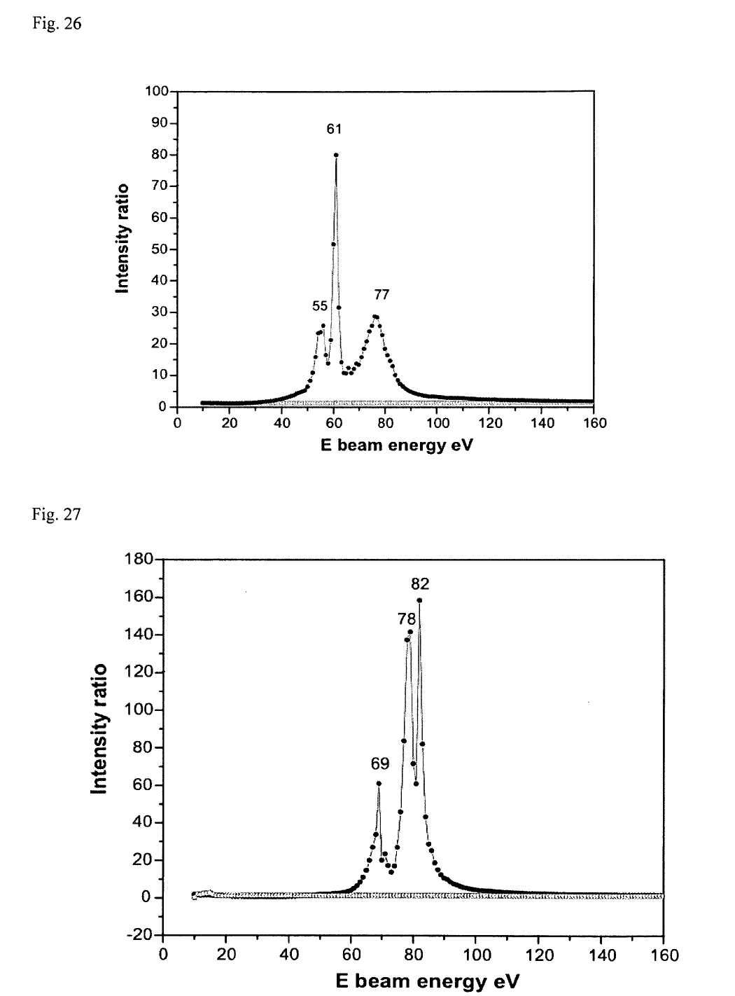

FIG. 26. The current at the top electrode divided by that at the bottom for the scattering an electron beam from a crossed argon beam (top curve) compared to the same ratio in the absence of the argon atomic beam (bottom curve) at a flight distance of 50 mm. A significant fifth-force effect was observed. The high-energy l=1 mₗ=1 hyperbolic-electronic state at 77 eV was significantly increased in the near field relative to the far field.

FIG. 27. The current at the top electrode divided by that at the bottom for the scattering an electron beam from a crossed krypton atomic beam (top curve) compared to the same ratio in the absence of the atomic beam (bottom curve) at a flight distance of 50 mm. A significant fifth-force effect was observed with the spectrum shifted to high-energy hyperbolic-electronic states relative to the far field pattern.

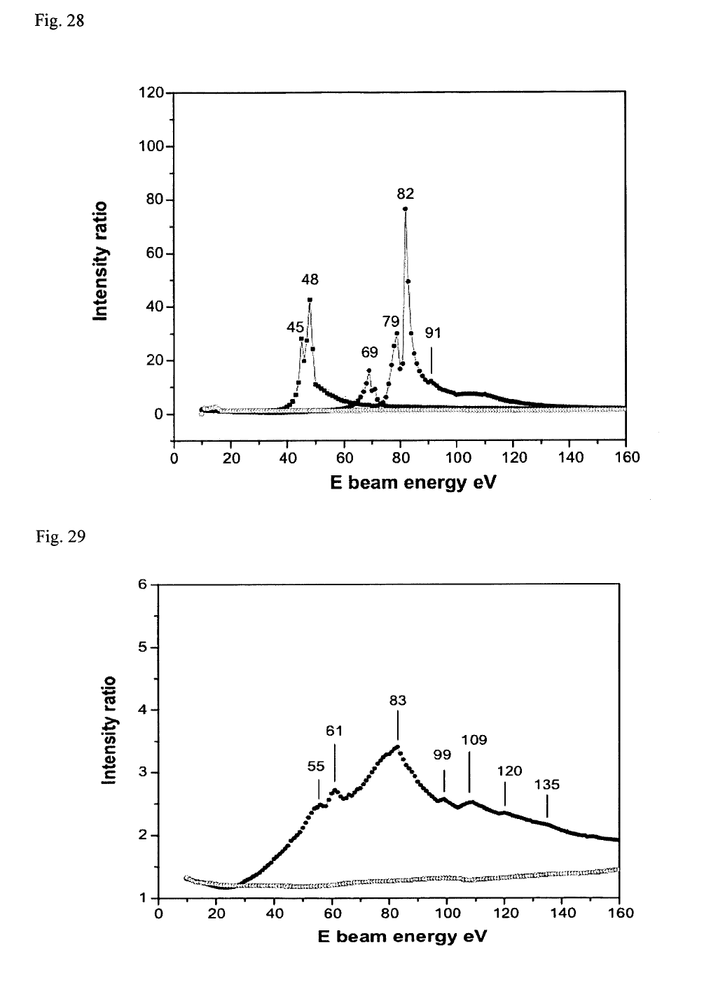

FIG. 28. The current at the top electrode divided by that at the bottom for the scattering an electron beam from a crossed xenon beam (top curves) compared to the same ratio in the absence of the xenon atomic beam (bottom curve) at a flight distance of 50 mm. With extensive pumping, the gas-flow was maintained constant at the intermediate pressure of 4.4×10⁻⁵ Torr while the electron gun was run at 10 V and 200 V before the scans corresponding to the squares and circles, respectively. There was a reciprocal relationship between the gun energy during pumping and the energy range of the spectrum when subsequently acquired.

FIG. 29. The current at the top electrode divided by that at the bottom for the scattering an electron beam from a crossed hydrogen molecular beam (top curve) compared to the same ratio in the absence of the H₂ molecular beam (bottom curve) at a flight distance of 50 mm. A significant fifth-force effect was observed. The spectrum was similar to that of neon with the series of high-energy states out to the (((Sₚ+l=1 mₗ=0)+(l=1 mₗ=1))+((Sₚ+l=1 mₗ=1)+(l=1 mₗ=1))) state observed at 135 eV indicating that the higher energy states dominate the spectrum in the near field.

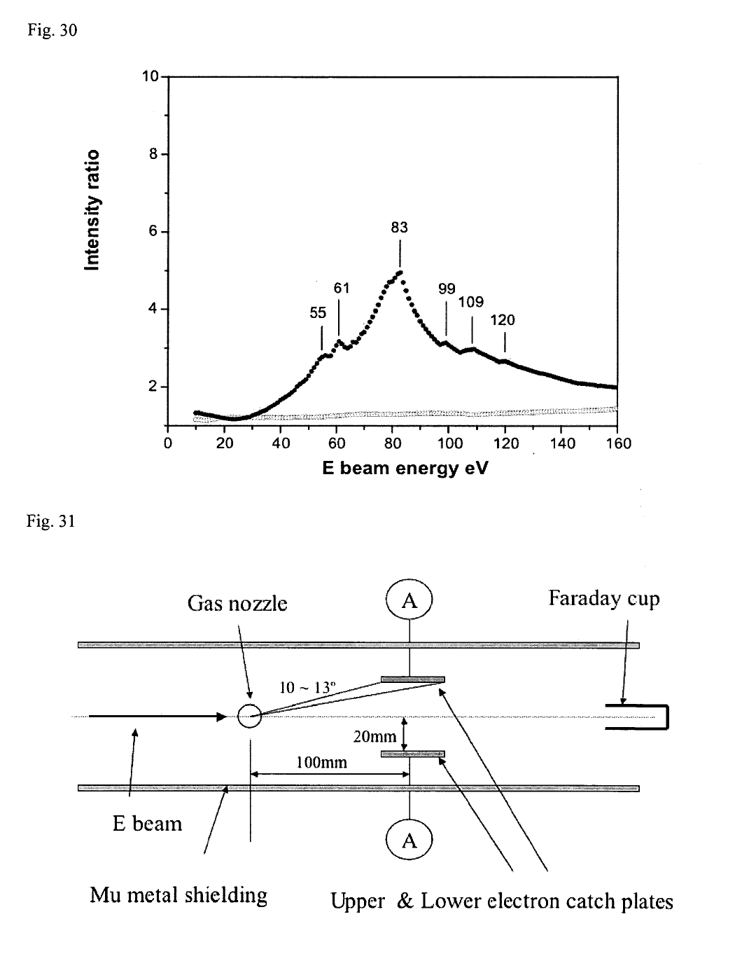

FIG. 30. The current at the top electrode divided by that at the bottom for the scattering an electron beam from a crossed nitrogen molecular beam (top curve) compared to the same ratio in the absence of the N₂ molecular beam (red curve) at a flight distance of 50 mm. The spectrum was essentially the same as that of H₂ with the high-energy states out to the (Sₚ+l=1 mₗ=0)+(l=1 mₗ=1) state observed at 120 eV indicating that the higher energy states dominate the spectrum in the near field.

FIG. 31. Schematic of the apparatus for scattering an electron beam from a crossed atomic or molecular beam and measuring the fifth-force deflected beam showing the separation of between the intersection point of the beams and top and bottom electrodes at a flight distance of 100 mm. When the flight distance is reduced to 50 mm, the deflection angle from the point of scattering to the electrodes doubles to the range ˜18-27°.

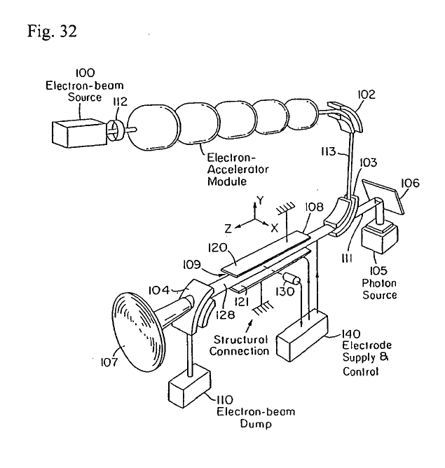

FIG. 32. A schematic of a fifth-force apparatus according to one embodiment of the present invention to produce hyperbolic electrons and transfer a fifth-force on an attached structure.

### DETAILED DESCRIPTION OF THE INVENTION

### Positive, Zero, and Negative Gravitational Mass

Matter arises during particle production from a photon. The limiting velocity c results in the contraction of spacetime due to particle production. The contraction is given by 2πr_{g} where r_{g} is the gravitational radius of the particle. This has implications for the physics of gravitation. By applying the condition to electromagnetic and gravitational fields at particle production, the Schwarzschild metric (SM) is derived from the classical wave equation, which modifies general relativity to include conservation of spacetime in addition to momentum and matter/energy. The result gives a natural relationship between Maxwell's equations, special relativity, and general relativity. It gives gravitation from the atom to the cosmos. The Schwarzschild metric gives the relationship whereby matter causes relativistic corrections to spacetime that determines the curvature of spacetime and is the origin of gravity. The gravitational equations with the equivalence of the particle production energies permit the equivalence of mass-energy and the spacetime wherein a “clock” is defined which measures “clicks” on an observable in one aspect, and in another, it is the ruler of spacetime of the universe with the implicit dependence of spacetime on matter-energy conversion. The masses of the leptons, the quarks, and nucleons are derived from this metric of spacetime. In addition to the propagation velocity, the intrinsic velocity of a particle and the geometry of its 2-dimensional velocity surface with respect to the limiting speed of light determine that the particle such as an electron may have gravitational mass different from its inertial mass. A constant velocity confined to a spherical surface corresponds to a positive gravitational mass equal to the inertial mass (e.g. particle production or a bound electron). A constant angular velocity function confined to a flat surface corresponds to a gravitational mass less than the inertial mass, which is zero in the limit of an absolutely unbound particle (e.g. absolutely free electron). A hyperbolic velocity function confined to a spherical surface corresponds to a negative gravitational mass (e.g. hyperbolic electron). Each case is considered in turn infra.

According to Newton's Law of Gravitation, the production of a particle of finite mass gives rise to a gravitational velocity of the particle. The gravitational velocity determines the energy and the corresponding eccentricity and trajectory of the gravitational orbit of the particle. The eccentricity, e, given by Newton's differential equations of motion in the case of the central field (Eq. (32.49-32.50)) permits the classification of the orbits according to the total energy, E, and according to the orbital velocity, v₀, relative to the Newtonian gravitational escape velocity, v_{g}, as follows [3]:

$$\begin{matrix}\begin{matrix}E < 0 & e < 1 & ellipse \\ E < 0 & e = 0 & circle ( special case of ellipse ) \\ E = 0 & e = 1 & parabolic orbit \\ E > 0 & e > 1 & hyperbolic orbit\end{matrix} & ( 35.17 ) \\ \begin{matrix}{v}_{0}^{2} < {v}_{g}^{2} = \frac{2 GM}{{r}_{0}} & e < 1 & ellipse \\ {v}_{0}^{2} < {v}_{g}^{2} = \frac{2 GM}{{r}_{0}} & e = 0 & circle ( special case of ellipse ) \\ {v}_{0}^{2} = {v}_{g}^{2} = \frac{2 GM}{{r}_{0}} & e = 1 & parabolic orbit \\ {v}_{0}^{2} > {v}_{g}^{2} = \frac{2 GM}{{r}_{0}} & e > 1 & hyperbolic orbit\end{matrix} & ( 35.18 )\end{matrix}$$

Since E=T+V and is constant, the closed orbits are those for which T<|V|, and the open orbits are those for which T≧|V|. It can be shown that the time average of the kinetic energy, <T>, for elliptic motion in an inverse square field is ½ that of the time average of the potential energy, <V>:<T>=½<V>.

In the case that a particle of inertial mass, m, is observed to have a speed, v₀, a distance from a massive object, r₀, and a direction of motion makes that an angle, φ, with the radius vector from the object (including a particle) of mass, M, the total energy is given by

$$E = \frac{1}{2} {mv}^{2} - \frac{GMm}{r} = \frac{1}{2} {mv}_{0}^{2} - \frac{GMm}{{r}_{0}} = constant \qquad ( 35.19 )$$

The orbit will be elliptic, parabolic, or hyperbolic, according to whether E is negative, zero, or positive. Accordingly, if v₀² is less than, equal to, or greater than

$$\frac{2 GM}{{r}_{0}} ,$$

the orbit will be an ellipse, a parabola, or a hyperbola, respectively. Since h, the angular momentum per unit mass, is

h=L/m=|r×v|=r₀v₀ sin φ (35.20)

the eccentricity, e, from Eq. (32.63) may be written as

$$e = {[ 1 + ( {v}_{0}^{2} - \frac{2 GM}{{r}_{0}} ) \frac{{r}_{0}^{2} {v}_{0}^{2} {sin}^{2} φ}{{G}^{2} {M}^{2}} ]}^{1 / 2} \qquad ( 35.21 )$$

As shown in the Gravity section (Eq. (32.35)), the production of a particle requires that the velocity of each of the mass-density element of the particle is equivalent to the Newtonian gravitational escape velocity, v_{g}, of the superposition of the mass-density elements of the antiparticle.

$${v}_{g} = \sqrt{\frac{2 Gm}{r}} = \sqrt{\frac{2 {Gm}_{0}}{{\overline{λ}}_{C}}} \qquad ( 35.22 )$$

From Eq. (35.21) and Eqs. (35.17-35.18), the eccentricity is one and the particle production trajectory is a parabola relative to the center of mass of the antiparticle. The right-hand side of Eq. (32.43) represents the correction to the laboratory coordinate metric for time corresponding to the relativistic correction of spacetime by the particle production event. Riemannian space is conservative. Only changes in the metric of spacetime during particle production must be considered. The changes must be conservative. For example, pair production occurs in the presence of a heavy body. A nucleus which existed before the production event only serves to conserve momentum but is not a factor in determining the change in the properties of spacetime as a consequence of the pair production event. The effect of this and other external gravitating bodies are equal on the photon and resulting particle and antiparticle and do not effect the boundary conditions for particle production. For particle production to occur, the particle must possess the escape velocity relative to the antiparticle where Eqs. (32.34), (32.48), and (32.140) apply. In other cases not involving particle production such as a special electron scattering event wherein hyperbolic electron production occurs as given infra, the presence of an external gravitating body must be considered. The curvature of spacetime due to the presence of a gravitating body and the constant maximum velocity of the speed of light comprise boundary conditions for hyperbolic electron production from a free electron.

With particle production, the form of the outgoing gravitational field front traveling at the speed of light (Eq. (32.10)) is

$$f ( t - \frac{r}{c} ) \qquad ( 35.23 )$$

At production, the particle must have a finite velocity called the gravitational velocity according to Newton's Law of Gravitation. In order that the velocity does not exceed c in any frame including that of the particle having a finite gravitational velocity, the laboratory frame of an incident photon that gives rise to the particle, and that of a gravitational field propagating outward at the speed of light, spacetime must undergo time dilation and length contraction due to the production event. During particle production the speed of light as a constant maximum as well as phase matching and continuity conditions require the following form of the squared displacements due to constant motion along two orthogonal axes in polar coordinates:

$$\begin{matrix}{( c τ )}^{2} + {( {v}_{g} t )}^{2} = {( ct )}^{2} & ( 35.24 ) \\ {( c τ )}^{2} = {( ct )}^{2} - {( {v}_{g} t )}^{2} & ( 35.25 ) \\ {τ}^{2} = {t}^{2} ( 1 - {( \frac{{v}_{g}}{c} )}^{2} ) \\ Thus , & ( 35.26 ) \\ f ( r ) = ( 1 - {( \frac{{v}_{g}}{c} )}^{2} ) & ( 35.27 )\end{matrix}$$

The derivation and result of spacetime time dilation is analogous to the derivation and result of special relativistic time dilation given by Eqs. (31.11-31.15). Consider the gravitational radius, r_{g}, of each orbitsphere of the particle production event, each of mass m₀

$${r}_{g} = \frac{2 {Gm}_{0}}{{c}^{2}} \qquad ( 35.28 )$$

where G is the Newtonian gravitational constant. Substitution of each of Eq. (35.11) and Eq. (35.12) into the Schwarzschild metric Eq. (35.2), gives the general form of the metric due to the relativistic effect on spacetime due to mass m₀.

$$\begin{matrix}d {τ}^{2} ( 1 - {( \frac{{v}_{g}}{c} )}^{2} ) d {t}^{2} - \frac{1}{{c}^{2}} [ \begin{matrix}{( 1 - {( \frac{{v}_{g}}{c} )}^{2} )}^{- 1} d {r}^{2} + \\ {r}^{2} d {θ}^{2} + {r}^{2} {sin}^{2} θ d {φ}^{2}\end{matrix} ] \\ and & ( 35.29 ) \\ d {τ}^{2} = ( 1 - \frac{{r}_{g}}{r} ) d {t}^{2} - \frac{1}{{c}^{2}} [ \begin{matrix}{( 1 - \frac{{r}_{g}}{r} )}^{- 1} d {r}^{2} + \\ {r}^{2} d {θ}^{2} + {r}^{2} {sin}^{2} θ d {φ}^{2}\end{matrix} ] & ( 35.30 )\end{matrix}$$

respectively. Masses and their effects on spacetime superimpose; thus, the metric corresponding to the Earth is given by substitution of the mass of the Earth, M, for m₀ in Eqs. (35.13-35.14). The corresponding Schwarzschild metric Eq. (35.2) is

$$d {τ}^{2} = ( 1 - \frac{2 GM}{{c}^{2} r} ) d {t}^{2} - \frac{1}{{c}^{2}} [ \begin{matrix}{( 1 - \frac{2 GM}{{c}^{2} r} )}^{- 1} d {r}^{2} + \\ {r}^{2} d {θ}^{2} + {r}^{2} {sin}^{2} θ d {φ}^{2}\end{matrix} ] \qquad ( 35.31 )$$

In the case of ordinary bound matter, the inertial and gravitational masses are equivalent as shown in the Equivalence of Inertial and Gravitational Masses Due to Absolute Space and Absolute Light Velocity section, and the following conditions from the particle production relationships given by Eq. (33.41) hold:

$$\begin{matrix}\frac{proper time}{coordinate time} = \frac{gravitational wave condition}{electromagnetic wave condition} \\ = \frac{gravitational mass phase matching}{charge \text{/} inertial mass phase matching} \\ \frac{proper time}{coordinate time} = i \frac{\sqrt{\frac{2 Gm}{{c}^{2} {\overline{λ}}_{C}}}}{α} \\ = i \frac{{v}_{g}}{α c}\end{matrix} \qquad ( 35.32 )$$

Consider the case that the radius in Eq. (35.31) goes to infinity. From Eq. (35.21) and Eqs. (35.17-35.18), when r₀ goes to infinity the eccentricity is always greater than or equal to one and approaches infinity, and the trajectory is a parabola or a hyperbola. Then, the gravitational velocity given by Eq. (35.22) with m=M goes to zero. This condition must hold from all r₀; thus, the free electron does not experience the force of the gravitational field of a massive object, but has inertial mass determined by the conservation of the angular momentum of as shown by Eqs. (3.19-3.20). From the Electron in Free Space section, the free electron has a velocity distribution given by

$$v ( ρ , φ , z , t ) = [ \frac{5}{2} ρ \frac{ℏ}{{m}_{e} {ρ}_{0}^{2}} {i}_{φ} ] \qquad ( 35.33 )$$

The velocity increases linearly with the radius in a two-dimensional plane. The corresponding gravity field front corresponds to a radius at infinity in Eq. (35.23). As a consequence, an ionized or free electron has a gravitational mass that is zero; whereas, the inertial mass is finite and constant (i.e. equivalent to its mass energy given by Eq. (33.13)). Minkowski space applies to the free electron.

In the Electron in Free Space section, a free electron is shown to be a two-dimensional plane wave—a flat surface. Because the gravitational mass depends on the positive curvature of a particle, a free electron has inertial mass but not gravitational mass. The experimental mass of the free electron measured by Witteborn [4] using a free fall technique is less than 0.09 mₑ, where mₑ is the inertial mass of the free electron (9.109534×10⁻³¹ kg). Thus, a free electron is not gravitationally attracted to ordinary matter, and the gravitational and inertial masses are not equivalent. Furthermore, it is possible to give the electron velocity function negative curvature and, therefore, cause a fifth force having a nature of negative gravity.

As is the case of special relativity, the velocity of a particle in the presence of a gravitating body is relative. In the case that the relative gravitational velocity is imaginary, the eccentricity is always greater than one, and the trajectory is a hyperbola. This case corresponds to a hyperbolic electron wherein gravitational mass is effectively negative and the inertial mass is constant (e.g. equivalent to its mass energy given by Eq. (33.13)). As shown infra. hyperbolic electrons can form from free electrons having specific kinetic energies by elastically scattering from targets such as neutral atoms. The formation of a hyperbolic electron occurs over the time that the plane wave free electron scatters from the neutral atom as well as the conditions given by Eqs. (35.157-35.159). Huygens' principle, Newton's law of Gravitation, and the constant speed of light in all inertial frames provide the boundary conditions to determine the metric corresponding to the hyperbolic electron. From Eq. (35.75), the velocity v(ρ,φ,z,t) on a two-dimensional sphere in spherical coordinates is

$$v ( r , θ , φ , t ) = [ \frac{ℏ}{{m}_{e} {r}_{0} sin θ} δ ( r - {r}_{0} ) {i}_{φ} ] \qquad ( 35.34 )$$

With hyperbolic electron production, the form of the outgoing gravitational field front traveling at the speed of light (Eq. (32.10)) is

$$f ( t - \frac{r}{c} ) \qquad ( 35.35 )$$

During hyperbolic electron production the speed of light as a constant maximum as well as phase matching and continuity conditions require the following form of the squared displacements due to constant motion along two orthogonal axes in polar coordinates:

(cτ)²+(v_{g}t)²=(ct)² (35.36)

According to Eq. (35.34), the velocity of the electron on the two-dimensional sphere approaches the speed of light at the angular extremes (θ=0 and θ=π), and the velocity is harmonic as a function of θ. The speed of any signal can not exceed the speed of light. Therefore, the outgoing two-dimensional spherical gravitational field front traveling at the speed of light and the velocity of the electron at the angular extremes require that the relative gravitational velocity must be radially outward. The relative gravitational velocity squared of the term (v_{g}t)² of Eq. (35.36) must be negative. In this case, the relative gravitational velocity may be considered imaginary which is consistent with the velocity as a harmonic function of θ. The energy of the orbit of the hyperbolic electron must always be greater than zero which corresponds to a hyperbolic trajectory and an eccentricity greater than one (Eqs. (35.17-35.18) and (35.21)). From Eq. (35.21) and Eq. (35.22) with the requirements that the relative gravitational velocity must be imaginary and the energy of the orbit must always be positive, the relative gravitational velocity for a hyperbolic electron produced in the presence of the gravitational field of the Earth is

$${v}_{g} = i \sqrt{\frac{2 GM}{r}} \qquad ( 35.37 )$$

where M is the mass of the Earth. Substitution of Eq. (35.37) into Eq. (35.36) gives

$$\begin{matrix}{( c τ )}^{2} = {( ct )}^{2} + {( {v}_{g} t )}^{2} & ( 35.38 ) \\ {τ}^{2} = {t}^{2} ( 1 + {( \frac{{v}_{g}}{c} )}^{2} ) \\ Thus , & ( 35.39 ) \\ f ( r ) = ( 1 + {( \frac{{v}_{g}}{c} )}^{2} ) & ( 35.40 )\end{matrix}$$

Consider a gravitational radius, r_{g}, of a massive object of mass M relative to a hyperbolic electron at the production event that is negative to match the boundary condition of a negatively curved velocity surface

$${r}_{g} = - \frac{2 GM}{{c}^{2}} \qquad ( 35.41 )$$

where G is the Newtonian gravitational constant. Substitution of each of Eq. (35.37) and Eq. (35.41) into the Schwarzschild metric Eq. (35.2), gives the general form of the metric due to the relativistic effect on spacetime due to a massive object of mass M relative to the hyperbolic electron.

$$\begin{matrix}d {τ}^{2} = ( 1 + {( \frac{{v}_{g}}{c} )}^{2} ) {dt}^{2} - \frac{1}{{c}^{2}} [ \begin{matrix}{( 1 + {( \frac{{v}_{g}}{c} )}^{2} )}^{- 1} {dr}^{2} + \\ {r}^{2} d {θ}^{2} + {r}^{2} {sin}^{2} θ d {φ}^{2}\end{matrix} ] \\ and & ( 35.42 ) \\ d {τ}^{2} = ( 1 + \frac{{r}_{g}}{r} ) {dt}^{2} - \frac{1}{{c}^{2}} [ \begin{matrix}{( 1 + \frac{{r}_{g}}{r} )}^{- 1} {dr}^{2} + \\ {r}^{2} d {θ}^{2} + {r}^{2} {sin}^{2} θ d {φ}^{2}\end{matrix} ] & ( 35.43 )\end{matrix}$$

respectively.

### Hyperbolic Electrons

### Scattering Transition Mechanism

It is possible to create a fifth force, a negative gravitational force, by scattering free electrons of a specific energy and corresponding de Broglie wavelength from targets such as atoms and molecules to form a unique orbitsphere-type free electron of a specific stable radius called a hyperbolic electron. Consider first the mechanism to deform an incident electron to cause it to transition to the shape of a bound electron. An electron and an atomic beam intersect such that the neutral atoms cause elastic scattering of the electrons of the electron beam to form hyperbolic electrons having the mass-density distribution given by Eq. (35.72) with a velocity distribution given by Eq. (35.75). The de Broglie wavelength of each electron is given by

$${λ}_{o} = \frac{h}{{m}_{e} {v}_{z}} = 2 {πρ}_{o} \qquad ( 35.44 )$$

where ρₒ is the radius of the free electron in the xy-plane, the plane perpendicular to its direction of propagation. The velocity of each electron follows from Eq. (35.44)

$${v}_{z} = \frac{h}{{m}_{e} {λ}_{0}} = \frac{h}{{m}_{e} 2 {πρ}_{0}} = \frac{ℏ}{{m}_{e} {ρ}_{0}} \qquad ( 35.45 )$$

The elastic electron scattering in the far field is given by the Fourier transform of the aperture function as described in Electron Scattering by Helium section.

The incident free electron mass-density distribution, σₘ(ρ,φ,z), and charge-density distribution, σₑ(ρ,φ,z), in the xy-plane at δ(z) are

$$\begin{matrix}\begin{matrix}{σ}_{m} ( ρ , φ , z ) = \frac{{m}_{e}}{\frac{2}{3} {πρ}_{0}^{3}} \sqrt{{ρ}_{0}^{2} - {ρ}^{2}} = \frac{3}{2} \frac{{m}_{e}}{{πρ}_{0}^{2}} \sqrt{1 - {( \frac{ρ}{{ρ}_{0}} )}^{2}} δ ( z ) & for 0 \leq ρ \leq {ρ}_{0} \\ {σ}_{m} ( ρ , φ , z ) = 0 & for {ρ}_{0} < ρ\end{matrix} \\ and & ( 35.46 ) \\ \begin{matrix}{σ}_{e} ( ρ , φ , z ) = \frac{e}{\frac{2}{3} {πρ}_{0}^{3}} \sqrt{{ρ}_{0}^{2} - {ρ}^{2}} = \frac{3}{2} \frac{e}{{πρ}_{0}^{2}} \sqrt{1 - {( \frac{ρ}{{ρ}_{0}} )}^{2}} δ ( z ) & for 0 \leq ρ \leq {ρ}_{0} \\ {σ}_{e} ( ρ , φ , z ) = 0 & for {ρ}_{0} < ρ\end{matrix} & ( 35.47 )\end{matrix}$$

respectively, where

$$\frac{{m}_{e}}{{πρ}_{0}^{2}}$$

is the average mass density and

$$\frac{e}{{πρ}_{0}^{2}}$$

is the average charge density of the free electron. The superposition of many electrons forms a plane wave as the trigonometric density variation of each individual electron averages to unity over an ensemble of many electrons. The convolution of the corresponding uniform plane wave with an orbitsphere of radius zₒ is given by Eq. (8.45) and Eq. (8.46). The aperture distribution function, a(ρ,φ,z), for the scattering of an incident plane wave by a He atom, for example, is given by the convolution of the plane wave function with the two-electron orbitsphere Dirac delta function of radius=0.567a₀ and charge/mass density of

$$\frac{2}{4 {π ( 0.567 {a}_{o} )}^{2}} .$$

For radial units in terms of aₒ

$$a ( ρ , φ , z ) = π ( z ) ⊗ \frac{2}{4 {π ( 0.567 {a}_{o} )}^{2}} [ δ ( r - 0.567 {a}_{o} ) ] \qquad ( 35.48 )$$

where a(ρ,φ,z) is given in cylindrical coordinates, π(z), the xy-plane wave is given in Cartesian coordinates with the propagation direction along the z-axis, and the He atom orbitsphere function,

$$\frac{2}{4 {π ( 0.567 {a}_{o} )}^{2}} [ δ ( r - 0.567 {a}_{o} ) ] ,$$

is given in spherical coordinates.

$$a ( ρ , φ , z ) = \frac{2}{4 {π ( 0.567 {a}_{o} )}^{2}} \sqrt{{( 0.567 {a}_{o} )}^{2} - {z}^{2}} δ ( r - \sqrt{{( 0.567 {a}_{o} )}^{2} - {z}^{2}} ) \qquad ( 35.49 )$$

For circular symmetry [5],

$$F ( s ) = \frac{2}{4 {π ( 0.567 {a}_{o} )}^{2}} 2 π {\int }_{0}^{∞} {\int }_{- ∞}^{∞} \sqrt{{( 0.567 {a}_{o} )}^{2} - {z}^{2}} δ ( ρ - \sqrt{{( 0.567 {a}_{o} )}^{2} - {z}^{2}} ) {J}_{o} ( s ρ ) {e}^{- i wz} ρ d ρ d z \qquad ( 35.50 )$$

Eq. (35.50) may be expressed as

$$F ( s ) = \frac{4 π}{4 {π ( 0.567 {a}_{o} )}^{2}} {\int }_{- {z}_{o}}^{{z}_{o}} ( {z}_{0}^{2} - {z}^{2} ) {J}_{o} ( s \sqrt{{z}_{o}^{2} - {z}^{2}} ) ) {e}^{i wz} d z ; {z}_{0} = 0.567 {a}_{0} \qquad ( 35.51 )$$

### Substitution of

$$\frac{z}{{z}_{o}} = - cos θ$$

gives

$$F ( s ) = \frac{4 π {z}_{o}^{2}}{4 π {z}_{o}^{2}} {\int }_{0}^{π} {sin}^{3} θ {J}_{o} ( {sz}_{o} sin θ ) {e}^{i {z}_{0} w cos θ} d θ \qquad ( 35.52 )$$

Substitution of the recurrence relationship,

$${J}_{o} ( x ) = \frac{2 {J}_{1} ( x )}{x} - {J}_{2} ( x ) ; x = {sz}_{0} sin θ \qquad ( 35.53 )$$

into Eq. (35.52), and, using the general integral of Apelblat [6]

$${\int }_{0}^{π} {( sin θ )}^{υ + 1} {J}_{υ} ( b sin θ ) {e}^{i a cos θ} d θ = {{[ \frac{2 π}{{a}^{2} + {b}^{2}} ]}^{\frac{1}{2}} [ \frac{b}{{a}^{2} + {b}^{2}} ]}^{υ} {J}_{υ + 1 / 2} [ {( {a}^{2} + {b}^{2} )}^{\frac{1}{2}} ] \qquad ( 35.54 )$$

with a=zₒw and b=zₒs gives:

$$F ( s ) = {[ \frac{2 π}{{( {z}_{o} w )}^{2} + {( {z}_{o} s )}^{2}} ]}^{\frac{1}{2}} \cdot \{ \begin{matrix}2 [ \frac{{z}_{o} s}{{( {z}_{o} w )}^{2} + {( {z}_{o} s )}^{2}} ] {J}_{3 / 2} [ {( {( {z}_{o} w )}^{2} + {( {z}_{o} s )}^{2} )}^{1 / 2} ] - \\ {[ \frac{{z}_{o} s}{{( {z}_{o} w )}^{2} + {( {z}_{o} s )}^{2}} ]}^{2} {J}_{5 / 2} [ {( {( {z}_{o} w )}^{2} + {( {z}_{o} s )}^{2} )}^{1 / 2} ]\end{matrix} \} \qquad ( 35.55 )$$

The electron elastic scattering intensity is given by a constant times the square of the amplitude given by Eq. (35.55).

$$\begin{matrix}{I}_{1}^{ed} = {I}_{e} {\{ \begin{matrix}{[ \frac{2 π}{{( {z}_{o} w )}^{2} + {( {z}_{o} s )}^{2}} ]}^{\frac{1}{2}} \\ \{ \begin{matrix}2 [ \frac{{z}_{o} s}{{( {z}_{o} w )}^{2} + {( {z}_{o} s )}^{2}} ] {J}_{3 / 2} [ {( {( {z}_{o} w )}^{2} + {( {z}_{o} s )}^{2} )}^{1 / 2} ] - \\ {[ \frac{{z}_{o} s}{{( {z}_{o} w )}^{2} + {( {z}_{o} s )}^{2}} ]}^{2} {J}_{5 / 2} [ {( {( {z}_{o} w )}^{2} + {( {z}_{o} s )}^{2} )}^{1 / 2} ]\end{matrix} \}\end{matrix} \}}^{2} \\ where & ( 35.56 ) \\ s = \frac{4 π}{λ} sin \frac{θ}{2} ; w = 0 ( units of {Å}^{- 1} ) & ( 35.57 )\end{matrix}$$

The scattering amplitude function, F(s) (Eq. (35.55)) and the differential cross section σ(θ) (proportional to the scattering intensity given by Eq. (35.56)) for the elastic scattering of 42.3 eV electrons to form hyperbolic electrons as a function of angle are shown graphically in FIGS. 3A and 3B, respectively.

Consider an incident electron having a de Broglie wavelength λₒ given by Eq. (35.44) corresponding to λ in Eq. (35.57). The convolution integral gives an aperture function that has the factor (Eq. (35.49)) of \sqrt{z₀²−z²}δ(ρ−\sqrt{z₀²−z²}) such that an electron may be elastically scattered by an atom to form a stable current on a two dimensional sphere having a radius of zₒ=ρₒ wherein the mass-density function on the two-dimensional spherical surface is given by

σₘ(ρ,φ,z)=Nmₑ\sqrt{ρ₀²−z²}δ(ρ−\sqrt{ρ₀²−z²}) (35.58)

The scattering distribution is given by Eqs. (35.56) and (35.57). To conserve angular momentum and energy, and to achieve force balance, such an electron called a hyperbolic electron has a negatively curved velocity distribution on the spherical surface given by Eq. (35.67) that causes it to behave differently in a gravitational field then a bound or free electron. With the condition zₒ=ρₒ=r₀, the elastic electron scattering intensity at the far field angle Θ is determined by the boundary conditions of the curvature of spacetime due to the presence of a gravitating body and the constant maximum velocity of the speed of light. The far field condition must be satisfied with respect to electron scattering and the gravitational orbital equation. The former condition is met by Eq. (35.56) and Eq. (35.57). The latter is derived in the Hyperbolic-Electron-Based

Propulsion Device section and is met by Eqs. (35.148-35.156) where the far field angle Θ is centered about the hyperbolic gravitational trajectory at angle φ given by Eq. (35.156). Thus, the parameter s of Eq. (35.57) is given by the following convolution:

$$\begin{matrix}s = \frac{4 π}{λ} sin ( θ ) ⊗ δ ( θ - ( Θ + φ ) ) \\ = \frac{4 π}{λ} sin ( Θ + φ )\end{matrix} \qquad ( 35.59 )$$

where the boundary conditions that the deflected beam pattern is away from the gravitating body and the conservation of current were applied.

The charge density, mass density, velocity, current density, and angular momentum of the scattered hyperbolic electron are on a spherical surface and are symmetrical about the z-axis about which current circulates. The surface mass/charge-density function, σₘ(ρ,φ,z), given in cylindrical coordinates, is derived as a boundary value problem with continuity and conservation principles applied in the same manner as for the free electron given in the Electron in Free Space section. The distinction is that the hyperbolic electron's current density is symmetric about the z-axis on a two dimensional sphere rather in a plane. The charge and mass-densities have the same dependency on z, but the coordinates transform from polar to cylindrical. The total mass is mₑ, and Eq. (35.58) must be normalized factor by the normalization factor N for cylindrical coordinates.

$$\begin{matrix}{m}_{e} = N {\int }_{- {ρ}_{0}}^{{ρ}_{0}} {\int }_{0}^{2 π} {\int }_{- ∞}^{∞} \sqrt{{ρ}_{0}^{2} - {z}^{2}} δ ( ρ - \sqrt{{ρ}_{0}^{2} - {z}^{2}} ) ρ d ρ d φ d z & ( 35.60 ) \\ N = \frac{{m}_{e}}{\frac{8}{3} {πρ}_{0}^{3}} & ( 35.61 )\end{matrix}$$

The mass-density function, σₘ(ρ,φ,z), of the scattered electron is

$${σ}_{m} ( ρ , φ , z ) = \frac{{m}_{e}}{\frac{8}{3} {πρ}_{0}^{3}} \sqrt{{ρ}_{0}^{2} - {z}^{2}} δ ( ρ - \sqrt{{ρ}_{0}^{2} - {z}^{2}} ) \\ {σ}_{m} ( ρ , φ , z ) = \frac{{m}_{e}}{\frac{8}{3} {πρ}_{0}^{2}} \sqrt{1 - {( \frac{z}{{ρ}_{0}} )}^{2}} δ ( ρ - {ρ}_{0} \sqrt{1 - {( \frac{z}{{ρ}_{0}} )}^{2}} ) \qquad ( 35.62 )$$

and charge-density distribution, σₑ(ρ,φ,z), is

$${σ}_{e} ( ρ , φ , z ) = \frac{e}{\frac{8}{3} {πρ}_{0}^{3}} \sqrt{{ρ}_{0}^{2} - {z}^{2}} δ ( ρ - \sqrt{{ρ}_{0}^{2} - {z}^{2}} ) \\ {σ}_{e} ( ρ , φ , z ) = \frac{e}{\frac{8}{3} {πρ}_{0}^{2}} \sqrt{1 - {( \frac{z}{{ρ}_{0}} )}^{2}} δ ( ρ - {ρ}_{0} \sqrt{1 - {( \frac{z}{{ρ}_{0}} )}^{2}} ) \qquad ( 35.63 )$$

The magnitude of the angular velocity of the orbitsphere given by Eq. (1.55) is

$$ω = \frac{ℏ}{{m}_{e} {r}_{0}^{2}} \qquad ( 35.64 )$$

The current-density function of the scattered hyperbolic electron, J(ρ,φ,z,t), in cylindrical coordinates can be found by convolving a plane, corresponding to the incident electron, with the orbitsphere uniform current density. The convolution is integral over r=r₀ to r=∞ of the product of the charge of the orbitsphere (Eq. (3.3)) times the angular velocity as a function of the radius r (Eq. (35.64)) corresponding to the incident electron forming an orbitsphere with the charge density given by Eq. (35.63):

$${\int }_{{r}_{o}}^{∞} ωπ ( z ) ⊗ δ ( r - {r}_{0} ) d r = \frac{e}{\frac{8}{3} π {r}_{0}^{3}} {\int }_{{r}_{0}}^{∞} \frac{ℏ}{{m}_{e} {r}^{2}} \sqrt{{r}_{0}^{2} - {z}^{2}} δ ( r - \sqrt{{r}_{0}^{2} - {z}^{2}} ) d r \qquad ( 35.65 )$$

With the substitution ρ₀=r₀, the cylindrically symmetric result in the corresponding coordinates is

$$J ( ρ , φ , z ) = [ \frac{e}{\frac{8}{3} {πρ}_{0}^{3}} \frac{ℏ}{{m}_{e} \sqrt{{ρ}_{0}^{2} - {z}^{2}}} δ ( ρ - \sqrt{{ρ}_{0}^{2} - {z}^{2}} ) {i}_{φ} ] \qquad ( 35.66 )$$

Then, the velocity in cylindrical coordinates is

$$\begin{matrix}v ( ρ , φ , z , t ) = [ \frac{ℏ}{{m}_{e} \sqrt{{ρ}_{0}^{2} - {z}^{2}}} δ ( ρ - \sqrt{{ρ}_{0}^{2} - {z}^{2}} ) {i}_{φ} ] \\ = [ \frac{ℏ}{{m}_{e} {ρ}_{0} \sqrt{1 - {( \frac{z}{{ρ}_{0}} )}^{2}}} δ ( ρ - {ρ}_{0} \sqrt{1 - {( \frac{z}{{ρ}_{0}} )}^{2}} ) {i}_{φ} ]\end{matrix} \qquad ( 35.67 )$$

The angular momentum, L, is given by

Li_{z}=mₑρ²ωi_{z}=mₑρi_{ρ}×vi_{φ} (35.68)

Substitution of mₑ for e in Eq. (35.66) followed by substitution into Eq. (35.68) gives the angular momentum-density function, L

$${Li}_{z} = \frac{{m}_{e}}{\frac{8}{3} {πρ}_{0}^{3}} \frac{ℏ}{{m}_{e} \sqrt{{ρ}_{0}^{2} - {z}^{2}}} {ρ}^{2} δ ( ρ - \sqrt{{ρ}_{0}^{2} - {z}^{2}} ) \qquad ( 35.69 )$$

The total angular momentum of the hyperbolic electron is given by integration over the two-dimensional surface having the angular momentum density given by Eq. (35.69).

$$\begin{matrix}{Li}_{z} = {\int }_{- {ρ}_{0}}^{{ρ}_{0}} {\int }_{0}^{2 π} {\int }_{- ∞}^{∞} \frac{{m}_{e}}{\frac{8}{3} {πρ}_{0}^{3}} \frac{ℏ}{{m}_{e} \sqrt{{ρ}_{0}^{2} - {z}^{2}}} δ ( ρ - \sqrt{{ρ}_{0}^{2} - {z}^{2}} ) {ρ}^{2} ρ d ρ d φ d z & ( 35.70 ) \\ {Li}_{z} = ℏ & ( 35.71 )\end{matrix}$$

Eqs. (35.71) and (35.77) are in agreement with Eq. (1.141); thus, the scalar sum of the magnitude of the angular momentum is conserved.

The mass, charge, and current of the scattered hyperbolic electron exist on a two-dimensional sphere which may be given in spherical coordinates where θ is with respect to the z-axis of the original cylindrical coordinate system. The mass-density function, σₘ(r,θ,φ), of the hyperbolic electron in spherical coordinates is

$${σ}_{m} ( r , θ , φ ) = \frac{{m}_{e}}{\frac{8}{3} π {r}_{0}^{2}} sin θδ ( r - {r}_{0} ) \qquad ( 35.72 )$$

The charge-density distribution, σₑ(r,θ,φ), in spherical coordinates is

$${σ}_{e} ( r , θ , φ ) = \frac{e}{\frac{8}{3} π {r}_{0}^{2}} sin θδ ( r - {r}_{0} ) \qquad ( 35.73 )$$

The current-density function J(r,θ,φ,t), in spherical coordinates is

$$J ( r , θ , φ , t ) = [ \frac{e}{\frac{8}{3} π {r}_{0}^{2}} \frac{ℏ}{{m}_{e} {r}_{0}^{2} sin θ} δ ( r - {r}_{0} ) {i}_{φ} ] \qquad ( 35.74 )$$

The velocity v(ρ,φ,z,t) in spherical coordinates is

$$v ( r , θ , φ , t ) = [ \frac{ℏ}{{m}_{e} {r}_{0} sin θ} δ ( r - {r}_{0} ) {i}_{φ} ] \qquad ( 35.75 )$$

The total angular momentum of the hyperbolic electron is given by integration over the two-dimensional negatively curved surface having the angular momentum density in spherical coordinates given by

$$\begin{matrix}{Li}_{z} = {\int }_{0}^{2 π} {\int }_{0}^{π} {\int }_{0}^{∞} \frac{{m}_{e} sin θ}{\frac{8}{3} π {r}_{0}^{3}} \frac{ℏ}{{m}_{e} {r}_{0} sin θ} {r}_{0}^{2} {sin}^{2} θδ ( r - {r}_{0} ) {r}^{2} sin θ d r d θ d φ & ( 35.76 ) \\ {Li}_{z} = ℏ & ( 35.77 )\end{matrix}$$

where the angular momentum density is given by Eq. (35.69) and ρ=r₀ sin θ.

### Hyperbolic-Electron Radii and Features

The electron orbitsphere of an atom has a constant velocity as a function of angle. Whereas, scattering of electrons from targets at a special energies such as the case where the incident electron's de Broglie wavelength equal to the radius z₀=ρ₀=0.567a₀ according to Eqs. (35.56), (35.57) (35.95), and (35.129-35.132) gives rise to an electron having a stable two-dimensional spherical shape with a velocity function on the surface whose magnitude approaches the limit of light-speed at opposite poles (Eq. (35.75)). The velocity function (Eq. (35.67) or Eq. (35.75)) is a hyperboloid. It exists on a two-dimensional sphere; thus, it is spatially bounded. The mass and charge functions given by Eq. (35.72) and Eq. (35.73), respectively, are finite on a two-dimensional sphere; thus, they are bounded. The scattered electron having a negatively curved two-dimensional velocity surface is called a hyperbolic electron. A unique photon excitation provides for the stability of hyperbolic electrons according to similar principles of other types of excited states.

As shown in the Excited States of the One-Electron Atom (Quantization) section, the orbitsphere is a resonator cavity that traps single photons of discrete frequencies. Thus, photon absorption occurs as an excitation of a resonator mode. The electric field lines of the “trapped photon” comprise an orbitsphere at the inner surface of the electron orbitsphere that spins around the z-axis at the same angular frequency as a spherical harmonic modulation function of the orbitsphere charge-density function. The angular momentum of the photon given by

$$m = \int \frac{1}{8 π c} Re [ r \times ( E \times {B}^{*} ) ] d {x}^{4} = ℏ$$

in the Photon section is conserved for the solutions for the resonant photons and excited state electron functions. The velocity along a great circle is light speed; thus, the relativistic electric field of a trapped resonant photon of an excited state are radial. The photon's electric field superposes that of the proton such that the radial electric field has a magnitude proportional to Z/n at the electron where n=1,2,3, . . . for excited states and

$$n = \frac{1}{2} , \frac{1}{3} , \frac{1}{4} , … , \frac{1}{137}$$

for lower energy states given in the Hydrino Theory—BlackLight Process section. This causes the charge density of the electron to correspondingly decrease and the radius to increase for states higher than 13.6 eV and the charge density of the electron to correspondingly increase and the radius to decrease for states lower than 13.6 eV.

Photons can propagate electron-surface current and maintain force balance in other excitations as well, such as during Larmor excitation in a magnetic field as given in the Magnetic Parameters of the Electron (Bohr Magneton) section. Furthermore, photons can exclusively maintain the current of a fundamental particle or a state of a fundamental particle in force balance. An example of the former involves the strong nuclear force wherein heavy photons called gluons can solely maintain the force balance of quarks in baryons as given in the Quark and Gluon Functions section. An example of the latter is the observation that free electrons in liquid helium form physical hollow bubbles that serve as resonator cavities that transition to fractional (1/integer) sizes and migrate at different rates when an electric field is applied as shown in the Stability of Fractional-Principal-Quantum States of Free Electrons in Liquid Helium section. Specifically, free electrons are trapped in superfluid helium as autonomous electron bubbles interloped between helium atoms that have been excluded from the space occupied by the bubble. The surrounding helium atoms maintain the spherical bubble through van der Waals forces. The bubble-like orbitsphere can act as a resonator cavity. The excitation of the Maxwellian resonator cavity modes by resonant photons form bubbles with radii of reciprocal integer multiples of that of the unexcited n =1 state. The central force that results in a fractional electron radius compared to the unexcited electron is provided by the absorbed photon. Each stable excited state electron bubble which has a radius of

$$\frac{{r}_{1}}{integer}$$

may migrate in an applied electric field. The photo-conductivity absorption spectrum of free electrons in superfluid helium and their mobilities predicted from the corresponding size and multipolarity of these long-lived bubble-like states with quantum numbers n, l, and mₗ matched the experimental results of the 15 identified ions. Further examples of the existence of free electrons as bubble-like cavities in fluids devoid of any molecules are free electrons in liquid ammonia and in oils which are also discussed with the supporting data in the Stability of Fractional-Principal-Quantum States of Free Electrons in Liquid Helium section.

Thus, it is a general phenomenon that photon absorption occurs as an excitation of a resonator mode; consequently, the hydrogen atomic energy states are quantized as a function of the parameter n as shown in the Excited States (Quantization) section. Each value of n corresponds to an allowed transition caused by a resonant photon which excites the transition of the orbitsphere resonator cavity. In the case of free electrons in superfluid helium, the central field of the proton is absent; however, the electron is maintained as an orbitsphere by the pressure of the surrounding helium atoms. In this case, rather than the traditional integer values (1, 2, 3, . . . ,) of n, values of reciprocal integers are allowed according to Eq. (2.2) where both the radii and wavelengths of the states are reciprocal integer multiples of that of the n=1 state and correspond to transitions with an increase in the effective central field that decreases the radius of the orbitsphere. In these cases, the electron undergoes a transition to a nonradiative higher-energy state. The trapped photon electric field which provides force balance for the orbitsphere is a solution of Laplace's equation in spherical coordinates and is given by Eq. (35.80).

In each case, the “trapped photon” is a “standing electromagnetic wave” which actually is a circulating wave that propagates around the z-axis, and its source current superimposes with each great circle current loop of the orbitsphere. The time-function factor, k(t), for the “standing wave” is identical to the time-function factor of the orbitsphere in order to satisfy the boundary (phase) condition at the orbitsphere surface. Thus, the angular frequency of the “trapped photon” has to be identical to the angular frequency of the electron orbitsphere, ωₙ, given by Eq. (1.55). Furthermore, the phase condition requires that the angular functions of the “trapped photon” have to be identical to the spherical harmonic angular functions of the electron orbitsphere. Combining k(t) with the φ-function factor of the spherical harmonic gives e^{i(mφ-ω}^{ₙ}ⁱ⁾ for both the electron and the “trapped photon” function. The angular functions in phase with the corresponding photon functions are the spherical harmonics. The charge-density functions including the time-function factor (Eq. (1.64-1.65)) are

$$\begin{matrix}l = 0 \\ ρ ( r , θ , φ , t ) = \frac{e}{8 π {r}^{2}} [ δ ( r - {r}_{n} ) ] [ {Y}_{0}^{0} ( θ , φ ) + {Y}_{l}^{m} ( θ , φ ) ] & ( 35.78 ) \\ l \neq 0 \\ ρ ( r , θ , φ , t ) = \frac{e}{4 π {r}^{2}} [ δ ( r - {r}_{n} ) ] [ \begin{matrix}{Y}_{0}^{0} ( θ , φ ) + \\ Re \{ {Y}_{l}^{m} ( θ , φ ) {e}^{i {ω}_{n} t} \}\end{matrix} ] & ( 35.79 )\end{matrix}$$

where Yₗ^{m}(θ,φ) are the spherical harmonic functions that spin about the z-axis with angular frequency ωₙ with Y₀⁰(θ,φ) the constant function. Re{Yₗ^{m}(θ,φ)e^{iω}^{ₙ}^{t}}=Pₗ^{m}(cos θ)cos(mφ+ω′ₙt) where to keep the form of the spherical harmonic as a traveling wave about the z-axis, ω′ₙ=mωₙ.

The solution of the “trapped photon” field of electrons in helium that is analogous to those of hydrogen excited states given by Eq. (2.15) is

$${E}_{r photon n , l , m} = C \frac{{e ( na )}^{l}}{4 {πɛ}_{o}} \frac{1}{{r}^{( l + 2 )}} [ \frac{1}{n} [ \begin{matrix}{Y}_{0}^{0} ( θ , φ ) + \\ Re \{ {Y}_{l}^{m} ( θ , φ ) {e}^{i {ω}_{n} t} \}\end{matrix} ] ] δ ( r - {r}_{n} ) {i}_{r} \\ {ω}_{n} = 0 for m = 0 \\ n = 1 , \frac{1}{2} , \frac{1}{3} , \frac{1}{4} , … , \frac{1}{p} \\ l = 1 , 2 , … , n - 1 \\ m = - l , - l + 1 , … , 0 , … , + l \qquad ( 35.80 )$$

In Eq. (35.80), a is the radius of the electron in helium without an absorbed photon. C is a constant expressed in terms of an equivalent central charge. It is determined by the force balance between the centrifugal force of the electron orbitsphere and the radial force provided by the pressure from the van der Waals force of attraction between helium atoms given by Eqs. (42.126-42.132).

For fractional quantum energy states of the electron, σₚₕₒₜₒₙ, the two-dimensional surface charge density due to the “trapped photon” at the electron orbitsphere, follows from Eqs. (5.8) and (2.11):

$${σ}_{photon} = \frac{e}{4 {π ( {r}_{n} )}^{2}} [ - \frac{1}{n} [ \begin{matrix}{Y}_{0}^{0} ( θ , φ ) + \\ Re \{ {Y}_{l}^{m} ( θ , φ ) {e}^{i {ω}_{n} t} \}\end{matrix} ] ] δ ( r - {r}_{n} ) \\ n = 1 , \frac{1}{2} , \frac{1}{3} , \frac{1}{4} , … , \qquad ( 35.81 )$$

And, σ_{electron}, the two-dimensional surface charge density of the electron orbitsphere is

$${σ}_{electron} = \frac{- e}{4 {π ( {r}_{n} )}^{2}} [ \begin{matrix}{Y}_{0}^{0} ( θ , φ ) + \\ Re \{ {Y}_{l}^{m} ( θ , φ ) {e}^{{iω}_{n} t} \}\end{matrix} ] δ ( r - {r}_{n} ) \qquad ( 35.82 )$$

The superposition of σₚₕₒₜₒₙ (Eq. (35.81)) and σ_{electron}, (Eq. (35.82)) where the spherical harmonic functions satisfy the conditions given in the Angular Function section gives a radial electric monopole represented by a delta function.

$${σ}_{photon} + {σ}_{electron} = \frac{- e}{4 {π ( {r}_{n} )}^{2}} \frac{1}{n} [ \begin{matrix}{Y}_{0}^{0} ( θ , φ ) + \\ Re \{ {Y}_{l}^{m} ( θ , φ ) {e}^{{iω}_{n} t} \}\end{matrix} ] δ ( r - {r}_{n} ) \\ n = 1 , \frac{1}{2} , \frac{1}{3} , \frac{1}{4} , … , \qquad ( 35.83 )$$

The radial delta function does not possess spacetime Fourier components synchronous with waves traveling at the speed of light [7-9]. Thus, the fractional quantum energy states are stable as given in the Boundary Condition of Nonradiation and the Radial Function—the Concept of the “Orbitsphere” section.

Similarly, scattering of electrons with special resonant kinetic energies such as 42.3 eV can result in the excitation of a hyperbolic electron-an electron state having a unique trapped photon that maintains the electron in a stable two-dimensional spherical shape with a velocity function on the surface whose magnitude approaches the limit of light-speed at opposite poles (Eq. (35.75)) corresponding to a negatively curved two-dimensional velocity surface. The mass and charge functions are given by Eqs. (35.72) and (35.73), respectively. The trapped photon that maintains the hyperbolic-electron state has similar characteristics as that corresponding to the Larmor precession of the magnetostatic dipole results in magnetic dipole radiation or absorption during a Stern-Gerlach transition as given in the Magnetic Parameters of the Electron (Bohr Magneton) section.

The photon gives rise to current on the surface that phase-matches the charge (mass) density of Eq. (1.123) and Eq. (35.73) and satisfies the condition

∇·J=0 (35.84)

To satisfy the condition of Eq. (35.84) and the nonradiative condition, the current is constant azimuthally. In addition, the photon standing wave of a hyperbolic-electron state also comprises a spherical harmonic function which satisfies Laplace's equation in spherical coordinates, conserves the photon angular momentum of , and provides the force balance for the corresponding charge (mass)-density wave. The corresponding central field at the orbitsphere surface after Eqs. (2.10-2.17) is given by

$$E = \frac{e}{4 {πɛ}_{o} {r}^{2}} [ {Y}_{0}^{0} ( θ , φ ) {i}_{y} + Re \{ {Y}_{l}^{m} ( θ , φ ) {e}^{{iω}_{n} t} \} {i}_{y} δ ( r - {r}_{1} ) ] \qquad ( 35.85 )$$

where the spherical harmonic dipole Yₗ^{m}(θ,φ)=sin θ is with respect to an Sₚ-axis (subscript p designates the photon spin vector and e designates the intrinsic hyperbolic electron spin). The dipole spins about the Sₚ-axis, the z-axis in cylindrical coordinates at the angular velocity given by Eq. (1.55). In the frame rotating about the Sₚ-axis, the electric field of the dipole is

$$\begin{matrix}E = \frac{e}{4 {πɛ}_{o} {r}^{2}} sin θsinϕδ ( r - {r}_{1} ) {i}_{y} & ( 35.86 ) \\ E = \frac{e}{4 {πɛ}_{o} {r}^{2}} ( sin θsinφ {i}_{r} + cos θsinφ {i}_{θ} + sin θcosφ {i}_{φ} ) δ ( r - {r}_{1} ) & ( 35.87 )\end{matrix}$$

The resulting current is nonradiative as shown by Eq. (1.39) and in Appendix I: Nonradiation Based on the Electromagnetic Fields and the Poynting Power Vector. Thus, the field in the rotating frame is magnetostatic as shown in FIG. 1.17 but directed along the z-axis. The time-averaged angular momentum and rotational energy due to the charge density wave are zero as given by Eqs. (1.109a) and (1.109b). However, the corresponding time-dependent surface charge density [symbol] σ [symbol] that gives rise to the dipole current of Eq. (1.123) as shown by Haus [10] is equivalent to the current due to a uniformly charged sphere rotating about the z-axis at the constant angular velocity given by Eq. (1.55). The charge density is given by Gauss' law at the two-dimensional surface:

σ=−ε₀n·Φ|ᵣ₌ᵣ_{₁}=−ε₀n·E|ᵣ₌ᵣ_{₁} (35.88)

### From Eq. (35.87), σ is

$$〈 σ 〉 = \frac{e}{4 π {r}_{1}^{2} } \frac{3}{2} sin θ \qquad ( 35.89 )$$

and the current (Eq. (1.123) is given by the product of Eq. (35.89) and the angular frequency (Eq. (1.55)). The velocity along a great circle is light speed; thus, the relativistic electric field of the trapped resonant photon of an hyperbolic-electron state are radial for the spherical component and perpendicular to the cylindrical-coordinate z-axis in the case of the components comprising cylindrical current. In each case, the electric field force and the corresponding magnetic-field force maintains a force balance with the centrifugal force.

During the transition of the free electron which is a two-dimensional disc lamina to a hyperbolic electron, the electron charge distribution becomes that of a 2-D uniform spherical shell of charge of radius r₀, and the electric field of the electron is zero for r<r₀ and the field is equivalent to that of a point charge −e at the origin for r>r₀ as shown in FIG. 1.20. The since the fields are spatially matched, the central force of the electron surface due to the trapped photon is given by Eq. (7.3):

$${F}_{ele} = \frac{{e}^{2}}{4 {πɛ}_{o} {r}^{2}} \qquad ( 35.90 )$$

The uniform current along the z-axis held in force balance by the electric field of the photon gives rise to magnetic field along the z-axis which in turn gives rise to a second magnetic force-balance term. Consider that the vector Sₚ corresponding to the spherical harmonic dipole Yₗ^{m}(θ,φ)=sin θ has a magnitude of

$$\frac{\sqrt{5}}{4} ℏ$$

at θ=26.57° from the Z-axis having the same angular momentum components as the bound electron orbitsphere given by Eqs. (1.76-1.77). Torque balance is achieved when the hyperbolic-electron intrinsic angular momentum of precesses away from the original z-axis by an angle

$$\frac{π}{3}$$

and then continuously precesses about the new Z-axis as shown in FIG. 4. In the stationary frame, the sum of the photon and intrinsic-electron angular momentum gives on the Z-axis and the

$$\frac{ℏ}{4}$$

X-axis projection averages to zero. Thus, the Z-component of angular momentum is conserved. The vector Sₑ has a magnitude of which conserves the intrinsic hyperbolic-electron angular momentum. The energy to flip the orientation of the Sₑ by 180° gives rise to a magnetic force F_{mag} given by Eq. (35.91).

As shown in the Electron in Free Space section (Eq. (3.51)), the centrifugal force within the two-dimensional disc lamina of the free electron is balanced by the magnetic force, and the total energy of the free electron is its translational energy. Consider the radiation-reaction force on a free electron in the formation of a hyperbolic electron. This force derived from the relativistically invariant relationship between momentum and energy achieves the condition that the sum of the mechanical momentum and electromagnetic momentum is conserved. This force F_{mag} given by Eq. (7.31) is

$${F}_{mag} = \frac{{ℏ}^{2}}{2 {m}_{e} {r}^{3}} \sqrt{\frac{3}{4}} {i}_{r} \qquad ( 35.91 )$$

wherein Z=1 and the force is one-half that in the case of pairing electrons since the spin projection of the trapped photon is

$$\frac{ℏ}{2} .$$

This force arises as an interaction of the time-independent photon driven modulation current and the electron orbitsphere spin function. The interaction of the photon's electric field and the electron charge density is given by the electric force (Eq. (35.90)). Energy balance is achieved when the magnitude of the photon field is equivalent to +e at the origin such that the photon-electron electric energy and magnetic energies are balanced by the corresponding self energies given by Eq. (54) of Appendix IV and the negative of Eq. (7.40), respectively. Then, the total energy is the kinetic energy which is equivalent to the initial translational kinetic energy as required for energy conservation. In this case, the de Broglie-relationship continuity relationship is maintained in the formation of a hyperbolic electron from a free electron in the same manner as in the case of the ionization of a bound atomic electron to form a free electron. The radius of the hyperbolic electron is given by balance of the forces corresponding to the energies that satisfy the energy balance and continuity conditions. The outward centrifugal force (Eqs. (7.1-7.2)) is balanced by the electric force (Eq. (35.90)) and the magnetic force (Eq. (35.91)):

$${m}_{e} {ρ}_{1} {ω}^{2} = \frac{{e}^{2}}{4 {πɛ}_{0} {ρ}^{2}} + \frac{{ℏ}^{2} sin θ}{2 {m}_{e} {ρ}^{3}} \sqrt{s ( s + 1 )} \qquad ( 35.92 )$$

wherein the force balance is about the z-axis, or Sₑ-axis of FIG. 4. From Eqs. (35.72) and (35.75),

$${m}_{e} sin θ {r}_{1} sin θ \frac{{ℏ}^{2}}{{m}_{e}^{2} {r}_{0}^{4} {sin}^{4} θ} = \frac{{e}^{2}}{4 {πɛ}_{0} {r}_{0}^{2} {sin}^{2} θ} + \frac{{ℏ}^{2} sin θ}{2 {m}_{e} {r}_{0}^{3} {sin}^{3} θ} \sqrt{s ( s + 1 )} \qquad ( 35.93 )$$

Then, the force balance for l=0 mₗ=0 is

$$\begin{matrix}\frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} & ( 35.94 ) \\ {r}_{0} = {a}_{0} ( 1 - \frac{\sqrt{\frac{3}{4}}}{2} ) = 0.567 {a}_{o} & ( 35.95 )\end{matrix}$$

By substituting the radius given by Eq. (35.95) into Eq. (1.47), the velocity v is given by

$$v = \frac{ℏ}{\frac{4 {πɛ}_{0} {ℏ}^{2}}{{e}^{2}} ( 1 - \frac{\sqrt{\frac{3}{4}}}{2} )} = \frac{α c}{( 1 - \frac{\sqrt{\frac{3}{4}}}{2} )} \qquad ( 35.96 )$$

where Eqs. (1.183) and (1.187) were used. Thus the general force balance equation is given by

$${F}_{centifugal} = {F}_{Coulombic} + \sum {F}_{mag}$$

$$\frac{{ℏ}^{2}}{{m}_{e} {r}^{3}} = \frac{{e}^{2}}{4 {πɛ}_{0} {r}^{2}} + \sum {F}_{mag}$$

(35.96a) where is the F_{centrifugal} is the centrifugal force, F_{Coulombic} is the Coulombic force, and ΣF_{mag} is the sum of the magnetic forces.

To conserve the angular momentum of photons of different polarizations, the corresponding orbital angular momentum states of the hyperbolic electron can be excited based on the solutions of Laplace's equation. The orbital angular momentum can add to the spin angular momentum of the electron to give rise to corresponding forces that result in decreased radii and energies at force balance as shown in Appendix VIII: The Relative Angular Momentum Components of Electron 1 and Electron 2 of Helium to Determine the Magnetic Interactions and the Central Magnetic Force section. The forces are given by Eqs. (1-14) of Appendix VIII. Since the current has extremes at the poles of the hyperbolic electron as given by Eq. (35.75), Eq. (10.82) also applies to the case of orbital angular momentum of the hyperbolic electron, except that the force is paramagnetic in this case. Since the photon source current is also at r₀, in Eq. (10.82) r₃=rₙ and the paramagnetic force is given by

$$\begin{matrix}{F}_{orbital} = {\sum }_{m} \frac{( l + \vert m \vert ) !}{( 2 l + 1 ) ( l - \vert m \vert ) !} \frac{{ℏ}^{2}}{4 {m}_{e} {r}_{0}^{3}} \sqrt{s ( s + 1 )} {i}_{r} \\ For l = 1 {m}_{l} = 0 & ( 35.97 ) \\ {F}_{orbital} = \frac{1}{3} \frac{{ℏ}^{2}}{4 {m}_{e} {r}_{0}^{3}} \sqrt{s ( s + 1 )} {i}_{r} \\ For l = 1 {m}_{l} = 1 & ( 35.98 ) \\ {F}_{orbital} = \frac{2}{3} \frac{{ℏ}^{2}}{4 {m}_{e} {r}_{0}^{3}} \sqrt{s ( s + 1 )} {i}_{r} & ( 35.99 )\end{matrix}$$

In addition, the angular momentum could be along the Sₚ as shown in FIG. 4 to add

$$\frac{ℏ}{2}$$

along the Z-axis. The corresponding force is

$${S}_{p} \\ {F}_{orbital} = \frac{1}{2} \frac{{ℏ}^{2}}{4 {m}_{e} {r}_{0}^{3}} \sqrt{s ( s + 1 )} {i}_{r} \qquad ( 35.100 )$$

The first fifteen hyperbolic electronic states are calculated using the force balance equation corresponding to Eq. (35.91) with the additional magnetic forces given by Eqs. (35.98-35-100) and linear combinations of these states which conserve the relationship between Coulombic energy and kinetic energy corresponding to Eq. (35.91). The magnetic quantum numbers, additional magnetic forces, the force-balance equations, and radii of the states are

$$\begin{matrix} l = 1 {m}_{l} = 0 & ( Eq . ( 35.98 ) ) \\ \frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )} & ( 35.101 ) \\ {r}_{0} = {a}_{0} ( 1 - ( 1 + \frac{1}{6} ) \frac{\sqrt{\frac{3}{4}}}{2} ) = 0.4948 {a}_{o} & ( 35.102 ) \\ l = 1 {m}_{l} = 1 & ( Eq . ( 35.99 ) ) \\ \frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )} & ( 35.103 ) \\ {r}_{0} = {a}_{0} ( 1 - ( 1 + \frac{1}{3} ) \frac{\sqrt{\frac{3}{4}}}{2} ) = 0.4226 {a}_{o} & ( 35.104 ) \\ {S}_{p} & ( Eq . ( 35.100 ) ) \\ \frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + \frac{1}{2} \frac{{ℏ}^{2}}{4 {m}_{e} {r}_{0}^{3}} \sqrt{s ( s + 1 )} & ( 35.105 ) \\ {r}_{0} = {a}_{0} ( 1 - ( 1 + \frac{1}{4} ) \frac{\sqrt{\frac{3}{4}}}{2} ) = 0.4587 {a}_{o} & ( 35.106 ) \\ Linear combination \text{:} ( l = 0 {m}_{l} = 0 ) + ( l = 1 {m}_{l} = 0 ) & ( Eq . ( 35.98 ) ) \\ \frac{{ℏ}^{2}}{{m}_{e} {r}^{3}} = \frac{{e}^{2}}{4 {πɛ}_{0} {r}^{2}} + 0.5 ( \begin{matrix}\frac{{ℏ}^{2}}{2 {m}_{e} {r}^{3}} \sqrt{s ( s + 1 )} + \\ \frac{{ℏ}^{2}}{2 {m}_{e} {r}^{3}} \sqrt{s ( s + 1 )} + \\ \frac{1}{3} \frac{{ℏ}^{2}}{4 {m}_{e} {r}_{0}^{3}} \sqrt{s ( s + 1 )}\end{matrix} ) & ( 35.107 ) \\ {r}_{0} = {a}_{0} ( 1 - ( 1 + \frac{1}{12} ) \frac{\sqrt{\frac{3}{4}}}{2} ) = 0.5309 {a}_{o} & ( 35.108 ) \\ Linear combination \text{:} {S}_{p} + ( l = 1 {m}_{l} = 0 ) & ( \begin{matrix}Eqs . ( 35.98 ) \\ and ( 35.100 )\end{matrix} ) \\ \frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + 0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} ) & ( 35.109 ) \\ {r}_{0} = {a}_{0} ( 1 - ( 1 + \frac{1}{8} + \frac{1}{12} ) \frac{\sqrt{\frac{3}{4}}}{2} ) = 0.4768 {a}_{o} & ( 35.110 ) \\ Linear combination \text{:} {S}_{p} + ( l = 1 {m}_{l} = 0 ) & ( \begin{matrix}Eqs . ( 35.99 ) \\ and ( 35.100 )\end{matrix} ) \\ \frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + 0.5 ( \frac{1}{2} \frac{{ℏ}^{2}}{4 {m}_{e} {r}_{0}^{3}} \sqrt{s ( s + 1 )} + \frac{2}{3} \frac{{ℏ}^{2}}{4 {m}_{e} {r}_{0}^{3}} \sqrt{s ( s + 1 )} ) & ( 35.111 ) \\ {r}_{0} = {a}_{0} ( 1 - ( 1 + \frac{1}{8} + \frac{1}{6} ) \frac{\sqrt{\frac{3}{4}}}{2} ) = 0.4407 {a}_{o} & ( 35.112 ) \\ Linear combination \text{:} {S}_{p} + ( l = 1 {m}_{l} = 0 ) + ( l = 1 {m}_{l} = 0 ) & ( \begin{matrix}Eqs . ( 35.98 ) \\ and ( 35.100 )\end{matrix} ) \\ \frac{{ℏ}^{2}}{{m}_{e} {r}^{3}} = ( \begin{matrix}\frac{{e}^{2}}{4 {πɛ}_{0} {r}^{2}} + \frac{{ℏ}^{2}}{2 {m}_{e} {r}^{3}} \sqrt{s ( s + 1 )} + \\ \frac{1}{3} \frac{{ℏ}^{2}}{4 {m}_{e} {r}_{0}^{3}} \sqrt{s ( s + 1 )} + \\ 0.5 ( \begin{matrix}\frac{1}{2} \frac{{ℏ}^{2}}{4 {m}_{e} {r}_{0}^{3}} \sqrt{s ( s + 1 )} + \\ \frac{1}{3} \frac{{ℏ}^{2}}{4 {m}_{e} {r}_{0}^{3}} \sqrt{s ( s + 1 )}\end{matrix} )\end{matrix} ) & ( 35.113 ) \\ {r}_{0} = {a}_{0} ( 1 - ( 1 + \frac{1}{6} + \frac{1}{8} + \frac{1}{12} ) \frac{\sqrt{\frac{3}{4}}}{2} ) = 0.4646 {a}_{o} & ( 35.114 ) \\ Linear combination \text{:} ( ( ( {S}_{p} + l = 1 {m}_{l} = 0 ) + ( l = 1 {m}_{l} = 0 ) ) + ( l = 1 {m}_{l} = 1 ) ) & ( \begin{matrix}Eqs . ( 35.98 ) , \\ ( 35.99 ) , \\ and ( 35.100 )\end{matrix} ) \\ \frac{{ℏ}^{2}}{{m}_{e} {r}^{3}} = ( \begin{matrix}\frac{{e}^{2}}{4 {πɛ}_{0} {r}^{2}} + 0.5 ( \begin{matrix}\frac{{ℏ}^{2}}{2 {m}_{e} {r}^{3}} \sqrt{s ( s + 1 )} + \\ \frac{1}{3} \frac{{ℏ}^{2}}{4 {m}_{e} {r}_{0}^{3}} \sqrt{s ( s + 1 )} + \\ \frac{{ℏ}^{2}}{2 {m}_{e} {r}^{3}} \sqrt{s ( s + 1 )} + \\ \frac{2}{3} \frac{{ℏ}^{2}}{4 {m}_{e} {r}_{0}^{3}} \sqrt{s ( s + 1 )}\end{matrix} ) + \\ 0.5 ( 0.5 ( \begin{matrix}\frac{1}{2} \frac{{ℏ}^{2}}{4 {m}_{e} {r}_{0}^{3}} \sqrt{s ( s + 1 )} + \\ \frac{1}{3} \frac{{ℏ}^{2}}{4 {m}_{e} {r}_{0}^{3}} \sqrt{s ( s + 1 )}\end{matrix} ) )\end{matrix} ) & ( 35.115 ) \\ {r}_{0} = {a}_{0} ( 1 - ( \frac{1}{2} + \frac{1}{12} + \frac{1}{2} + \frac{1}{6} + \frac{1}{16} + \frac{1}{24} ) \frac{\sqrt{\frac{3}{4}}}{2} ) = 0.4136 {a}_{o} & ( 35.116 ) \\ Linear combination \text{:} ( ( ( {S}_{p} + l = 1 {m}_{l} = 0 ) + ( l = 1 {m}_{l} = 0 ) ) + ( ( {S}_{p} + l = 1 {m}_{l} = 1 ) + ( l = 1 {m}_{l} = 0 ) ) ) & ( \begin{matrix}Eqs . ( 35.98 ) , \\ ( 35.99 ) , \\ and ( 35.100 )\end{matrix} ) \\ \frac{{ℏ}^{2}}{{m}_{e} {r}^{3}} = ( \begin{matrix}\frac{{e}^{2}}{4 {πɛ}_{0} {r}^{2}} + 0.5 ( \begin{matrix}\frac{{ℏ}^{2}}{2 {m}_{e} {r}^{3}} \sqrt{s ( s + 1 )} + \\ \frac{1}{3} \frac{{ℏ}^{2}}{4 {m}_{e} {r}_{0}^{3}} \sqrt{s ( s + 1 )} + \\ \frac{{ℏ}^{2}}{2 {m}_{e} {r}^{3}} \sqrt{s ( s + 1 )} + \\ \frac{1}{3} \frac{{ℏ}^{2}}{4 {m}_{e} {r}_{0}^{3}} \sqrt{s ( s + 1 )}\end{matrix} ) + \\ 0.5 ( \begin{matrix}0.5 ( \begin{matrix}\frac{1}{2} \frac{{ℏ}^{2}}{4 {m}_{e} {r}_{0}^{3}} \sqrt{s ( s + 1 )} + \\ \frac{1}{3} \frac{{ℏ}^{2}}{4 {m}_{e} {r}_{0}^{3}} \sqrt{s ( s + 1 )}\end{matrix} ) + \\ 0.5 ( \begin{matrix}\frac{1}{2} \frac{{ℏ}^{2}}{4 {m}_{e} {r}_{0}^{3}} \sqrt{s ( s + 1 )} + \\ \frac{2}{3} \frac{{ℏ}^{2}}{4 {m}_{e} {r}_{0}^{3}} \sqrt{s ( s + 1 )}\end{matrix} )\end{matrix} )\end{matrix} ) & ( 35.117 ) \\ {r}_{0} = {a}_{0} ( 1 - ( \begin{matrix}\frac{1}{2} + \frac{1}{12} + \frac{1}{2} + \frac{1}{12} + \\ \frac{1}{16} + \frac{1}{24} + \frac{1}{16} + \frac{1}{12}\end{matrix} ) \frac{\sqrt{\frac{3}{4}}}{2} ) = 0.3866 {a}_{o} & ( 35.118 ) \\ Linear combination \text{:} ( {S}_{p} + l = 1 {m}_{l} = 0 ) + ( l = 1 {m}_{l} = 0 ) & ( \begin{matrix}Eqs . ( 35.98 ) , \\ ( 35.99 ) , \\ and ( 35.100 )\end{matrix} ) \\ \frac{{ℏ}^{2}}{{m}_{e} {r}^{3}} = ( \begin{matrix}\frac{{e}^{2}}{4 {πɛ}_{0} {r}^{2}} + \frac{{ℏ}^{2}}{2 {m}_{e} {r}^{3}} \sqrt{s ( s + 1 )} + \\ \frac{1}{3} \frac{{ℏ}^{2}}{4 {m}_{e} {r}_{0}^{3}} \sqrt{s ( s + 1 )} + \\ 0.5 ( \begin{matrix}\frac{1}{2} \frac{{ℏ}^{2}}{4 {m}_{e} {r}_{0}^{3}} \sqrt{s ( s + 1 )} + \\ \frac{2}{3} \frac{{ℏ}^{2}}{4 {m}_{e} {r}_{0}^{3}} \sqrt{s ( s + 1 )}\end{matrix} )\end{matrix} ) & ( 35.119 ) \\ {r}_{0} = {a}_{0} ( 1 - ( 1 + \frac{1}{6} + \frac{1}{8} + \frac{1}{6} ) \frac{\sqrt{\frac{3}{4}}}{2} ) = 0.3685 {a}_{o} & ( 35.120 ) \\ Linear combination \text{:} ( ( ( {S}_{p} + l = 1 {m}_{l} = 0 ) + ( l = 1 {m}_{l} = 0 ) ) + ( ( {S}_{p} + l = 1 {m}_{l} = 1 ) + ( l = 1 {m}_{l} = 0 ) ) ) & ( \begin{matrix}Eqs . ( 35.98 ) , \\ ( 35.99 ) , \\ and ( 35.100 )\end{matrix} ) \\ \frac{{ℏ}^{2}}{{m}_{e} {r}^{3}} = ( \begin{matrix}\frac{{e}^{2}}{4 {πɛ}_{0} {r}^{2}} + 0.5 ( \begin{matrix}\frac{{ℏ}^{2}}{2 {m}_{e} {r}^{3}} \sqrt{s ( s + 1 )} + \\ \frac{1}{3} \frac{{ℏ}^{2}}{4 {m}_{e} {r}_{0}^{3}} \sqrt{s ( s + 1 )} + \\ \frac{{ℏ}^{2}}{2 {m}_{e} {r}^{3}} \sqrt{s ( s + 1 )} + \\ \frac{2}{3} \frac{{ℏ}^{2}}{4 {m}_{e} {r}_{0}^{3}} \sqrt{s ( s + 1 )}\end{matrix} ) + \\ 0.5 ( \begin{matrix}0.5 ( \begin{matrix}\frac{1}{2} \frac{{ℏ}^{2}}{4 {m}_{e} {r}_{0}^{3}} \sqrt{s ( s + 1 )} + \\ \frac{2}{3} \frac{{ℏ}^{2}}{4 {m}_{e} {r}_{0}^{3}} \sqrt{s ( s + 1 )}\end{matrix} ) + \\ 0.5 ( \begin{matrix}\frac{1}{2} \frac{{ℏ}^{2}}{4 {m}_{e} {r}_{0}^{3}} \sqrt{s ( s + 1 )} + \\ \frac{1}{3} \frac{{ℏ}^{2}}{4 {m}_{e} {r}_{0}^{3}} \sqrt{s ( s + 1 )}\end{matrix} )\end{matrix} )\end{matrix} ) & ( 35.121 ) \\ {r}_{0} = {a}_{0} ( 1 - ( \begin{matrix}\frac{1}{2} + \frac{1}{12} + \frac{1}{2} + \frac{1}{6} + \\ \frac{1}{16} + \frac{1}{12} + \frac{1}{16} + \frac{1}{24}\end{matrix} ) \frac{\sqrt{\frac{3}{4}}}{2} ) = 0.3505 {a}_{o} & ( 35.122 ) \\ Linear combination \text{:} ( {S}_{p} + l = 1 {m}_{l} = 0 ) + ( l = 1 {m}_{l} = 0 ) & ( \begin{matrix}Eqs . ( 35.98 ) , \\ ( 35.99 ) , \\ and ( 35.100 )\end{matrix} ) \\ \frac{{ℏ}^{2}}{{m}_{e} {r}^{3}} = ( \begin{matrix}\frac{{e}^{2}}{4 {πɛ}_{0} {r}^{2}} + \frac{{ℏ}^{2}}{2 {m}_{e} {r}^{3}} \sqrt{s ( s + 1 )} + \\ \frac{2}{3} \frac{{ℏ}^{2}}{4 {m}_{e} {r}_{0}^{3}} \sqrt{s ( s + 1 )} + \\ 0.5 ( \begin{matrix}\frac{1}{2} \frac{{ℏ}^{2}}{4 {m}_{e} {r}_{0}^{3}} \sqrt{s ( s + 1 )} + \\ \frac{1}{3} \frac{{ℏ}^{2}}{4 {m}_{e} {r}_{0}^{3}} \sqrt{s ( s + 1 )}\end{matrix} )\end{matrix} ) & ( 35.123 ) \\ {r}_{0} = {a}_{0} ( 1 - ( 1 + \frac{1}{3} + \frac{1}{8} + \frac{1}{12} ) \frac{\sqrt{\frac{3}{4}}}{2} ) = 0.3324 {a}_{o} & ( 35.124 ) \\ Linear combination \text{:} ( ( ( {S}_{p} + l = 1 {m}_{l} = 0 ) + ( l = 1 {m}_{l} = 0 ) ) + ( ( {S}_{p} + l = 1 {m}_{l} = 1 ) + ( l = 1 {m}_{l} = 0 ) ) ) & ( \begin{matrix}Eqs . ( 35.98 ) , \\ ( 35.99 ) , \\ and ( 35.100 )\end{matrix} ) \\ \frac{{ℏ}^{2}}{{m}_{e} {r}^{3}} = ( \begin{matrix}\frac{{e}^{2}}{4 {πɛ}_{0} {r}^{2}} + 0.5 ( \begin{matrix}\frac{{ℏ}^{2}}{2 {m}_{e} {r}^{3}} \sqrt{s ( s + 1 )} + \\ \frac{2}{3} \frac{{ℏ}^{2}}{4 {m}_{e} {r}_{0}^{3}} \sqrt{s ( s + 1 )} + \\ \frac{{ℏ}^{2}}{2 {m}_{e} {r}^{3}} \sqrt{s ( s + 1 )} + \\ \frac{2}{3} \frac{{ℏ}^{2}}{4 {m}_{e} {r}_{0}^{3}} \sqrt{s ( s + 1 )}\end{matrix} ) + \\ 0.5 ( \begin{matrix}0.5 ( \begin{matrix}\frac{1}{2} \frac{{ℏ}^{2}}{4 {m}_{e} {r}_{0}^{3}} \sqrt{s ( s + 1 )} + \\ \frac{1}{3} \frac{{ℏ}^{2}}{4 {m}_{e} {r}_{0}^{3}} \sqrt{s ( s + 1 )}\end{matrix} ) + \\ 0.5 ( \begin{matrix}\frac{1}{2} \frac{{ℏ}^{2}}{4 {m}_{e} {r}_{0}^{3}} \sqrt{s ( s + 1 )} + \\ \frac{2}{3} \frac{{ℏ}^{2}}{4 {m}_{e} {r}_{0}^{3}} \sqrt{s ( s + 1 )}\end{matrix} )\end{matrix} )\end{matrix} ) & ( 35.125 ) \\ {r}_{0} = {a}_{0} ( 1 - ( \begin{matrix}\frac{1}{2} + \frac{1}{6} + \frac{1}{2} + \frac{1}{6} + \\ \frac{1}{16} + \frac{1}{24} + \frac{1}{16} + \frac{1}{12}\end{matrix} ) \frac{\sqrt{\frac{3}{4}}}{2} ) = 0.3144 {a}_{o} & ( 35.126 ) \\ Linear combination \text{:} ( {S}_{p} + l = 1 {m}_{l} = 1 ) + ( l = 1 {m}_{l} = 1 ) & ( \begin{matrix}Eqs . ( 35.98 ) , \\ ( 35.99 ) , \\ and ( 35.100 )\end{matrix} ) \\ \frac{{ℏ}^{2}}{{m}_{e} {r}^{3}} = ( \begin{matrix}\frac{{e}^{2}}{4 {πɛ}_{0} {r}^{2}} + \frac{{ℏ}^{2}}{2 {m}_{e} {r}^{3}} \sqrt{s ( s + 1 )} + \\ \frac{2}{3} \frac{{ℏ}^{2}}{4 {m}_{e} {r}_{0}^{3}} \sqrt{s ( s + 1 )} + \\ 0.5 ( \begin{matrix}\frac{1}{2} \frac{{ℏ}^{2}}{4 {m}_{e} {r}_{0}^{3}} \sqrt{s ( s + 1 )} + \\ \frac{2}{3} \frac{{ℏ}^{2}}{4 {m}_{e} {r}_{0}^{3}} \sqrt{s ( s + 1 )}\end{matrix} )\end{matrix} ) & ( 35.127 ) \\ {r}_{0} = {a}_{0} ( 1 - ( 1 + \frac{1}{3} + \frac{1}{8} + \frac{1}{6} ) \frac{\sqrt{\frac{3}{4}}}{2} ) = 0.2964 {a}_{o} & ( 35.128 )\end{matrix}$$

Hyperbolic electrons can be formed by crossing an electron beam with a beam of neutral atoms such as helium. The velocity is given by

$${v}_{z} = \frac{ℏ}{{m}_{e} {ρ}_{o}} \qquad ( 35.129 )$$

where ρ₀ is the radius of the corresponding hyperbolic electron. The minimum velocity of the free electrons of the electron beam to form hyperbolic electrons by elastic electron scattering is

$${v}_{z} = \frac{ℏ}{{m}_{e} {ρ}_{o}} = 3.858361 \times {10}^{6} m \text{/} s \qquad ( 35.130 )$$

where ρ₀=0.567a₀=3.000434×10⁻¹¹ m (Eq. (35.95)). The kinetic energy of the incident electron that scatters to form a hyperbolic electron is given by

$$T = \frac{1}{2} {m}_{e} {v}_{z}^{2} \qquad ( 35.131 )$$

Thus, using the electron velocity v_{z} (Eq. (35.130)), the kinetic energy, T, for resonant hyperbolic electron formation corresponding to the elastic scattering threshold is

$$T = \frac{1}{2} {m}_{e} {v}_{z}^{2} = 42.3 eV \qquad ( 35.132 )$$

The velocities (Eq. (35.129)) and energies (Eq. (35.131)) corresponding to the fifteen states given by Eqs. (35.95), (35.102), (35.104), (35.106), (35.108), (35.110), (35.112), (35.114), (35.116), (35.118), (35.120), (35.124), (36.126), and (35.128) are listed in Table 1 with their corresponding radii and quantum numbers.

TABLE 1
The theoretical velocities and the kinetic energies of incident elastically scattered
electrons for resonant hyperbolic electron formation given in increasing
order of energy with the corresponding radii and quantum
numbers of the n = 1 hyperbolic-electronic states.

| | Theoretical | | Theoretical | |
|---|---|---|---|---|
| | Hyperbolic- | | Threshold | |
| | Electron | Theoretical | Kinetic | |
| | Radius | Velocity | Energy | Quantum Numbers |
| Peak # | (a₀) | (10⁶ m/s) | (eV) | Sₚ, l, and mₗ |
| 1 | 0.5670 | 3.8584 | 42.32 | l = 0 mₗ = 0 |
| 2 | 0.5309 | 4.1207 | 48.27 | (l = 0 mₗ = 0) + (l = 1 mₗ = 0) |
| 3 | 0.4948 | 4.4212 | 55.57 | l = 1 mₗ = 0 |
| 4 | 0.4768 | 4.5885 | 59.85 | Sₚ + (l = 1 mₗ = 0) |
| 5 | 0.4587 | 4.7690 | 64.65 | Sₚ |
| 6 | 0.4407 | 4.9642 | 70.06 | Sₚ + (l = 1 mₗ = 1) |
| 7 | 0.4226 | 5.1761 | 76.17 | l = 1 mₗ = 1 |
| 8 | 0.4136 | 5.2890 | 79.52 | (((Sₚ + l = 1 mₗ = 0) + (l = 1 mₗ = 0)) + |
| | | | | (l = 1 Mₗ =1)) |
| 9 | 0.4046 | 5.4069 | 83.11 | (Sₚ + l = 1 mₗ = 0) + (l = 1 mₗ = 0) |
| 10 | 0.3866 | 5.6593 | 91.05 | (((Sₚ + l = 1 mₗ = 0) + (l = 1 mₗ = 0)) + |
| | | | | ((Sₚ + l = 1 mₗ = 1) + (l = 1 mₗ = 0))) |
| 11 | 0.3685 | 5.9364 | 100.18 | (Sₚ + l = 1 mₗ = 1) + (l = 1 mₗ = 0) |
| 12 | 0.3505 | 6.2420 | 110.76 | (((Sₚ + l = 1 mₗ = 1) + (l = 1 mₗ = 0)) + |
| | | | | ((Sₚ + l = 1 mₗ = 0) + (l = 1 mₗ = 1))) |
| 13 | 0.3324 | 6.5807 | 123.11 | (Sₚ + l = 1 mₗ = 0) + (l = 1 mₗ = 1) |
| 14 | 0.3144 | 6.9584 | 137.65 | (((Sₚ + l = 1 mₗ = 0) + (l = 1 mₗ = 1)) + |
| | | | | ((Sₚ + l = 1 mₗ = 1) + (l = 1 mₗ = 1))) |
| 15 | 0.2964 | 7.3820 | 154.92 | (Sₚ + l = 1 mₗ = 1) + (l = 1 mₗ = 1) |

Hyperbolic electrons can also be formed by inelastic scattering wherein the difference between the incidence energy Eᵢ and the excitation energy Eₗₒₛₛ of the species with which the free electron collides is one of the resonant production energies T, one of the incident kinetic energies, given in Table 1.

T=Eᵢ−Eₗₒₛₛ (35.133)

The velocity function of the two-dimensional spherical hyperbolic electron is shown in color scale in FIG. 5. The velocity distribution along the z-axis of a hyperbolic electron is shown schematically in FIG. 6. With an incident electron kinetic energy of 42.3 eV, the formation of a hyperbolic electron by elastic free-electron scattering from an atom is shown in FIG. 7.

The velocity is harmonic or imaginary as a function of θ. Therefore, the gravitational velocity of the Earth relative to that of the hyperbolic electron is imaginary. This case corresponds to an eccentricity greater than one and a hyperbolic orbit of Newton's Law of Gravitation. The metric for the imaginary gravitational velocity is based on the center of mass of the scattering event. The Earth, helium, and the hyperbolic electron are spherically symmetrical; thus, the Schwarzschild metric (Eqs. (35.42-35.43)) applies. The velocity distribution defines a surface of negative curvature relative to the positive curvature of the Earth. This case corresponds to a negative radius of Eq. (35.41) or an imaginary gravitational velocity of Eq. (35.37). The lift due to the resulting repulsive gravitational force is given in the Hyperbolic-Electron-Based Propulsion Device section. According to Eq. (32.49) and Eq. (32.140), matter, energy, and spacetime are conserved with respect to creation of a particle which is repelled from a gravitating body. The gravitationally ejected particle gains energy as it is repelled. The ejection of a particle having a negatively curved velocity surface such as a hyperbolic electron from a gravitating body such as the Earth must result in an infinitesimal decrease in the radius of the gravitating body (e.g. r of the Schwarzschild metric given by Eq. (35.2) where m₀=M is the mass of the Earth). The amount that the gravitational potential energy of the gravitating body is lowered is equivalent to the energy gained by the repelled particle. The physics is time-reversible. The process may be run backwards to achieve the original state before the repelled particle such as a hyperbolic electron was created.

### Fifth-Force Propulsion Device

It is possible to scatter an electron beam from atoms or molecules such that the emerging scattered electrons each have a velocity distribution with negative curvature. The emerging beam of electrons called “hyperbolic electrons” experience a fifth force, a repulsive gravitational force (on the Earth), and the beam will tend to move upward (away from the Earth). Hyperbolic electrons can be focused into a beam by electric and/or magnetic fields to form a hyperbolic electron beam. For propulsion or levitation use, the fifth force of the hyperbolic-electron beam must be transferred to a negatively charged plate. The Coulombic repulsion between the beam of electrons and the negatively charged plate will cause the plate (and anything connected to the plate) to lift. FIGS. 8 and 9 give a schematic of the components and operation of such a device, respectively.

As shown schematically in FIGS. 8 and 9, the device to provide an repulsive gravitational force (fifth force) for levitation or propulsion comprises a gas jet of atoms or molecules and an energy-tunable electron gun that supplies an electron beam having electrons of a precise energy such that hyperbolic electrons form when scattered by the atoms. Preferably, the energy is 42.3 eV corresponding to an electron radius ρ₀=0.567a₀ or is the other energies and corresponding radii given in Table 1. Electrons having these resonant parameters may be scattered from a gas jet such as an atomic beam of helium atoms using the set up described by Bonham [11]. The gas jet and electron beam intersect such that each electron is scattered such that forms a spherical shell with a velocity distribution on the spherical surface that is a hyperboloid of negative curvature (hyperbolic electron). The hyperbolic electron beam passes into an electric field provided by a capacitor. The hyperbolic electrons experience a repulsive force from the gravitating body due to their velocity surfaces of negative curvature and are accelerated away from the center of the gravitating body such as the Earth. This upward force is transferred to the capacitor via a repulsive electric force between the hyperbolic electrons and the electric field of the capacitor. As shown by Eqs. (35.148-35.156), the final velocity of the hyperbolic electron may be at an angle φ from the horizontal axis, the axis perpendicular to the gravitational-force axis. This angle depends on the angle ψ of the incident beam with respect to the horizontal axis as shown by Eq. (35.160) and Eqs. (35.142), (35.148), and (35.155). Thus, for control of the components of force, energy, and power, the device further comprises a means to control the angle of the incident beam with respect to horizontal axis as well as a means to change the angle of the capacitors to preferably cause the propagation direction of the hyperbolic-electron beam at the angle φ to be perpendicular to the plates. The capacitor is rigidly attached to the body to be levitated or propelled by structural attachments so that the repulsive force causes lift to the craft. Then, the spent hyperbolic electrons are collected in a trap such as a Faraday cup as described by Bonham [11] and recirculated to the electron beam. The atoms of the gas jet are also collected and recirculated using a pump.

This hyperbolic-electron Coulombic force provides lift to the capacitor due to the repulsion of the hyperbolic electron from the Earth as it undergoes a trajectory through the capacitor. The trajectory of hyperbolic electrons generated by the propulsion system can be found by solving the Newtonian inverse-square gravitational force equations for the case of a repulsive force caused by hyperbolic electron production. The trajectory follows from the Newtonian gravitational force and the solution of motion in an inverse-square repulsive field is given by Fowles [12]. The trajectory can be calculated rigorously by solving the orbital equation from the Schwarzschild metric (Eqs. (35.15-35.16)) for a two-dimensional spatial velocity-density function of negative curvature which is produced by the apparatus and repelled by the Earth. The rigorous solution is equivalent to that given for the case of a positive gravitational velocity given in the Orbital Mechanics section except that the gravitational velocity is imaginary and the magnitude is determined by the condition that the proper and coordinate times are matched.

In the case of a velocity function having negative curvature, Eq. (32.78) becomes

$$( 1 + \frac{2 GM}{{rc}^{2}} ) \frac{d t}{d τ} = \frac{E}{{mc}^{2}} \qquad ( 35.134 )$$

where M is the mass of the Earth and m is the mass of the hyperbolic electron. Eq. (32.79) is based on the equations of motion of the geodesic, which in the case of an imaginary gravitation velocity or a negative gravitational radius becomes

$${( \frac{d r}{d θ} )}^{2} = \frac{{r}^{4}}{{L}_{θ}^{2}} [ {( \frac{E}{c} )}^{2} - ( 1 + \frac{2 GM}{{c}^{2} r} ) ( \frac{{L}_{θ}^{2}}{{r}^{2}} + {m}^{2} {c}^{2} ) ] \qquad ( 35.135 )$$

The repulsive central force equations can be transformed into an orbital equation by the substitution,

$$u = \frac{1}{r} .$$

The relativistically corrected differential equation of the orbit of a particle moving under a repulsive central force is

$${( \frac{d u}{d θ} )}^{2} + {u}^{2} = \frac{{( \frac{E}{c} )}^{2} - {m}^{2} {c}^{2}}{{L}_{θ}^{2}} - \frac{{m}^{2} {c}^{2}}{{L}_{θ}^{2}} ( \frac{2 GM}{{c}^{2}} ) u - ( \frac{2 GM}{{c}^{2}} ) {u}^{3} \qquad ( 35.136 )$$

By differentiating with respect to 9, noting that u=u(θ) gives

$$\begin{matrix}\frac{{d}^{2} u}{d {θ}^{2}} + u = - \frac{GM}{{a}^{2}} - \frac{3}{2} ( \frac{2 GM}{{c}^{2}} ) {u}^{2} \\ where & ( 35.137 ) \\ a = \frac{{L}_{θ}}{m} & ( 35.138 )\end{matrix}$$

In the case of a weak field,

$$( \frac{2 GM}{{c}^{2}} ) u << 1 \qquad ( 35.139 )$$

and the second term on the right-hand of (35.37) can then be neglected in the zero-order. The equation of the orbit is

$$\begin{matrix}{u}_{0} = \frac{1}{r} = A cos ( θ + {θ}_{0} ) - \frac{GM}{{a}^{2}} & ( 35.140 ) \\ r = \frac{1}{A cos ( θ + {θ}_{0} ) - \frac{GM}{{a}^{2}}} & ( 35.141 )\end{matrix}$$

where A and θ₀ denote the constants of integration. Consider Eₒ, is the orbital energy of the electron with initial velocity v₀ and kinetic energy Eᵢ:

$${E}_{i} = \frac{1}{2} {mv}_{0}^{2} \qquad ( 35.142 )$$

where m is the mass of the hyperbolic electron. Consider the trajectory of a hyperbolic electron shown in FIG. 10. The orbit equation may also be expressed in terms of Eᵢ and Eₒ as given by Fowles [13]

$$\begin{matrix}r = \frac{\frac{{mp}^{2} {v}_{0}^{2}}{GmM}}{- 1 + {( 1 + \frac{2 {E}_{i} {mp}^{2} {v}_{0}^{2}}{{( GMm )}^{2}} )}^{\frac{1}{2}} cos ( θ - {θ}_{0} )} \\ = \frac{2 {pE}_{i} {E}_{o}^{- 1}}{- 1 + {( 1 + 4 {E}_{i}^{2} {E}_{o}^{- 2} )}^{\frac{1}{2}} cos ( θ - {θ}_{0} )}\end{matrix} \qquad ( 35.143 )$$

where the constant

$$a = \frac{{L}_{θ}}{m}$$

is expressed in terms of another parameter p called the impact parameter. The impact parameter is the perpendicular distance from the origin (deflection or scattering center) to the final line of motion of the hyperbolic electron corresponding to a trajectory with the same initial parameter as shown in FIG. 10. The relationship between a, the angular momentum per unit mass, and v₀, the initial velocity of the hyperbolic electron, is

a=|r×v|=pv₀ (35.144)

In a repulsive field, the energy is always greater than zero. Thus, the eccentricity e, the coefficient of cos (θ−θ₀), must be greater than unity (e>1) which requires that the orbit must be hyperbolic.

As shown in FIG. 10, the electron approaches along one asymptote and recedes along the other. The direction of the polar axis is selected such that the initial position of the hyperbolic electron is θ=0, r=∞. According to either of the equations of the orbit (Eq. (35.141) or Eq. (35.143)) r assumes its minimum value when cos (θ=θ₀)=1, that is, when θ=θ₀. Since r=∞ when θ=0, then r is also infinite when θ=2θ₀. Therefore, the angle between the two asymptotes of the hyperbolic path is 2θ₀, and the angle φ through which the incident hyperbolic electron is deflected is given by

φ=π−2θ₀ (35.145)

Furthermore, the denominator of Eq. (35.143) vanishes when θ=0 and θ=2θ₀. Thus,

$$- 1 + {( 1 + 4 {E}_{i}^{2} {E}_{o}^{- 2} )}^{\frac{1}{2}} cos ( {θ}_{0} ) = 0 \qquad ( 35.146 )$$

Using Eq. (35.145) and Eq. (35.146), the scattering angle, φ, is given in terms of θ as

$$tan {θ}_{0} = \frac{2 {E}_{i}}{{E}_{o}} = cot \frac{φ}{2} \qquad ( 35.147 )$$

And, the scattering angle, φ, is

$$φ = 2 arctan \frac{{E}_{o}}{2 {E}_{i}} \qquad ( 35.148 )$$

Next, the orbital energy Eₒ of the hyperbolic electron following its production is determined using Eqs. (35.134) and (32.42). Consider Eq. (32.42) for the conditions of hyperbolic electron production:

$$d τ = {dt ( 1 - \frac{2 {Gm}_{0}}{{c}^{2} {r}_{α}^{*}} - \frac{{v}^{2}}{{c}^{2}} )}^{\frac{1}{2}} \qquad ( 35.149 )$$

Substitution of Eq. (35.149) into Eq. (35.134) gives

$${mc}^{2} \frac{( 1 + \frac{2 GM}{{r}_{α}^{*} {c}^{2}} )}{{( 1 + \frac{2 {Gm}_{0}}{{c}^{2} {r}_{α}^{*}} - \frac{{v}^{2}}{{c}^{2}} )}^{\frac{1}{2}}} = E \qquad ( 35.150 )$$

where r_{α}* is the production radius. The gravitational velocity of the Earth for hyperbolic electron production in the laboratory frame, v_{g}_{_{E}}, is

$${v}_{{g}_{E}} = \sqrt{\frac{2 GM}{{r}_{α}^{*}}} \qquad ( 35.151 )$$

Then, Eq. (35.150) becomes

$${mc}^{2} \frac{( 1 + {( \frac{{v}_{{g}_{E}}}{c} )}^{2} )}{{( 1 + {( \frac{{v}_{{g}_{E}}}{c} )}^{2} - \frac{{v}^{2}}{{c}^{2}} )}^{\frac{1}{2}}} = E \qquad ( 35.152 )$$

The proper and coordinate times are synchronous when

V_{g}_{_{K}}=V (35.153)

Substitution of Eq. (35.153) into Eq. (35.152) gives

$${mc}^{2} ( 1 + \frac{{v}^{2}}{{c}^{2}} ) = E \qquad ( 35.154 )$$

Using Eq. (35.154) and Eqs. (33.12-33.14), the orbital energy is

$${E}_{0} \approx ( {m}_{0} {c}^{2} + \frac{1}{2} {m}_{0} {v}^{2} ) ( 1 + {( \frac{v}{c} )}^{2} ) - {m}_{0} {c}^{2} \approx \frac{1}{2} {m}_{0} {v}^{2} + {{mc}^{2} ( \frac{v}{c} )}^{2} \approx \frac{3}{2} {m}_{0} {v}^{2} \qquad ( 35.155 )$$

With the substitution of Eᵢ and Eₒ given by Eqs. (35.142) and (35.155) into Eq. (35.148), the scattering angle, φ, is

$$φ = 2 arctan \frac{\frac{3}{2} {m}_{0} {v}^{2}}{2 \frac{1}{2} {m}_{0} {v}^{2}} \\ = 2 arctan \frac{3}{2} \\ = 112.6 ° \qquad ( 35.156 )$$

The scattering distribution of hyperbolic electrons given by Eq. (35.56) is centered at a scattering angle of φ given by Eq. (35.156). With the condition zₒ=ρₒ=r₀, the elastic electron scattering intensity at the far field angle Θ is determined by the boundary conditions of the curvature of spacetime due to the presence of a gravitating body and the constant maximum velocity of the speed of light. The far field condition must be satisfied with respect to electron scattering and the gravitational orbital equation. The former condition is met by Eq. (35.56) and Eq. (35.57). The latter is met by Eqs. (35.148-35.156) where the far field angle Θ is centered about the hyperbolic gravitational trajectory at angle φ (Eq. (35.156)) which further determines that the corresponding impact parameter p for each electron is given by Eq. (35.158).

The elastic scattering condition is possible due to the large mass of the helium atom and the Earth relative to the electron wherein the recoil energy transferred during a collision is inversely proportional to the mass as given by Eq. (2.144). According to Eqs. (32.48), (32.140) and (32.43), matter, energy, and spacetime are conserved with respect to creation of the hyperbolic electron which is repelled from a gravitating body (e.g. the Earth). The ejection of a hyperbolic electron having a negatively curved velocity surface from the Earth must result in an infinitesimal decrease in the radius of the Earth (e.g. r of the Schwarzschild metric given by Eq. (35.2) where m₀=M is the mass of the Earth, 5.98×10²⁴ kg). The amount that the gravitational potential energy of the Earth is lowered is equivalent to the total energy gained by the repelled hyperbolic electron. Momentum is also conserved for the electron, Earth, and helium atom wherein the gravitating body that repels the hyperbolic electron, the Earth, receives an equal and opposite change of momentum with respect to that of the electron. Causing a satellite to follow a hyperbolic trajectory about a gravitating body is a common technique to achieve a gravity assist to further propel the satellite. In this case, the energy and momentum gained by the satellite are also equal and opposite those lost by the gravitating body.

As given in the leptons section, at particle production, the production photon and created gravitational field front are at light velocity, the particle velocity must be the Newtonian gravitational escape velocity, its energy is zero, and its trajectory is a parabola. In contrast, hyperbolic electron production results in a negatively-curved velocity surface wherein the mass at the extremes approaches light speed. Thus, the hyperbolic-electron-production radius in the light-like frame r^{α}** is given by the particle-production condition given in the Gravity section, the maximum speed of light at hyperbolic-electron-production for the photon that provides the force balance (Eqs. (35.94), (35.101), (35.103), (35.105), (35.107), (35.109), (35.111), (35.113), (35.115), (35.117), (35.119), (35.121), (35.123), (35.125), and (35.127)) and the corresponding outgoing gravitational field front. In this case, the Earth's gravitational velocity is also equal to the speed of light in the production frame. The gravitational velocity of the Earth for hyperbolic electron production in the production frame, v_{g}_{_{E}}*, is

$${v}_{{g}_{E}}^{*} = \sqrt{\frac{2 GM}{{r}_{α}^{**}}} = c \qquad ( 35.157 )$$

Then, the hyperbolic-electron-production radius is

$${r}_{α}^{**} = \frac{2 GM}{{c}^{2}} = {r}_{g} = 8.88 \times {10}^{- 3 } m \qquad ( 35.158 )$$

where r_{g} is the gravitational radius given by Eq. (35.41). The corresponding production time t_{g} is

$${t}_{g} = \frac{2 π {r}_{α}^{**}}{c} \\ = \frac{4 π GM}{{c}^{3}} \\ = \frac{2 π {r}_{g}}{c} \\ = \frac{2 π ( 8.88 \times {10}^{- 3} m )}{c} \\ = 1.86 \times {10}^{- 10} s \qquad ( 35.159 )$$

The incident velocities for hyperbolic electron production are given by (Eq. (35.129)) and Eqs. (35.95), (35.102), (35.104), (35.106), (35.108), (35.110), (35.112), (35.114), (35.116), (35.118), (35.120), (35.124), (36.126), and (35.128); however, in each case, the hyperbolic electron trajectory and energy Eₒ is dependent on the direction of the incident velocity. With the vector direction of the initial velocity defined with respect to the horizontal axis, the axis perpendicular with the radial gravitational-force vector, the initial velocity in the

$$\frac{1}{2} {m}_{0} {v}^{2}$$

term of Eₒ (Eq. (35.155)) and Eₜ (Eq. (35.142)) for the determination of the scattering angle using Eq. (35.148) is

v=v₀ cos ψ (35.160)

where ψ is the angle from the horizontal axis towards the radial axis. In the case that ψ=90°, Eₒ=m₀v₀², and Eₜ along the horizontal axis (Eq. (35.142)) is 0, φ=180°. Thus, the incident electron propagating along the radial axis is directed vertically following the production of a hyperbolic electron. This aspect of the behavior of hyperbolic electron production is permissive of means to control the energy and power selectively applied to the horizontal and vertical axes to control the motion of a fifth-force-driven craft. For example, consider the case that the incident electron velocity is 3.8584×10⁶ m/s as given by Eq. (35.130) and ψ=0°, Then according to Eq. (35.156), φ=112.6°. The corresponding hyperbolic-electron velocity corresponding to the energy

$${E}_{0} \approx \frac{3}{2} {m}_{0} {v}^{2}$$

at this angle is

$$v = \sqrt{\frac{{E}_{0}}{{E}_{i}}} {v}_{0} \\ = \sqrt{3} {v}_{0} \\ = \sqrt{3} ( 3.86 \times {10}^{6} m \text{/} s ) \\ = 6.69 \times {10}^{6} m \text{/} s \qquad ( 35.161 )$$

The projection vₕ in the direction opposite to the initial velocity along the horizontal axis is

$${v}_{h} = v cos φ \\ = ( 6.69 \times {10}^{6} m \text{/} s ) cos ( 112.6 ° ) \\ = - 2.57 \times {10}^{6} m \text{/} s \qquad ( 35.162 )$$

The projection vᵥ in the direction along the radial or vertical axis is

$${v}_{v} = v sin φ \\ = ( 6.69 \times {10}^{6} m \text{/} s ) sin ( 112.6 ° ) \\ = 6.18 \times {10}^{6} m \text{/} s \qquad ( 35.163 )$$

The corresponding energies Eₕ and Eᵥ are

$$\begin{matrix}{E}_{h} = \frac{1}{2} {m}_{0} {v}_{h}^{2} \\ = \frac{1}{2} {{m}_{0} ( 2.57 \times {10}^{6} m \text{/} s )}^{2} \\ = 18.8 eV & ( 35.164 ) \\ {E}_{v} = \frac{1}{2} {m}_{0} {v}_{h}^{2} \\ = \frac{1}{2} {{m}_{0} ( 6.18 \times {10}^{6} m \text{/} s )}^{2} \\ = 108.6 eV & ( 35.165 )\end{matrix}$$

These horizontal and vertical components can be directed to horizontally translate and lift of a craft, respectively.

For example, with an initial energy of T=42.3 eV, the final kinetic energy of each hyperbolic electron that may be imparted to lifting the device is Eᵥ=108.6 eV according to Eq. (35.165). With a beam current of 10⁵ amperes achieved by multiple beams such as 100 beams each providing 10³ amperes, the power transferred to the device P_{FF} is

$${P}_{FF} = \frac{{10}^{5} coulomb}{sec} \times \frac{1 electron}{1.6 \times {10}^{- 19} coulombs} \times \frac{108.6 eV}{electron} \times \frac{1.6 \times {10}^{- 19} J}{eV} = 10.9 MW \qquad ( 35.166 )$$

The power dissipated against gravity P_{G} is given by

P_{G}=m_{c}gv_{c} (35.167)

where m_{c} is the mass of the craft, g is the acceleration of gravity, v_{c} is the velocity of the craft. In the case of a 10⁴ kg craft, 10.9 MW of power provided by Eq. (35.166) sustains a steady lifting velocity of 111 m/sec. Thus, significant lift is possible using hyperbolic electrons.

In the case of a 10⁴ kg craft, F_{g}, the gravitational force is

$${F}_{g} = {m}_{c} g = ( {10}^{4} kg ) ( 9.8 \frac{m}{{sec}^{2}} ) = 9.8 \times {10}^{4} N \qquad ( 35.168 )$$

where m_{c} is the mass of the craft and g is the standard gravitational acceleration. The lifting force may be determined from the gradient of the energy which is approximately the energy dissipated divided by the vertical (relative to the Earth) distance over which it is dissipated. The fifth force provided by the hyperbolic electrons may be controlled by adjusting the electric field of the capacitor. For example, the electric field of the capacitor may be increased such that the levitating force overcomes the gravitational force. The electric field of the capacitor, E_{cap}, may be constant and given by the capacitor voltage, V_{cap}, divided by the distance between the capacitor plates, d, of a parallel plate capacitor.

$${E}_{cap} = \frac{{V}_{cap}}{d} \qquad ( 35.169 )$$

In the case that V_{cap} is 10⁶ V and d is 1 m, the electric field is

$${E}_{cap} = \frac{{10}^{6} V}{m} \qquad ( 35.170 )$$

The force of the electric field of the capacitor on a hyperbolic electron, Fₑₗₑ, is the electric field, E_{cap} times the fundamental charge

$${F}_{ele} = {eE}_{cap} = ( 1.6 \times {10}^{- 19 } C ) ( {10}^{6} \frac{V}{m} ) = 1.6 \times {10}^{- 13} N \qquad ( 35.171 )$$

The distance traveled away from the Earth, Δr_{z}, by a hyperbolic electron having an energy of E=108.6 eV=1.74×10⁻¹⁷ J is given by the energy divided by the electric field Fₑₗₑ

$$Δ {r}_{z} = \frac{E}{{F}_{ele}} \\ = \frac{1.74 \times {10}^{- 17} J}{1.6 \times {10}^{- 13} N} \\ = 1.09 \times {10}^{- 4} m \\ = 0.109 mm \qquad ( 35.172 )$$

The number of electrons Nₑ is given by

$${N}_{e} = \frac{I}{{ev}_{e} {r}_{i}} \qquad ( 35.173 )$$

where I is the current, e is the fundamental electron charge, vₑ is the hyperbolic electron velocity, rᵢ is the length of the current. Substitution of I=10⁵ A, vₑ=vᵥ=6.18×10⁶ m/s, (Eq. (35.163)) and rᵢ=Δr_{z}=1.09×10⁻⁴ m (Eq. (35.172)), the number of electrons is

Nₑ=9.27×10²⁰ electrons (35.174)

The fifth force, F_{FF}, is given by multiplying the number of electrons (Eq. (35.174)) by the force per electron (Eq. (35.171)).

F_{FF}NₑFₑ=(9.27×10²⁰ electrons)(1.6×10¹³ N)=1.48×10⁸ N (35.175)

wherein the force F_{FF} acts over the distance Δr_{z}=0.109 mm. Thus, this example of a fifth-force device may provide a levitating force that is capable of overcoming the gravitational force on the craft to achieve a maximum vertical velocity of 111 m/sec as given by Eq. (35.167). The hyperbolic electron current and the electric field of the capacitor may be adjusted to control the vertical acceleration and velocity.

The current may be dramatically reduced when the hyperbolic electrons have a long half-life. The fifth force per hyperbolic electron is given by the energy such as those in Table 1 and Eq. (35.155) divided by the production radius given by Eq. (35.158). The number of hyperbolic electrons needed to levitate a craft of a given mass is given by the gravitational force on the craft (F=mg) divided by the fifth force per hyperbolic electron. Then, the incident current is given by the number of hyperbolic electrons times the fundamental charge e divided by the hyperbolic-electron half-life.

Levitation by a fifth force is orders of magnitude more energy efficient than conventional rocketry. In the former case, the energy dissipation is converted directly to gravitational potential energy as the craft is lifted out of the gravitation field. Whereas, in the case of rocketry, matter is expelled at a higher velocity than the craft to provide thrust or lift. The basis of rocketry's tremendous inefficiency of energy dissipation to gravitational potential energy conversion may be determined from the thrust equation. In a case wherein external forces including gravity are taken as zero for simplicity, the thrust equation is [14]

$$v = {v}_{0} + V ln \frac{{m}_{0}}{m} \qquad ( 35.176 )$$

where v is the velocity of the rocket at any time, v₀ is the initial velocity of the rocket, m₀ is the initial mass of the rocket plus unburned fuel, m is the mass at any time, and V is the speed of the ejected fuel relative to the rocket. Owing to the nature of the logarithmic function, it is necessary to have a large fuel to payload ratio in order to attain the large speeds needed for satellite launching, for example.

### Mechanics

A fifth-force device as shown in FIGS. 8 and 9 can cause radial motion relative to the gravitating body such as the Earth. The corresponding motion in the vertical direction is defined as along the z-axis. It is also important to devise a means to cause translation in the transverse or horizontal direction, the direction tangential to the gravitating body's surface defined as the xy-plane. Consider that a vertical component and, depending on the direction of the incident beam, a horizontal component of the power of the hyperbolic-electron beam is also transferred to the craft as the hyperbolic electrons are deflected upward by the gravitating body as shown by Eqs. (35.162-35.165). The power and momentum conservation is achieved with the equal and opposite momentum and power changes in the gravitating body. The electrons move rectilinearly until being elastically scattered from an atomic beam to form hyperbolic electrons which are deflected in a trajectory with controllable radial and transverse components relative to the center of the gravitating body. This latter power may be used to cause the craft to spin in the case that the devices are located peripherally with regard to the craft, and the resulting spin may be used to translate the craft in a direction tangential to the gravitating body's surface. The rotational kinetic energy can be converted to translational energy as shown in detail infra.

For example, using multiple devices of controllable vertical lift, the fifth force can be made variable in any direction in the xy-plane of an aerospace vehicle to be tangentially accelerated such that the spinning vehicle can be made to tilt to change the direction of its spin angular momentum vector. Conservation of angular momentum stored in the craft along the z-axis results in horizontal acceleration. Thus, the vehicle to be tangentially accelerated possesses a cylindrically or spherically symmetrically rotatable mass having a moment of inertia that serves as a flywheel. The flywheel is rotated by the horizontal component of power which is generated and transferred to the craft by controlling the angle of the incident electron beam and the orientation of capacitors to transduce the forces of the deflected hyperbolic-electron beam to impart a controlled angular momentum to the craft. By controlling the vertical forces in the xy-plane by controlling a plurality of fifth-force devices located around the perimeter of the craft, an imbalance can be controllably created to tilt the craft and cause a precession resulting in horizontal translation of the craft. The fifth-force devices can also be controlled to cause the craft to follow a hyperbolic orbit about a gravitating body to achieve a gravity assist to further propel the craft. Alternatively, the electron beam can serve the additional function of a direct source of transverse acceleration. Thus, it may be function as an ion rocket.

Consider the mechanics of using conservation of angular momentum generated and stored in the craft to achieve tangential mobility. The vehicle is levitated using the fifth-force system to overcome the gravitational force of the gravitating body (e.g. Earth) while a horizontal component of power causes the craft to spin where the levitation and rotation is such that the angular momentum vector of the flywheel is parallel to the radial or central vector of the gravitational force of the gravitating body (z-axis). Then at altitude, the angular momentum vector of the flywheel is forced to make a finite angle with the radial vector of gravitational force by tuning the symmetry of the levitating forces provided by a fifth-force apparatus comprising multiple elements at different spatial locations on the vehicle. A torque is produced on the flywheel as the angular momentum vector is reoriented with respect to the radial vector due to the interaction of the central force of gravity of the gravitating body, the resultant fifth force of the apparatus, and the angular momentum of the flywheel device. The resulting acceleration, which conserves angular momentum, is perpendicular to the plane formed by the radial vector and the angular momentum vector. Thus, the resulting acceleration is tangential to the surface of the gravitating body.

Large translational velocities are achievable by executing a trajectory which is vertical followed by a transverse precessional translation with a large radius. The latter motion is caused by tilting the spinning craft to cause it to precess with a radius that increases due to the transverse force provided by the horizontal component of the hyperbolic-electron beam and the acceleration caused the variable imbalance in the gravitational and fifth forces in the transverse or xy-plane. For example, the tilt is provided by the activation and deactivation of multiple fifth-force devices spaced so that the desired torque perpendicular to the spin axis is maintained while the craft also undergoes a controlled fall, which increases the precessional radius.

During the translational acceleration in the xy-plane, energy stored in the flywheel is converted to kinetic energy of the vehicle. As the radius of the precession goes to infinity the rotational energy is entirely converted into transitional kinetic energy. The equation for rotational kinetic energy, E_{R}, and translational kinetic energy, E_{T}, are given as follows:

$${E}_{R} = \frac{1}{2} I {ω}^{2} \qquad ( 35.177 )$$

where I is the moment of inertia and w is the angular rotational frequency;

$${E}_{T} = \frac{1}{2} {mv}^{2} \qquad ( 35.178 )$$

where m is the total mass and v is the translational velocity of the craft. The equation for the moment of inertia, I, of the flywheel is given as:

I=Σmᵢr² (35.179)

where mᵢ is the infinitesimal mass at a distance r from the center of mass. Eqs. (35.177) and (35.179) demonstrate that the rotational kinetic energy stored for a given mass is maximized by maximizing the distance of the mass from the center of mass. Thus, ideal design parameters are cylindrical symmetry with the rotating mass, flywheel, at the perimeter of the vehicle.

The equation that describes the motion of the vehicle with a moment of inertia, I, a spin moment of inertial, Iₛ, a total mass, m, and a spin frequency of its flywheel of S is given as follows [15]:

$$\begin{matrix}mgl sin θ = I \ddot{θ} + {I}_{s} S \dot{φ} sin θ - I {\dot{φ}}^{2} cos θsin θ & ( 35.180 ) \\ 0 = I \frac{d}{d t} ( \dot{φ} sin θ ) - {I}_{s} S \dot{θ} + I \dot{θ} \dot{φ} cos θ & ( 35.181 ) \\ 0 = {I}_{s} \dot{S} & ( 35.182 )\end{matrix}$$

The schematic for the parameters of Eqs. (35.180-35.182) appears in FIG. 11 where θ is the tilt angle between the radial vector and the angular momentum vector, \ddot{θ} is the acceleration of the tilt angle θ, g is the acceleration due to gravity, l is the height to which the vehicle levitates, and \dot{φ} is the angular precession frequency resulting from the torque which is a consequence of tilting the craft.

Eq. (35.182) shows that S, the spin of the craft about the symmetry axis, remains constant. Also, the component of the angular momentum along that axis is constant.

L_{z}=IₛS=constant (35.183)

Eq. (35.181) is then equivalent to

$$0 = \frac{d }{d t} ( I \dot{φ} {sin}^{2} θ + {I}_{s} S cos θ ) \qquad ( 35.184 )$$

so that

I\dot{φ} sin² θ+IₓS cos θ=B=constant (35.185)

If there is no drag acting on the spinning craft to dissipate its energy, E, then the total energy, E, equal to the kinetic, T, and potential, V, remains constant:

$$\frac{1}{2} ( I {ω}_{x}^{2} + I {ω}_{y}^{2} + {I}_{s} {S}^{2} ) + mgl cos θ = E \qquad ( 35.186 )$$

or equivalently in terms of Eulerian angles,

$$\frac{1}{2} ( I {\dot{θ}}^{2} + I {\dot{φ}}^{2} {sin}^{2} θ + {I}_{s} {S}^{2} ) + mgl cos θ = E \qquad ( 35.187 )$$

From Eq. (35.185), \dot{φ} may be solved and substituted into Eq. (35.187). The result is

$$\frac{1}{2} I {\dot{θ}}^{2} + \frac{{( B - {I}_{s} S cos θ )}^{2}}{2 I {sin}^{2} θ} + \frac{1}{2} {I}_{s} {S}^{2} + mgl cos θ = E \qquad ( 35.188 )$$

which is entirely in terms of θ. Eq. (35.188) permits θ to be obtained as a function of time t by integration. The following substitution may be made:

u=cos θ (35.189)

Then

\dot{u}=−−(sin θ)\dot{θ}=−(1−u²)^{1/2}\dot{θ} (35.190)

Eq. (35.188) is then

\dot{u}²=(1−u²)(2E−IₛS²−2mglu)I⁻¹−(B−IₛSu)²I⁻² (35.191)

or

\dot{u}²=f(u) (35.192)

from which u (hence θ) may be solved as a function of t by integration:

$$t = \int \frac{d u}{\sqrt{f ( u )}} \qquad ( 35.193 )$$

In Eq. (35.163), f(u) is a cubic polynomial, thus, the integration may be carried out in terms of elliptic functions. Then, the precession velocity, \dot{φ}, may be solved by substitution of θ into Eq. (35.185) wherein the constant B is the initial angular momentum of the craft along the spin axis, IₛS given by Eq. (35.183). The radius of the precession is given by

R=l sin θ (35.194)

And the linear velocity, v, of the precession is given by

v=R\dot{φ} (35.195)

The maximum rotational speed for steel is approximately 1100 m/sec [16]. For a craft with a radius of 10 m, the corresponding angular velocity is

$$\frac{110 cycles}{sec} .$$

In the case that most of the mass of a 10⁴ kg was at this radius, the initial rotation energy (Eq. (35.177)) is 6×10⁹ J. As the craft tilts and changes altitude (increases or decreases), the vertical force imbalance in the xy-plane pushes the craft away from the axis that is radial with respect to the Earth. For example, as the craft tilts and falls, the created imbalance pushes the craft into a trajectory, which is analogous to that of a gyroscope as shown in FIG. 11. From FIG. 11, the force provided by the fifth force along the tilted z-axis (mg cos θ) may be less than the force to counter that of gravity on the craft. From Eq. (35.185), the rotational energy is transferred from the initial spin to the precession as the angle θ increases. From Eq. (35.186), the precessional energy may become essentially equal to the initial rotational energy plus the initial gravitational potential energy. Thus, the linear velocity of the craft may reach approximately 1100 m/sec (2500 mph).

During the transfer, the craft falls approximately one half the distance of the radius of the precession of the center of mass about the Z-axis. Thus, the initial vertical height, l, must be greater.

In the cases of solar system and interstellar travel, velocities approaching the speed of light may be obtained by using gravity assists from massive gravitating bodies wherein the fifth-force capability of the craft establishes the desired trajectory to maximize the assist.

### Experimental

Hyperbolic electrons are formed by scattering at the energies given in Table 1 wherein the scattering is elastic. The minimum elastic scattering threshold for the formation of hyperbolic electrons is given by Eq. (35.132). Hyperbolic electrons can also be formed by inelastic scattering wherein the difference between the incidence energy Eᵢ and the excitation energy Eₗₒₛₛ of the species with which the free electron collides is one of the resonant production energies T (Eq. (35.133)), the one of the kinetic energies given in Table 1. Thus, free-electrons made incident on and elastically scattered from target species such as noble-gas atoms (e.g. He, Ne, Ar, Kr, and Xe) or molecules (e.g. H₂ and N₂) are anticipated to form hyperbolic electrons that accelerate away from the center of the Earth at a threshold energy of 42.3 eV and the additional resonance energies given in Table 1. And, the fifth-force effect will occur at higher incident electron energy as hyperbolic electrons form according to the resonance condition of Eq. (35.133) due to incident-electron energy loss. The loss may be due to excitation or recoil energy transfer to the collision target, such as a noble gas atom, until a resonant energy given in Table 1 for the scattered free-electrons can no longer be achieved. In the case of a resonant elastic excitation, distinct peaks in the upward-deflected-beam current of an electron are predicted at the incident energies given in Table 1. These predictions have been confirmed experimentally.

### Experimental Apparatus to Create a Fifth Force

The experimental set up for scattering an electron beam from a crossed atomic beam and measuring the fifth-force deflected beam as the normalized current at a top electrode relative to a bottom electrode is shown in FIG. 12. The side, top, and inside views of the fifth-force testing apparatus are shown in FIGS. 13, 14, and 15, respectively. The beams and electrodes were housed in a stainless steel chamber with two cylindrical μ-metal shields to eliminate the influence of the Earth's magnetic field. The inner μ-metal cylinder had a diameter of 50 mm, and the outer μ-metal cylinder had a diameter of 130 mm. The electron gun was a Kimball Physics ELG-2 (5-2 keV, 1 nA-10 μA). In the energy region of 20-160 eV, the typical electron beam spot size was about 0 5 mm at a working distance of 20 mm, the half-width and accuracy of the beam energy were both about ±1 eV, and the incident beam current was in the range of 100 nA-1 μA. A noble-gas atomic beam or molecular beam was produced by flowing the gas (He, Ne, Ar, Xe, H₂, or N₂) into the chamber through a gas nozzle made of quarter inch OD stainless steel tubing and having a 10 micron-diameter orifice positioned 30 mm from the tip of the electron gun. The chamber vacuum pressure before introducing the gas was 5×10⁻⁷ Torn The chamber pressure with the introduction of the atomic beam was typically in the range of 1.5×10⁻⁵ to 6×10⁻⁵ Torr. The pressure was adjusted to optimize the fifth-force effect. A Faraday cup collected the undeflected portion of the beam. With low charging at the electrodes, the peak current deflected current away from the Faraday cup was up to 60% of the incident current observed as peaks at specific energies.

The 20×15 mm molybdenum plate electrodes were positioned above and below the beam path perpendicular to the gravitation-force line of the Earth with a separation of 40 mm and positioned 100 mm and then 50 mm from the gas nozzle to test the fifth force in the far field and near field, respectively. A small Faraday cup to measure the axis beam intensity was positioned 130 mm from the molybdenum plates in the direction of electron beam axis. The scattering angles were about 10-13° and 18-27° for the 100 mm and 50 mm position, respectively. The upper and bottom plates were each connected to a pico-ammeter for current measurement. Before introducing the gas into the chamber, the axial electron beam intensity was optimized for each energy position as the energy was stepped over the range of 10 eV to 160 eV at 1 eV intervals with a dwell time of 5 seconds per position. The electron beam energy, electron gun focusing, and beam deflection voltages were controlled by the power supply system and PC software. The scattering current intensities at both electrodes were recorded as a function of the electron beam energy.

### Results and Discussion of Tests on the Fifth Force

### Far-Field Results

The current at the upper electrode normalized by that at the bottom electrode when the electron beam was incident with a helium, neon, argon, krypton, and xenon atomic beam and a hydrogen and nitrogen molecular beam compared to the absence of the atomic beam at a flight distance of 100 mm is shown in FIGS. 16-22, respectively. No energy-dependent bias in the beam current was present as indicated by the flat ratio of upper and bottom electrode currents in the absence of the atomic or molecular beam. The ratio was close to one over the entire energy range for all experiments involving the controls of all gases indicating that the beam was well centered. In contrast, when the atomic or molecular beam was introduced, a striking upward deflection of the beam was observed as an increased current at the upper and a decreased at current at the lower electrode giving a normalized ratio significantly greater than that in the absence of the atomic beam. Furthermore, a series of peaks were observed that matched the theoretical predictions for the formation of some of the hyperbolic-electronic states given in Table 1. The peak assignments for helium, neon, argon, krypton, xenon, hydrogen and nitrogen are given in Tables 2-8, respectively. Peaks with an expected high transition probability such as that corresponding to the n=1 Sₚ state at 64.7 eV were strong; whereas, peaks involving low probability such as the 48.3 eV peak corresponding to the (l=0 mₗ=0)+(l=1 mₗ=0) state involving a double excitation were low. The fifth-force effect continued at higher incident electron energy with decreasing intensity in agreement with the decreased cross section for energy loss to match the condition of Eq. (35.133).

Typically, the peak intensities were a maximum at a pressure of about 3.5×10⁻⁵ Torr and a beam current of about 100 nA. Furthermore, it was observed that the intensity of the hyperbolic-electronic-state peaks decreased in intensity after the first scan and the lower-intensity spectrum was extremely reproducible thereafter. This observation was found to be due to the differential deflection that gives a charging differential. Once charging occurred, greater intensity peaks were observed as the pressure was increased over a range of about a factor of two since the gas partially discharged the electrodes. The charging effect could also be partially compensated for with an increase in beam current over a range of 30% since it increased the upward current due to the higher probability for electron scattering as the number of electrons increases. Since the ratio of the beam currents in the absence of the atomic or molecular beam was observed to be about one over the energy range and energy peaks are observed, the charging does not eliminate the fifth-force effect, but only dampens it. It was also found that inelastic interference was not a significant issue in observing the predicted resonant peaks corresponding to the fifth-force effect, even in the case of scattering from a molecular beam in the far field. Molecules have many continua bands in their absorption spectra. But, inelastic scattering of the incident electron beam using a molecular beam was not appreciable as shown by the observation of intense resonant peaks shown in FIGS. 21 and 22.

TABLE 2
The assignment of the incident electron energy peaks observed
in the normalized upwardly deflected electron beam elastically
scattered from a helium atomic beam to theoretical energies
and the corresponding quantum numbers of n = 1 resonant
hyperbolic-electronic states.

| | Observed | Theoretical | |
|---|---|---|---|
| | Peak | Threshold | |
| | Energy | Kinetic Energy | Quantum Numbers |
| Peak # | (eV) | (eV) | Sₚ, l, and mₗ |
| 1 | 47 | 42.32 | l = 0 mₗ = 0 |
| 3 | 55 | 55.57 | l = 1 mₗ = 0 |
| 5 | 65 | 64.65 | Sₚ |

TABLE 3
The assignment of the incident electron energy peaks observed
in the normalized upwardly deflected electron beam elastically
scattered from a neon atomic beam to theoretical energies
and the corresponding quantum numbers of n = 1 resonant
hyperbolic-electronic states.

| | Observed | Theoretical | |
|---|---|---|---|
| | Peak | Threshold | |
| | Energy | Kinetic Energy | Quantum Numbers |
| Peak # | (eV) | (eV) | Sₚ, l, and mₗ |
| 1 | 45 | 42.32 | l = 0 mₗ = 0 |
| 3 | 55 | 55.57 | l = 1 mₗ = 0 |
| 5 | 66 | 64.65 | Sₚ |
| 6 | 72 | 70.06 | Sₚ + (l = 1 mₗ = 1) |
| 7 | 78 | 76.17 | l = 1 mₗ = 1 |

TABLE 4
The assignment of the incident electron energy peaks observed
in the normalized upwardly deflected electron beam elastically
scattered from an argon atomic beam to theoretical energies
and the corresponding quantum numbers of n = 1 resonant
hyperbolic-electronic states.

| | Observed | Theoretical | |
|---|---|---|---|
| | Peak | Threshold | |
| | Energy | Kinetic Energy | Quantum Numbers |
| Peak # | (eV) | (eV) | Sₚ, l, and mₗ |
| 1 | 45 | 42.32 | l = 0 mₗ = 0 |
| 2 | 49 | 48.27 | (l = 0 mₗ = 0) + (l = 1 mₗ = 0) |
| 3 | 55 | 55.57 | l = 1 mₗ = 0 |
| 4 | 59 | 59.85 | Sₚ + (l = 1 mₗ = 0) |
| 5 | 67 | 64.65 | Sₚ |
| 6 | 72 | 70.06 | Sₚ + (l = 1 mₗ = 1) |
| 7 | 78 | 76.17 | l = 1 mₗ = 1 |

TABLE 5
The assignment of the incident electron energy peaks observed
in the normalized upwardly deflected electron beam elastically
scattered from a krypton atomic beam to theoretical energies
and the corresponding quantum numbers of n = 1 resonant
hyperbolic-electronic states.

| | Observed | Theoretical | |
|---|---|---|---|
| | Peak | Threshold | |
| | Energy | Kinetic Energy | Quantum Numbers |
| Peak # | (eV) | (eV) | Sₚ, l, and mₗ |
| 1 | 45 | 42.32 | l = 0 mₗ = 0 |
| 3 | 55 | 55.57 | l = 1 mₗ = 0 |
| 4 | 60 | 59.85 | Sₚ + (l = 1 mₗ = 0) |
| 5 | 67 | 64.65 | Sₚ |
| 6 | 72 | 70.06 | Sₚ + (l = 1 mₗ = 1) |

TABLE 6
The assignment of the incident electron energy peaks observed
in the normalized upwardly deflected electron beam elastically
scattered from a xenon atomic beam to theoretical energies
and the corresponding quantum numbers of n = 1 resonant
hyperbolic-electronic states.

| | Observed | Theoretical | |
|---|---|---|---|
| | Peak | Threshold | |
| | Energy | Kinetic Energy | Quantum Numbers |
| Peak # | (eV) | (eV) | Sₚ, l, and mₗ |
| 1 | 46 | 42.32 | l = 0 mₗ = 0 |
| 4 | 60 | 59.85 | Sₚ + (l = 1 mₗ = 0) |
| 5 | 67 | 64.65 | Sₚ |
| 6 | 72 | 70.06 | Sₚ + (l = 1 mₗ = 1) |
| 7 | 78 | 76.17 | l = 1 mₗ = 1 |

TABLE 7
The assignment of the incident electron energy peaks observed
in the normalized upwardly deflected electron beam elastically
scattered from a hydrogen molecular beam to theoretical energies
and the corresponding quantum numbers of n = 1 resonant
hyperbolic-electronic states.

| | Observed | Theoretical | |
|---|---|---|---|
| | Peak | Threshold | |
| | Energy | Kinetic Energy | Quantum Numbers |
| Peak # | (eV) | (eV) | Sₚ, l, and mₗ |
| 1 | 45 | 42.32 | l = 0 mₗ = 0 |
| 3 | 55 | 55.57 | l = 1 mₗ = 0 |
| 5 | 67 | 64.65 | Sₚ |
| 6 | 72 | 70.06 | Sₚ + (l = 1 mₗ = 1) |
| 7 | 78 | 76.17 | l = 1 mₗ = 1 |

TABLE 8
The assignment of the incident electron energy peaks observed
in the normalized upwardly deflected electron beam elastically
scattered from a nitrogen molecular beam to theoretical energies
and the corresponding quantum numbers of n = 1 resonant
hyperbolic-electronic states.

| | Observed | Theoretical | |
|---|---|---|---|
| | Peak | Threshold | |
| | Energy | Kinetic Energy | Quantum Numbers |
| Peak # | (eV) | (eV) | Sₚ, l, and mₗ |
| 1 | 45 | 42.32 | l = 0 mₗ = 0 |
| 3 | 55 | 55.57 | l = 1 mₗ = 0 |
| 5 | 67 | 64.65 | Sₚ |
| 6 | 72 | 70.06 | Sₚ + (l = 1 mₗ = 1) |
| 7 | 78 | 76.17 | l = 1 mₗ = 1 |

### Near-Field Results

The distance of the electrodes from the beam intersection point was decreased from 100 mm to 50 mm. It was found that considerably more charging of the upper electrode occurred in the 50 mm case as expected which required a higher gas pressure of about 5×10⁻⁵ to obtain good spectra. Charging was evidenced by the dramatic decrease in the spectral intensity upon repeat scanning with significant broadening of the peaks. Only after a significant delay between scans was the intensity recovered. This effect is shown for neon in comparing FIGS. 24 and 25. This is an indication that the half-life of a hyperbolic state can be very long (>1 min) In addition, it was found that certain lines of the spectra changed their relative intensity with pressure. And, the lower-energy as compared to higher-energy peaks dominated the spectrum depending on the whether the electron gun was maintained at high energy (200 V) or low energy (10 V), respectively, as the chamber was extensively pumped. This would be expected if collisional depopulation of these states having large half-lives was dependent on the energy of the state and that of the collisional partner or secondary electrons or ions to which energy is transferred. An example of this effect is shown for Xe in FIG. 28.

The gun energy was set to 10 V with extensive pumping with gas flow at pressure between scans to enhance the high-energy region of the spectrum. But, even at this condition, there appeared to be a bias for the higher-energy range of the spectrum in the 50 mm case. Based on the vector projections of the velocity of Eqs. (35.163-35.167), the upward acceleration due to the fifth force increases with the kinetic energy of production of the hyperbolic electrons. Thus, it is expected that the higher-energy states dominate the spectrum in the near field and the lower-energy states dominate in the far field. To test this prediction, the 50 mm results were compared to the corresponding 100 mm results. Specifically, the upper-electrode current normalized by that at the bottom electrode when the electron beam was incident with a helium, neon, argon, krypton, and xenon atomic beam and a hydrogen and nitrogen molecular beam compared to the absence of the atomic beam is shown in FIGS. 16-22 with peak assignments given in Tables 2-8, respectively. The predicted trend is apparent when these results are compared to the corresponding 50 mm results given in FIGS. 23-30 and Tables 9-16.

With optimization of the pressure condition, a very large fifth-force effect was observed as measured by the percentage of the incident current involved. With Xe, the current at the

Faraday cup dropped to less than half the incident current at 55 eV, 74 eV and 81 eV as the pressure was increased to an optimized value. These peaks did not match ionization energies of xenon or sum thereof The sharp dips in Faraday current corresponded to the peaks for the l=1 mₗ=0, l=1 mₗ=1, and (Sₚ+l=1 mₗ=0)+(l=1 mₗ=0) state formation showing very strong resonance production with this scatterer and the sets of conditions run. The effect was repeated with Kr which showed a sharp dip in the Faraday current of about half the incident current at 74 eV corresponding to the peak for the l=1 mₗ=1 state formation. The same dip but of less intensity was observed with Ne, and a small dip (˜15%) was also observed at 55 eV, 74 eV, and 81 eV with Ar. The trend was Xe>Kr>Ar>Ne as expected based on the geometric cross sections. This effect occurred as the pressure was increased to an optimum of about 5.5×10⁻⁵ Torr. As with the other gases, the intensities of the peaks of the electrode current ratios were pressure dependent, but the presence of peaks at predicted energies was 100% reproducible.

TABLE 9
The assignment of the incident electron energy peaks observed
in the normalized upwardly deflected electron beam elastically
scattered from a helium atomic beam to theoretical energies
and the corresponding quantum numbers of n = 1 resonant
hyperbolic-electronic states.

| | Observed | Theoretical | |
|---|---|---|---|
| | Peak | Threshold | |
| | Energy | Kinetic Energy | Quantum Numbers |
| Peak # | (eV) | (eV) | Sₚ, l, and mₗ |
| 5 | 65 | 64.65 | Sₚ |
| 7 | 76 | 76.17 | l = 1 mₗ = 1 |
| 9 | 82 | 83.11 | (Sₚ + l = 1 mₗ = 0) + (l = 1 mₗ = 0) |
| 11 | 100 | 100.18 | (Sₚ + l = 1 mₗ = 1) + (l = 1 mₗ = 0) |

TABLE 10
The assignment of the incident electron energy peaks observed
in the normalized upwardly deflected electron beam elastically
scattered from a neon atomic beam to theoretical energies and
the corresponding quantum numbers of n = 1 resonant
hyperbolic-electronic states.

| | Observed | Theoretical | |
|---|---|---|---|
| | Peak | Threshold | |
| Peak | Energy | Kinetic | Quantum Numbers |
| # | (eV) | Energy (eV) | Sₚ, l, and mₗ |
| 9 | 83 | 83.11 | (Sₚ + l = 1 mₗ = 0) + (l = 1 mₗ = 0) |
| 11 | 99 | 100.18 | (Sₚ + l = 1 mₗ = 1) + (l = 1 mₗ = 0) |
| 12 | 109 | 110.76 | (((Sₚ + l = 1 mₗ = 1) + (l = 1 mₗ = 0)) + |
| | | | ((Sₚ + l = 1 mₗ = 0) + (l = 1 mₗ = 1))) |
| 13 | 120 | 123.11 | (Sₚ + l = 1 mₗ = 0) + (l = 1 mₗ = 1) |
| 14 | 136 | 137.65 | (((Sₚ + l = 1 mₗ = 0) + (l = 1 mₗ = 1)) + |
| | | | ((Sₚ + l = 1 mₗ = 1) + (l = 1 mₗ = 1))) |
| 15 | 150 | 154.92 | (Sₚ + l = 1 mₗ = 1) + (l = 1 mₗ = 1) |

TABLE 11
The assignment of the incident electron energy peaks observed
in the normalized upwardly deflected electron beam elastically
scattered from a neon atomic beam to theoretical energies and
the corresponding quantum numbers of n = 1 resonant
hyperbolic-electronic states.

| | Observed | Theoretical | |
|---|---|---|---|
| | Peak | Threshold | |
| | Energy | Kinetic Energy | Quantum Numbers |
| Peak # | (eV) | (eV) | Sₚ, l, and mₗ |
| 11 | 100 | 100.18 | (Sₚ + l = 1 mₗ = 1) + (l = 1 mₗ = 0) |

TABLE 12
The assignment of the incident electron energy peaks observed
in the normalized upwardly deflected electron beam elastically
scattered from an argon atomic beam to theoretical energies
and the corresponding quantum numbers of n = 1 resonant
hyperbolic-electronic states.

| | Observed | Theoretical | |
|---|---|---|---|
| | Peak | Threshold | |
| | Energy | Kinetic Energy | Quantum Numbers |
| Peak # | (eV) | (eV) | Sₚ, l, and mₗ |
| 3 | 55 | 55.57 | l = 1 mₗ = 0 |
| 4 | 61 | 59.85 | Sₚ + (l = 1 mₗ = 0) |
| 7 | 77 | 76.17 | l = 1 mₗ = 1 |

TABLE 13
The assignment of the incident electron energy peaks observed
in the normalized upwardly deflected electron beam elastically
scattered from a krypton atomic beam to theoretical energies
and the corresponding quantum numbers of n = 1 resonant
hyperbolic-electronic states.

| | Observed | Theoretical | |
|---|---|---|---|
| | Peak | Threshold | |
| | Energy | Kinetic Energy | Quantum Numbers |
| Peak # | (eV) | (eV) | Sₚ, l, and mₗ |
| 6 | 69 | 70.06 | Sₚ + (l = 1 mₗ = 1) |
| 7 | 78 | 76.17 | l = 1 mₗ = 1 |
| 9 | 82 | 83.11 | (Sₚ + l = 1 mₗ = 0) + (l = 1 mₗ = 0) |

TABLE 14
The assignment of the incident electron energy peaks observed
in the normalized upwardly deflected electron beam elastically
scattered from a xenon atomic beam to theoretical energies
and the corresponding quantum numbers of n = 1 resonant
hyperbolic-electronic states.

| | Observed | Theoretical | |
|---|---|---|---|
| | Peak | Threshold | |
| Peak | Energy | Kinetic | Quantum Numbers |
| # | (eV) | (eV) | Energy Sₚ, l, and mₗ |
| 1 | 45 | 42.32 | l = 0 mₗ = 0 |
| 2 | 48 | 48.27 | (l = 0 mₗ = 0) + (l = 1 mₗ = 0) |
| 6 | 69 | 70.06 | Sₚ + (l = 1 mₗ = 1) |
| 8 | 79 | 79.52 | (((Sₚ + l = 1 mₗ = 0) + (l = 1 mₗ = 0)) + |
| | | | (l = 1 mₗ = 1)) |
| 9 | 82 | 83.11 | (Sₚ + l = 1 mₗ = 0) + (l = 1 mₗ = 0) |
| 10 | 91 | 91.05 | (((Sₚ + l = 1 mₗ = 0) + (l = 1 mₗ = 0)) + |
| | | | ((Sₚ + l = 1 mₗ = 1) + (l = 1 mₗ = 0))) |

TABLE 15
The assignment of the incident electron energy peaks observed
in the normalized upwardly deflected electron beam elastically
scattered from a hydrogen molecular beam to theoretical energies
and the corresponding quantum numbers of n = 1 resonant
hyperbolic-electronic states.

| | Observed | Theoretical | |
|---|---|---|---|
| | Peak | Threshold | |
| Peak | Energy | Kinetic | Quantum Numbers |
| # | (eV) | Energy (eV) | Sₚ, l, and mₗ |
| 3 | 55 | 55.57 | l = 1 mₗ = 0 |
| 4 | 61 | 59.85 | Sₚ + (l = 1 mₗ = 0) |
| 9 | 83 | 83.11 | (Sₚ + l = 1 mₗ = 0) + (l = 1 mₗ = 0) |
| 11 | 99 | 100.18 | (Sₚ + l = 1 mₗ = 1) + (l = 1 mₗ = 0) |
| 12 | 109 | 110.76 | (((Sₚ + l = 1 mₗ = 1) + (l = 1 mₗ = 0)) + |
| | | | ((Sₚ + l = 1 mₗ = 0) + (l = 1 mₗ = 1))) |
| 13 | 120 | 123.11 | (Sₚ + l = 1 mₗ = 0) + (l = 1 mₗ = 1) |
| 14 | 135 | 137.65 | (((Sₚ + l = 1 mₗ = 0) + (l = 1 mₗ = 1)) + |
| | | | ((Sₚ + l = 1 mₗ = 1) + (l = 1 mₗ = 1))) |

TABLE 16
The assignment of the incident electron energy peaks observed
in the normalized upwardly deflected electron beam elastically
scattered from a nitrogen molecular beam to theoretical energies
and the corresponding quantum numbers of n = 1 resonant
hyperbolic-electronic states.

| | Observed | Theoretical | |
|---|---|---|---|
| | Peak | Threshold | |
| Peak | Energy | Kinetic | Quantum Numbers |
| # | (eV) | Energy (eV) | Sₚ, l, and mₗ |
| 3 | 55 | 55.57 | l = 1 mₗ = 0 |
| 4 | 61 | 59.85 | Sₚ + (l = 1 mₗ = 0) |
| 9 | 83 | 83.11 | (Sₚ + l = 1 mₗ = 0) + (l = 1 mₗ = 0) |
| 11 | 99 | 100.18 | (Sₚ + l = 1 mₗ = 1) + (l = 1 mₗ = 0) |
| 12 | 109 | 110.76 | (((Sₚ + l = 1 mₗ = 1) + (l = 1 mₗ = 0)) + |
| | | | ((Sₚ + l = 1 mₗ = 0) + (l = 1 mₗ = 1))) |
| 13 | 120 | 123.11 | (Sₚ + l = 1 mₗ = 0) + (l = 1 mₗ = 1) |

### Acceleration Due to the Fifth Force

The magnitude of the fifth force can be conservatively calculated from the deflection distance and time of flight of the hyperbolic electrons to the upper electrode in the far-field case (100 mm transit distance). The time of flight to the electrodes after the scattering event to form a hyperbolic electron can be estimated from the transit distance Δz by

$$t = \frac{Δ z}{{v}_{{z}^{0}}} \qquad ( 35.196 )$$

Then, the acceleration due to the fifth force is given by

$$a = \frac{2 Δ x}{{t}^{2}} = \frac{2 Δ x}{{( \frac{Δ z}{{v}_{{z}^{0}}} )}^{2}} = 2 Δ {x ( \frac{{v}_{{z}^{0}}}{Δ z} )}^{2} \qquad ( 35.197 )$$

where Δx is the vertical distance from the beam axis to the top electrode. The dimensions of the apparatus are shown in FIG. 31. With an incident electron kinetic energy of 42.3 eV (Eq. (35.132)), the electron velocity given by Eq. (35.130) is v_{z0}=3.86×10⁶ m/s. Then, using Δz=0.1 m and Δx=0.02 m in Eqs. (35.196) and (35.197), the flight time and fifth-force acceleration are

$$\begin{matrix}t = \frac{Δ z}{{v}_{{z}^{0}}} = ( \frac{0.1 m}{3.86 \times {10}^{6} m \text{/} s} ) = 2.59 \times {10}^{- 8} s & ( 35.198 ) \\ {a}_{x} = 2 Δ {x ( \frac{{v}_{{z}^{0}}}{Δ z} )}^{2} \\ = 2 ( 0.02 m ) {( \frac{3.86 \times {10}^{6} m \text{/} s}{0.1 m} )}^{2} \\ = 5.96 \times {10}^{13} m \text{/} {s}^{2} & ( 35.199 )\end{matrix}$$

The electron velocity upon reaching the upper plate is

vₓ=aₓt=(5.96'10¹³ m/s²)(2.59×10⁻⁸ s)=1.54×10⁶ m/s (35.200)

and the corresponding energy is

$$T = \frac{1}{2} {m}_{e} {v}_{x}^{2} = \frac{1}{2} {{m}_{e} ( 1.54 \times {10}^{6} m \text{/} s )}^{2} = 6.77 eV \qquad ( 35.201 )$$

As a comparison with the fifth-force acceleration given by Eq. (35.197), the acceleration due to gravity is only 9.8 m/s². The fifth-force acceleration based on this estimate is over twelve orders of magnitude greater. Even a micro fifth-force device has great promise as a replacement for micro-ion-thrusters for maintaining the orbits of satellites.

In further embodiments, hyperbolic electrons are formed by scattering from other scattering means such as from other atoms and molecules and by fields such as electric and magnetic fields. The magnetic field may be a multipole field, preferably a dipole or quadrupole field.

### Other Embodiments of a Propulsion Device

In further embodiments, hyperbolic electrons are formed by scattering from scattering means other than atoms or molecules such as scattering by fields such as electric and magnetic fields. The magnetic field may be a multipole field, preferably a dipole or quadrupole field. Furthermore, as in the case of free electrons in superfluid helium, hyperbolic electrons can absorb specific frequencies of light to transition to higher-kinetic energy states corresponding to reduced radii. By this means, the fifth force can be increased. Thus, the device of the present invention further comprises a photon source such as a laser to cause transitions of hyperbolic electron to the reduce-radii states. The position of the photon source may be at the position of and in replacement of the atomic beam shown in FIGS. 8 and 9 wherein the photon source may also comprise the means to cause the transitions of free electrons to hyperbolic electron states. Preferably, the photons have energies about equal to the transition energies. Preferably, the photon energies are at least one of those given in Table 1.

In another embodiment according to the present invention, the apparatus for providing the fifth force comprises a means to inject electrons and a guide means to guide the electrons. Hyperbolic electrons are produced from the propagating guided electrons by application of one or more of an electric field, a magnetic field, or an electromagnetic field by a field source means. The propagating hyperbolic electrons are repelled by the fifth force arising from the gravitational field of a gravitating body. A field source means provides an opposite force to the repulsive fifth force on the hyperbolic electrons Thus, the repulsive fifth force is transferred to the field source and the guide which further transfers the force to the attached structure to be propelled.

In an embodiment, the propulsion means shown schematically in FIG. 32 comprises an electron beam source 100, and an electron accelerator module 101, such as an electron gun, an electron storage ring, a radiofrequency linac, an introduction linac, an electrostatic accelerator, or a microtron. The beam is focused by focusing means 112, such as a magnetic or electrostatic lens, a solenoid, a quadrupole magnet, or a laser beam. In an embodiment, hyperbolic electrons are produced by the interaction of the free electrons and the electronic or magnetic field of means 112. The electron beam such as a hyperbolic electron beam 113, is directed into a channel of electron guide 109, by beam directing means 102 and 103, such as dipole magnets. Channel 109, comprises a field generating means to produce a constant electric or magnetic force in the direction opposite to direction of the fifth force. For example, given that the repulsive fifth force is negative z directed as shown in FIG. 32, the field generating means 109, provides a constant z directed electric force due to a constant electric field in the negative z direction via a linear potential provided by grid electrodes 108 and 128. Or, given that the repulsive fifth force is positive y directed as shown in FIG. 32, the field generating means 109, provides a constant negative y directed electric force due to a constant electric field in the negative y direction via a linear potential provided by the top electrode 120, and bottom electrode 121, of field generating means 109. The force provides work against the gravitational field of the gravitating body as the hyperbolic electron propagates along the channel of the guide means and field producing means 109. The resulting work is transferred to the means to be propelled via its attachment to field producing means 109.

The electric or magnetic force is variable until force balance with the repulsive fifth force may be achieved. In the absence of force balance, the electrons will be accelerated and the emittance of the beam will increase. Also, the accelerated hyperbolic electrons will radiate; thus, the drop in emittance and/or the absence of radiation is the signal that force balance is achieved. The emittance and/or radiation is detected by sensor means 130, such as a photomultiplier tube, and the signal is used in a feedback mode by analyzer-controller 140 which varies the constant electric or magnetic force by controlling the potential or dipole magnets of (field producing) means 109 to control force balance to maximize the propulsion.

In one embodiment, the field generating means 109, further provides an electric or magnetic field that produces hyperbolic electrons of the electron beam 113. In another embodiment, hyperbolic electrons are produced from the electron beam 113 by the absorption of photons provided by a photon source 105, such as a high intensity photon source, such as a laser. The laser radiation can be confined to a resonator cavity by mirrors 106 and 107.

In a further embodiment, hyperbolic electrons are produced from the electron beam 113 by photons from the photon source 105. The laser radiation or the resonator cavity is oriented relative to the propagation direction of the electrons such that the cross section for hyperbolic-electron production is maximized.

Following the propagation through the field generating means 109 in which propulsion work is extracted from the beam 113, the beam 113, is directed by beam directing apparatus 104, such as a dipole magnet into electron-beam dump 110.

In a further embodiment, the beam dump 110 is replaced by a means to recover the remaining energy of the beam 113 such as a means to recirculate the beam or recover its energy by electrostatic deceleration or deceleration in a radio frequency-excited linear accelerator structure. These means are described by Feldman [17] which is incorporated by reference.

The present invention comprises high current and high-energy beams and related systems of free electron lasers. Such systems are described in Nuclear Instruments and Methods in Physics Research [18-19] that are incorporated herein by reference.

### Additional Embodiments of the States Formed of the Free Electron

In addition to superfluid helium, free electrons also form bubbles devoid of any atoms in other fluids such as oils and liquid ammonia. In the operation of an electrostatic atomizing device Kelly [20] observed that the mobility of free electrons in oil increased by an integer factor rather that continuously. Above the breakdown of the discharge device, the slope of the current versus electric field was discontinuous. It shifted to one half that before breakdown. This corresponds to a higher mobility of electrons to the grounded electrode of a triode of the atomizer, with a concomitant reduction in charging of the moving oil and the corresponding charged fluid current at the outlet of the dispersion device. As in the case of the discharge effect on the mobility of free electrons in superfluid helium, the breakdown current is a light source which excites the electron to transition from the n=1 to the

$$n = \frac{1}{2}$$

state given by Eq. (42.126). Excitation of electrons to fractional states is a method to increase their mobility to more effectively charge a fluid in order to form a dispersed fluid. The apparatus patented by Kelly [20] may be improved by a modification to include a source of light to cause the electron transitions to fractional states.

Alkali metals, and to a lesser extent other metals such as Ca, Sr, Ba, Eu, and Yb are soluble in liquid ammonia and certain other solvents. The electrolytically conductive solutions have free electrons of extraordinary mobility as their main charge carriers [21]. In very pure liquid ammonia the lifetime of free electrons can be significant with less than 1% decomposition per day. The confirmation of their existence as free entities is given by their broad absorption around 15,000 Å that can only be assigned to free electrons in the solution that is blue due to the absorption. In addition, magnetic and electron spin resonance studies show the presence of free electrons, and a decrease in paramagnetism with increasing concentration is consistent with spin pairing of electrons to form diamagnetic pairs. As in the case of free electrons in superfluid helium, ammoniated free electrons form cavities devoid of ammonia molecules having a typical diameter of 3-3.4 Å. The cavities are evidenced by the observation that the solutions are of much lower density than the pure solvent. From another perspective, they occupy far too great a volume than that predicted from the sum of the volumes of the metal and solvent. An understanding of the structure of free electrons in other fluids such as liquid ammonia may further lead to means to control the electron mobility and reactivity by controlling the fractional state using light.

### Implicit Ranges

It is to be understood by one skilled in the Art that when a specific energy is given certain ranges are tolerable. In one embodiment, the range is the specified energy ±1000 eV, preferably ±100 eV, more preferably ±5 eV, and most preferably it is the value ±1 eV.

### REFERENCES

1. V. Fock, The Theory of Space, Time, and Gravitation, The MacMillan Company, (1964).
2. L. Z. Fang, and R. Ruffini, Basic Concepts in Relativistic Astrophysics, World Scientific, (1983).
3. G. R. Fowles, Analytical Mechanics, Third Edition, Holt, Rinehart, and Winston, N.Y., (1977), pp. 154-155.
4. F. C. Witteborn, W. M. and Fairbank, Physical Review Letters, Vol. 19, No. 18, (1967), pp. 1049-1052.
5. R. N. Bracewell, The Fourier Transform and Its Applications, McGraw-Hill Book Company, New York, (1978), pp. 252-253.
6. A. Apelblat, Table of Definite and Infinite Integrals, Elsevier Scientific Publishing Company,

Amsterdam, (1983).
7. H. A. Haus, “On the radiation from point charges”, Am. J. Phys., 54, (1986), pp. 1126-1129.
8. T. A. Abbott, D. J. Griffiths, Am. J. Phys., Vol. 153, No. 12, (1985), pp. 1203-1211.
9. G. Goedecke, Phys. Rev., 135B, (1964), p. 281.
10. H. A. Haus, J. R. Melcher, “Electromagnetic Fields and Energy”, Department of Electrical Engineering and Computer Science, Massachusetts Institute of Technology, (1985), Sec. 8.6.
11. R. F. Bonham, M. Fink, High Energy Electron Scattering, ACS Monograph, Van Nostrand Reinhold Company, New York, (1974).
12. G. R. Fowles, Analytical Mechanics, Third Edition, Holt, Rinehart, and Winston, N.Y., (1977), pp. 140-164.
13. G. R. Fowles, Analytical Mechanics, Third Edition, Holt, Rinehart, and Winston, N.Y., (1977), pp. 154-160.
14. G. R. Fowles, Analytical Mechanics, Third Edition, Holt, Rinehart, and Winston, N.Y., (1977), pp. 182-184.
15. G. R. Fowles, Analytical Mechanics, Third Edition, Holt, Rinehart, and Winston, N.Y., (1977), pp. 243-247.
16. J. W. Beams, “Ultrahigh-Speed Rotation”, pp. 135-147.
17. Feldman, D. W., et al., Nuclear Instruments and Methods in Physics Research, A259, 26-30 (1987).
18. Nuclear Instruments and Methods in Physics Research, A272, (1,2), 1-616 (1988).
19. Nuclear Instruments and Methods in Physics Research, A259, (1,2), 1-316 (1987).
20. Arnold J. Kelly, “Electrostatic Atomizing Device”, U.S. Pat. No. 4,581,675, Apr. 8, 1986.
21. F. A. Cotton, G. Wilkinson, Advanced Inorganic Chemistry A Comprehensive Text, Interscience Publishers, New York, N.Y., (1962), pp. 193-194.

What is claimed is:

1. A method of providing a fifth force from a gravitating mass comprising the steps of:
providing a free electron;
forming a hyperbolic-electron state of the electron wherein a repulsive fifth force away from said gravitating mass is created;
applying a field from a field source to the hyperbolic electron;
receiving the repulsive fifth force on said field source from the hyperbolic electron in response to the force provided by said gravitating mass and the hyperbolic electron.

2. The method of claim 1, wherein the step of forming comprises the step of
providing an electron beam and a neutral atomic or molecular beam; and
providing the intersection of said beams such that the electrons form hyperbolic electrons.

3. The method of claim 2, wherein
the radius of at least one of each incident and hyperbolic electron is given by the force balance equation according to
$${F}_{centifugal} = {F}_{Coulombic} + \sum {F}_{mag}$$
$$\frac{{ℏ}^{2}}{{m}_{e} {r}^{3}} = \frac{{e}^{2}}{4 π {ɛ}_{0} {r}^{2}} + \sum {F}_{mag}$$
where F_{centrifugal} is the centrifugal force, F_{Coulombic} is the Coulombic force, and ΣF_{mag} is the sum of the magnetic forces.

4. The method of claim 3, wherein the magnetic force is at least one of or a linear combination of one or more of
$${F}_{orbital} = {\sum }_{m} \frac{( l + \vert m \vert ) !}{( 2 l + 1 ) ( l - \vert m \vert ) !} \frac{{ℏ}^{2}}{4 {m}_{e} {r}_{0}^{3}} \sqrt{s ( s + 1 )} {i}_{r}$$
$$For l = 1 {m}_{l} = 0$$
$${F}_{orbital} = \frac{1}{3} \frac{{ℏ}^{2}}{4 {m}_{e} {r}_{0}^{3}} \sqrt{s ( s + 1 )} {i}_{r}$$
$$For l = 1 {m}_{l} = 1$$
$${F}_{orbital} = \frac{2}{3} \frac{{ℏ}^{2}}{4 {m}_{e} {r}_{0}^{3}} \sqrt{s ( s + 1 )} {i}_{r} , and {S}_{p}$$
$${F}_{orbital} = \frac{1}{2} \frac{{ℏ}^{2}}{4 {m}_{e} {r}_{0}^{3}} \sqrt{s ( s + 1 )} {i}_{r} .$$

5. The method of claim 4, wherein the force balance and corresponding radius of the hyperbolic electron is at least one of
$$l = 1 {m}_{l} = 0$$
$$\frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )}$$
$${r}_{0} = {a}_{0} ( 1 - ( 1 + \frac{1}{6} ) \frac{\sqrt{\frac{3}{4}}}{2} ) = 0.4948 {a}_{o}$$
$$l = 1 {m}_{l} = 1$$
$$\frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )}$$
$${r}_{0} = {a}_{0} ( 1 - ( 1 + \frac{1}{3} ) \frac{\sqrt{\frac{3}{4}}}{2} ) = 0.4226 {a}_{o}$$
$${S}_{p}$$
$$\frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + \frac{1}{2} \frac{{ℏ}^{2}}{4 {m}_{e} {r}_{0}^{3}} \sqrt{s ( s + 1 )}$$
$${r}_{0} = {a}_{0} ( 1 - ( 1 + \frac{1}{4} ) \frac{\sqrt{\frac{3}{4}}}{2} ) = 0.4587 {a}_{o}$$
$$Linear combination : ( l = 0 {m}_{l} = 0 ) + ( l = 1 {m}_{l} = 0 )$$
$$\frac{{ℏ}^{2}}{{m}_{e} {r}^{3}} = \frac{{e}^{2}}{4 {πɛ}_{0} {r}^{2}} + 0.5 ( \frac{{ℏ}^{2}}{2 {m}_{e} {r}^{3}} \sqrt{s ( s + 1 )} + \frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )} )$$
$${r}_{0} = {a}_{0} ( 1 - ( 1 + \frac{1}{12} ) \frac{\sqrt{\frac{3}{4}}}{2} ) = 0.5309 {a}_{o}$$
$$Linear combination : {S}_{p} + ( l = 1 {m}_{l} = 0 )$$
$$\frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + 0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} )$$
$${r}_{0} = {a}_{0} ( 1 - ( 1 + \frac{1}{8} + \frac{1}{12} ) \frac{\sqrt{\frac{3}{4}}}{2} ) = 0.4768 {a}_{o}$$
$$Linear combination : {S}_{p} + ( l = 1 {m}_{l} = 1 )$$
$$\frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + 0.5 ( \frac{1}{2} \frac{{ℏ}^{2}}{4 {m}_{e} {r}_{0}^{3}} \sqrt{s ( s + 1 )} + \frac{2}{3} \frac{{ℏ}^{2}}{4 {m}_{e} {r}_{0}^{3}} \sqrt{s ( s + 1 )} )$$
$${r}_{0} = {a}_{0} ( 1 - ( 1 + \frac{1}{8} + \frac{1}{6} ) \frac{\sqrt{\frac{3}{4}}}{2} ) = 0.4407 {a}_{o}$$
$$Linear combination : ( {S}_{p} + l = 1 {m}_{l} = 0 ) + ( l = 1 {m}_{l} = 0 )$$
$$\frac{{ℏ}^{2}}{{m}_{e} {r}^{3}} = ( \begin{matrix}\frac{{e}^{2}}{4 {πɛ}_{0} {r}^{2}} + \frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )} + \\ 0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} )\end{matrix} )$$
$${r}_{0} = {a}_{0} ( 1 - ( 1 + \frac{1}{6} + \frac{1}{8} + \frac{1}{12} ) \frac{\sqrt{\frac{3}{4}}}{2} ) = 0.4046 {a}_{o}$$
$$Linear combination : ( ( ( {S}_{p} + l = 1 {m}_{l} = 0 ) + ( l = 1 {m}_{l} = 0 ) ) + ( l = 1 {m}_{l} = 1 ) )$$
$$\frac{{ℏ}^{2}}{{m}_{e} {r}^{3}} = ( \begin{matrix}\frac{{e}^{2}}{4 {πɛ}_{0} {r}^{2}} + 0.5 ( \begin{matrix}\frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )} + \\ \frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )}\end{matrix} ) + \\ 0.5 ( 0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} ) )\end{matrix} )$$
$${r}_{0} = {a}_{0} ( 1 - ( \frac{1}{2} + \frac{1}{12} + \frac{1}{2} + \frac{1}{6} + \frac{1}{16} + \frac{1}{24} ) \frac{\sqrt{\frac{3}{4}}}{2} ) = 0.4136 {a}_{o}$$
$$Linear combination : ( ( ( {S}_{p} + l = 1 {m}_{l} = 0 ) + ( l = 1 {m}_{l} = 0 ) ) + ( ( {S}_{p} + l = 1 {m}_{l} = 1 ) + ( l = 1 {m}_{l} = 0 ) ) )$$
$$\frac{{ℏ}^{2}}{{m}_{e} {r}^{3}} = ( \begin{matrix}\frac{{e}^{2}}{4 {πɛ}_{0} {r}^{2}} + 0.5 ( \begin{matrix}\frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )} + \\ \frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )}\end{matrix} ) + \\ 0.5 ( \begin{matrix}0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} ) + \\ 0.5 ( \frac{1}{2} \frac{{ℏ}^{2}}{4 {m}_{e} {r}_{0}^{3}} \sqrt{s ( s + 1 )} + \frac{2}{3} \frac{{ℏ}^{2}}{4 {m}_{e} {r}_{0}^{3}} \sqrt{s ( s + 1 )} )\end{matrix} )\end{matrix} )$$
$${r}_{0} = {a}_{0} ( 1 - ( \frac{1}{2} + \frac{1}{12} + \frac{1}{2} + \frac{1}{12} + \frac{1}{16} + \frac{1}{24} + \frac{1}{16} + \frac{1}{12} ) \frac{\sqrt{\frac{3}{4}}}{2} ) = 0.3866 {a}_{o}$$
$$Linear combination : ( {S}_{p} + l = 1 {m}_{l} = 1 ) + ( l = 1 {m}_{l} = 0 )$$
$$\frac{{ℏ}^{2}}{{m}_{e} {r}^{3}} = ( \begin{matrix}\frac{{e}^{2}}{4 {πɛ}_{0} {r}^{2}} + \frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )} + \\ 0.5 ( \frac{1}{2} \frac{{ℏ}^{2}}{4 {m}_{e} {r}_{0}^{3}} \sqrt{s ( s + 1 )} + \frac{2}{3} \frac{{ℏ}^{2}}{4 {m}_{e} {r}_{0}^{3}} \sqrt{s ( s + 1 )} )\end{matrix} )$$
$${r}_{0} = {a}_{0} ( 1 - ( 1 + \frac{1}{6} + \frac{1}{8} + \frac{1}{6} ) \frac{\sqrt{\frac{3}{4}}}{2} ) = 0.3685 {a}_{o}$$
$$Linear combination : ( ( ( {S}_{p} + l = 1 {m}_{l} = 1 ) + ( l = 1 {m}_{l} = 0 ) ) + ( ( {S}_{p} + l = 1 {m}_{l} = 0 ) + ( l = 1 {m}_{l} = 1 ) ) )$$
$$\frac{{ℏ}^{2}}{{m}_{e} {r}^{3}} = ( \begin{matrix}\frac{{e}^{2}}{4 {πɛ}_{0} {r}^{2}} + 0.5 ( \begin{matrix}\frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )} + \\ \frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )}\end{matrix} ) + \\ 0.5 ( \begin{matrix}0.5 ( \frac{1}{2} \frac{{ℏ}^{2}}{4 {m}_{e} {r}_{0}^{3}} \sqrt{s ( s + 1 )} + \frac{2}{3} \frac{{ℏ}^{2}}{4 {m}_{e} {r}_{0}^{3}} \sqrt{s ( s + 1 )} ) + \\ 0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} )\end{matrix} )\end{matrix} )$$
$${r}_{0} = {a}_{0} ( 1 - ( \frac{1}{2} + \frac{1}{12} + \frac{1}{2} + \frac{1}{6} + \frac{1}{16} + \frac{1}{12} + \frac{1}{16} + \frac{1}{24} ) \frac{\sqrt{\frac{3}{4}}}{2} ) = 0.3505 {a}_{o}$$
$$Linear combination : ( {S}_{p} + l = 1 {m}_{l} = 0 ) + ( l = 1 {m}_{l} = 1 )$$
$$\frac{{ℏ}^{2}}{{m}_{e} {r}^{3}} = ( \begin{matrix}\frac{{e}^{2}}{4 {πɛ}_{0} {r}^{2}} + \frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )} + \\ 0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} )\end{matrix} )$$
$${r}_{0} = {a}_{0} ( 1 - ( 1 + \frac{1}{3} + \frac{1}{8} + \frac{1}{12} ) \frac{\sqrt{\frac{3}{4}}}{2} ) = 0.3324 {a}_{o}$$
$$Linear combination : ( ( ( {S}_{p} + l = 1 {m}_{l} = 0 ) + ( l = 1 {m}_{l} = 1 ) ) + ( ( {S}_{p} + l = 1 {m}_{l} = 1 ) + ( l = 1 {m}_{l} = 1 ) ) )$$
$$\frac{{ℏ}^{2}}{{m}_{e} {r}^{3}} = ( \begin{matrix}\frac{{e}^{2}}{4 {πɛ}_{0} {r}^{2}} + 0.5 ( \begin{matrix}\frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )} + \\ \frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )}\end{matrix} ) + \\ 0.5 ( \begin{matrix}0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} ) + \\ 0.5 ( \frac{1}{2} \frac{{ℏ}^{2}}{4 {m}_{e} {r}_{0}^{3}} \sqrt{s ( s + 1 )} + \frac{2}{3} \frac{{ℏ}^{2}}{4 {m}_{e} {r}_{0}^{3}} \sqrt{s ( s + 1 )} )\end{matrix} )\end{matrix} )$$
$${r}_{0} = {a}_{0} ( 1 - ( \frac{1}{2} + \frac{1}{6} + \frac{1}{2} + \frac{1}{6} + \frac{1}{16} + \frac{1}{24} + \frac{1}{16} + \frac{1}{12} ) \frac{\sqrt{\frac{3}{4}}}{2} ) = 0.3144 {a}_{o}$$
$$and$$
$$Linear combination : ( {S}_{p} + l = 1 {m}_{l} = 1 ) + ( l = 1 {m}_{l} = 1 )$$
$$\frac{{ℏ}^{2}}{{m}_{e} {r}^{3}} = ( \begin{matrix}\frac{{e}^{2}}{4 {πɛ}_{0} {r}^{2}} + \frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )} + \\ 0.5 ( \frac{1}{2} \frac{{ℏ}^{2}}{4 {m}_{e} {r}_{0}^{3}} \sqrt{s ( s + 1 )} + \frac{2}{3} \frac{{ℏ}^{2}}{4 {m}_{e} {r}_{0}^{3}} \sqrt{s ( s + 1 )} )\end{matrix} )$$
$${r}_{0} = {a}_{0} ( 1 - ( 1 + \frac{1}{3} + \frac{1}{8} + \frac{1}{6} ) \frac{\sqrt{\frac{3}{4}}}{2} ) = 0.2964 {a}_{o}$$

6. The method of claim 5, wherein at least one of the radius of the incident electron (cylindrical coordinates) and the hyperbolic electron (spherical coordinates) in units of the Bohr radius a₀ is at least one of 0.5670, 0.5309, 0.4948, 0.4768, 0.4587, 0.4407, 0.4226, 0.4136, 0.4046, 0.3866, 0.3685, 0.3505, 0.3324, 0.3144, and 0.2964.

7. The method of claim 6, wherein the velocity of the incident electron is given by
$${v}_{z} = \frac{ℏ}{{m}_{e} {ρ}_{o}}$$
where ρₒ is the radius of the corresponding hyperbolic electron.

8. The method of claim 7, wherein the velocity of the incident electron in units of 10⁶ m/s is at least one of 3.8584, 4.1207, 4.4212, 4.5885, 4.7690, 4.9642, 5.1761, 5.2890, 5.4069, 5.6593, 5.9364, 6.2420, 6.5807, 6.9584, and 7.3820.

9. The method of claim 6, wherein the kinetic energy of the incident electron is given by
$$T = \frac{1}{2} {m}_{e} {v}_{z}^{2}$$
where the electron velocity is v_{z}.

10. The method of claim 9, wherein the kinetic energy T of the incident electron in units of eV is at least one of 42.32, 48.27, 55.57, 59.85, 64.65, 70.06, 76.17, 79.52, 83.11, 91.05, 100.18, 110.76, 123.11, 137.65, and 154.92.

11. The method of claim 10, wherein the quantum numbers of the n=1 hyperbolic-electronic state is at least one of l=0 mₗ=0, (l=0 mₗ=0)+(l=1 mₗ=0), l=1 mₗ=0, Sₚ+(l=1 mₗ=0), Sₚ, Sₚ+(l=1 mₗ=1), l=1 mₗ=1, (((Sₚ+l=1 mₗ=0)+(l=1 mₗ=0))+(l=1 mₗ=1)), (Sₚ+l=1 mₗ=0)+(l=1 mₗ=0), (((Sₚ+l=1 mₗ=0)+(l=1 mₗ=0))+((Sₚ+l=1 mₗ=1)+(l=1 mₗ=0))), (Sₚ+l=1 mₗ=1)+(l=1 mₗ=0), (Sₚ+l=1 mₗ=1)+(l=1 mₗ=0), (((Sₚ+l=1 mₗ=1)+(l=1 mₗ=0))+((Sₚ+l=1 mₗ=0)+(l=1 mₗ=1))), (((Sₚ+l=1 mₗ=1)+(l=1 mₗ=0))+((Sₚ+l=1 mₗ=0)+(l=1 mₗ=1))), (Sₚ+l=1 mₗ=0)+(l=1 mₗ32 1), (Sₚ+l=1 mₗ=0)+(l=1 mₗ=1), (((Sₚ+l=1 mₗ=0)+(l=1 mₗ=1))+((Sₚ+l=1 mₗ=1)+(l=1 mₗ=1))), and (Sₚ+l=1 mₗ=1)+(l=1 mₗ=1).

12. The method of claim 11, wherein the hyperbolic electron is formed by inelastic scattering wherein the difference between the incidence energy Eᵢ and the excitation energy Eₗₒₛₛ of the species with which the free electron collides is one of the resonant production energies T, one of the resonance incident kinetic energies.

13. The method of claim 12, wherein the kinetic energy of the incident electron Eᵢ satisfies the relationship Eᵢ−Eₗₒₛₛ=T wherein T in units of eV is at least one of 42.32, 48.27, 55.57, 59.85, 64.65, 70.06, 76.17, 79.52, 83.11, 91.05, 100.18, 110.76, 123.11, 137.65, and 154.92.

14. The method of claim 2, wherein the electron beam is provided by an electron gun of adjustable energy.

15. The method of claim 2, wherein the atomic or molecular beam comprises at least one of helium, neon, argon, krypton, xenon, hydrogen and nitrogen.

16. The method of claim 1, wherein the step of receiving said repulsive fifth force on said field source from said hyperbolic electron in response to the force provided by said gravitating mass and said hyperbolic electron comprises,
providing an electric field which produces a force on the said hyperbolic electron which is in a direction opposite that of the force of the gravitating body on the hyperbolic electron.

17. The method of claim 16, further including the step of applying the received repulsive force to a structure movable in relation to said gravitating means.

18. The method of claim 17, further including the step of rotating said structure around an axis providing an angular momentum vector of said circularly rotating structure parallel to the central vector of the gravitational force by said gravitating mass.

19. The method of claim 18, further including the step of changing the orientation of said angular momentum vector to accelerate said structure through a trajectory substantially parallel to the surface of said gravitating mass.

20. Apparatus for providing lift from a gravitating body comprising:
a free electron;
means of applying energy to said free electron;
means of forming a hyperbolic electron wherein a repulsive force away from said gravitating mass is created;
means of applying a field to said hyperbolic electron;
a repulsive force developed by said hyperbolic electron in response to said applied field is impressed on said means for applying the field in a direction away from said gravitating body.

21. The apparatus of claim 20, wherein the means of forming comprises
an electron beam and a neutral atomic or molecular beam;
wherein the beams intersect such that the electrons form hyperbolic electrons.

22. The apparatus of claim 21, wherein
the radius of at least one of each incident and hyperbolic electron is given by the force balance equation according to
$${F}_{centifugal} = {F}_{Coulombic} + \sum {F}_{mag}$$
$$\frac{{ℏ}^{2}}{{m}_{e} {r}^{3}} = \frac{{e}^{2}}{4 {πɛ}_{0} {r}^{2}} + \sum {F}_{mag}$$
where F_{centrifugal} is the centrifugal force, F_{Coulombic} is the Coulombic force, and ΣF_{mag} is the sum of the magnetic forces.

23. The apparatus of claim 22, wherein the magnetic force is at least one of or a linear combination of one or more of
$${F}_{orbital} = {\sum }_{m} \frac{( l + \vert m \vert ) !}{( 2 l + 1 ) ( l - \vert m \vert ) !} \frac{{ℏ}^{2}}{4 {m}_{e} {r}_{0}^{3}} \sqrt{s ( s + 1 )} {i}_{r}$$
$$For l = 1 {m}_{l} = 0$$
$${F}_{orbital} = \frac{1}{3} \frac{{ℏ}^{2}}{4 {m}_{e} {r}_{0}^{3}} \sqrt{s ( s + 1 )} {i}_{r}$$
$$For l = 1 {m}_{l} = 1$$
$${F}_{orbital} = \frac{2}{3} \frac{{ℏ}^{2}}{4 {m}_{e} {r}_{0}^{3}} \sqrt{s ( s + 1 )} {i}_{r} , and {S}_{p}$$
$${F}_{orbital} = \frac{1}{2} \frac{{ℏ}^{2}}{4 {m}_{e} {r}_{0}^{3}} \sqrt{s ( s + 1 )} {i}_{r} .$$

24. The apparatus of claim 23, wherein the force balance and corresponding radius of the hyperbolic electron is at least one of
$$l = 1 {m}_{l} = 0$$
$$\frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )}$$
$${r}_{0} = {a}_{0} ( 1 - ( 1 + \frac{1}{6} ) \frac{\sqrt{\frac{3}{4}}}{2} ) = 0.4948 {a}_{o}$$
$$l = 1 {m}_{l} = 1$$
$$\frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )}$$
$${r}_{0} = {a}_{0} ( 1 - ( 1 + \frac{1}{3} ) \frac{\sqrt{\frac{3}{4}}}{2} ) = 0.4226 {a}_{o}$$
$${S}_{p}$$
$$\frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + \frac{1}{2} \frac{{ℏ}^{2}}{4 {m}_{e} {r}_{0}^{3}} \sqrt{s ( s + 1 )}$$
$${r}_{0} = {a}_{0} ( 1 - ( 1 + \frac{1}{4} ) \frac{\sqrt{\frac{3}{4}}}{2} ) = 0.4587 {a}_{o}$$
$$Linear combination : ( l = 0 {m}_{l} = 0 ) + ( l = 1 {m}_{l} = 0 )$$
$$\frac{{ℏ}^{2}}{{m}_{e} {r}^{3}} = \frac{{e}^{2}}{4 {πɛ}_{0} {r}^{2}} + 0.5 ( \frac{{ℏ}^{2}}{2 {m}_{e} {r}^{3}} \sqrt{s ( s + 1 )} + \frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )} )$$
$${r}_{0} = {a}_{0} ( 1 - ( 1 + \frac{1}{12} ) \frac{\sqrt{\frac{3}{4}}}{2} ) = 0.5309 {a}_{o}$$
$$Linear combination : {S}_{p} + ( l = 1 {m}_{l} = 0 )$$
$$\frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + 0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} )$$
$${r}_{0} = {a}_{0} ( 1 - ( 1 + \frac{1}{8} + \frac{1}{12} ) \frac{\sqrt{\frac{3}{4}}}{2} ) = 0.4768 {a}_{o}$$
$$Linear combination : {S}_{p} + ( l = 1 {m}_{l} = 1 )$$
$$\frac{{ℏ}^{2}}{{m}_{e} {r}^{3}} = \frac{{e}^{2}}{4 {πɛ}_{0} {r}^{2}} + \frac{{ℏ}^{2}}{2 {m}_{e} {r}^{3}} \sqrt{s ( s + 1 )} + 0.5 ( \frac{1}{2} \frac{{ℏ}^{2}}{4 {m}_{e} {r}_{0}^{3}} \sqrt{s ( s + 1 )} + \frac{2}{3} \frac{{ℏ}^{2}}{4 {m}_{e} {r}_{0}^{3}} \sqrt{s ( s + 1 )} )$$
$${r}_{0} = {a}_{0} ( 1 - ( 1 + \frac{1}{8} + \frac{1}{6} ) \frac{\sqrt{\frac{3}{4}}}{2} ) = 0.4407 {a}_{o}$$
$$Linear combination : ( {S}_{p} + l = 1 {m}_{l} = 0 ) + ( l = 1 {m}_{l} = 0 )$$
$$\frac{{ℏ}^{2}}{{m}_{e} {r}^{3}} = ( \begin{matrix}\frac{{e}^{2}}{4 {πɛ}_{0} {r}^{2}} + \frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )} + \\ 0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} )\end{matrix} )$$
$${r}_{0} = {a}_{0} ( 1 - ( 1 + \frac{1}{6} + \frac{1}{8} + \frac{1}{12} ) \frac{\sqrt{\frac{3}{4}}}{2} ) = 0.4046 {a}_{o}$$
$$Linear combination : ( ( ( {S}_{p} + l = 1 {m}_{l} = 0 ) + ( l = 1 {m}_{l} = 0 ) ) + ( l = 1 {m}_{l} = 1 ) )$$
$$\frac{{ℏ}^{2}}{{m}_{e} {r}^{3}} = ( \begin{matrix}\frac{{e}^{2}}{4 {πɛ}_{0} {r}^{2}} + 0.5 ( \begin{matrix}\frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )} + \\ \frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )}\end{matrix} ) + \\ 0.5 ( 0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} ) )\end{matrix} )$$
$${r}_{0} = {a}_{0} ( 1 - ( \frac{1}{2} + \frac{1}{12} + \frac{1}{2} + \frac{1}{6} + \frac{1}{16} + \frac{1}{24} ) \frac{\sqrt{\frac{3}{4}}}{2} ) = 0.4136 {a}_{o}$$
$$Linear combination : ( ( ( {S}_{p} + l = 1 {m}_{l} = 0 ) + ( l = 1 {m}_{l} = 0 ) ) + ( ( {S}_{p} + l = 1 {m}_{l} = 1 ) + ( l = 1 {m}_{l} = 0 ) ) )$$
$$\frac{{ℏ}^{2}}{{m}_{e} {r}^{3}} = ( \begin{matrix}\frac{{e}^{2}}{4 {πɛ}_{0} {r}^{2}} + 0.5 ( \begin{matrix}\frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )} + \\ \frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )}\end{matrix} ) + \\ 0.5 ( \begin{matrix}0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} ) + \\ 0.5 ( \frac{1}{2} \frac{{ℏ}^{2}}{4 {m}_{e} {r}_{0}^{3}} \sqrt{s ( s + 1 )} + \frac{2}{3} \frac{{ℏ}^{2}}{4 {m}_{e} {r}_{0}^{3}} \sqrt{s ( s + 1 )} )\end{matrix} )\end{matrix} )$$
$${r}_{0} = {a}_{0} ( 1 - ( \frac{1}{2} + \frac{1}{12} + \frac{1}{2} + \frac{1}{12} + \frac{1}{16} + \frac{1}{24} + \frac{1}{16} + \frac{1}{12} ) \frac{\sqrt{\frac{3}{4}}}{2} ) = 0.3866 {a}_{o}$$
$$Linear combination : ( {S}_{p} + l = 1 {m}_{l} = 1 ) + ( l = 1 {m}_{l} = 0 )$$
$$\frac{{ℏ}^{2}}{{m}_{e} {r}^{3}} = ( \begin{matrix}\frac{{e}^{2}}{4 {πɛ}_{0} {r}^{2}} + \frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )} + \\ 0.5 ( \frac{1}{2} \frac{{ℏ}^{2}}{4 {m}_{e} {r}_{0}^{3}} \sqrt{s ( s + 1 )} + \frac{2}{3} \frac{{ℏ}^{2}}{4 {m}_{e} {r}_{0}^{3}} \sqrt{s ( s + 1 )} )\end{matrix} )$$
$${r}_{0} = {a}_{0} ( 1 - ( 1 + \frac{1}{6} + \frac{1}{8} + \frac{1}{6} ) \frac{\sqrt{\frac{3}{4}}}{2} ) = 0.3685 {a}_{o}$$
$$Linear combination : ( ( ( {S}_{p} + l = 1 {m}_{l} = 1 ) + ( l = 1 {m}_{l} = 0 ) ) + ( ( {S}_{p} + l = 1 {m}_{l} = 0 ) + ( l = 1 {m}_{l} = 1 ) ) )$$
$$\frac{{ℏ}^{2}}{{m}_{e} {r}^{3}} = ( \begin{matrix}\frac{{e}^{2}}{4 {πɛ}_{0} {r}^{2}} + 0.5 ( \begin{matrix}\frac{{ℏ}^{2}}{2 {m}_{e} {r}^{3}} \sqrt{s ( s + 1 )} + \frac{1}{3} \frac{{ℏ}^{2}}{4 {m}_{e} {r}_{0}^{3}} \sqrt{s ( s + 1 )} + \\ \frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )}\end{matrix} ) + \\ 0.5 ( \begin{matrix}0.5 ( \frac{1}{2} \frac{{ℏ}^{2}}{4 {m}_{e} {r}_{0}^{3}} \sqrt{s ( s + 1 )} + \frac{2}{3} \frac{{ℏ}^{2}}{4 {m}_{e} {r}_{0}^{3}} \sqrt{s ( s + 1 )} ) + \\ 0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} )\end{matrix} )\end{matrix} )$$
$${r}_{0} = {a}_{0} ( 1 - ( \frac{1}{2} + \frac{1}{12} + \frac{1}{2} + \frac{1}{6} + \frac{1}{16} + \frac{1}{12} + \frac{1}{16} + \frac{1}{24} ) \frac{\sqrt{\frac{3}{4}}}{2} ) = 0.3505 {a}_{o}$$
$$Linear combination : ( {S}_{p} + l = 1 {m}_{l} = 0 ) + ( l = 1 {m}_{l} = 1 )$$
$$\frac{{ℏ}^{2}}{{m}_{e} {r}^{3}} = ( \begin{matrix}\frac{{e}^{2}}{4 {πɛ}_{0} {r}^{2}} + \frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )} + \\ 0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} )\end{matrix} )$$
$${r}_{0} = {a}_{0} ( 1 - ( 1 + \frac{1}{3} + \frac{1}{8} + \frac{1}{12} ) \frac{\sqrt{\frac{3}{4}}}{2} ) = 0.3324 {a}_{o}$$
$$Linear combination : ( ( ( {S}_{p} + l = 1 {m}_{l} = 0 ) + ( l = 1 {m}_{l} = 1 ) ) + ( ( {S}_{p} + l = 1 {m}_{l} = 1 ) + ( l = 1 {m}_{l} = 1 ) ) )$$
$$\frac{{ℏ}^{2}}{{m}_{e} {r}^{3}} = ( \begin{matrix}\frac{{e}^{2}}{4 {πɛ}_{0} {r}^{2}} + 0.5 ( \begin{matrix}\frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )} + \\ \frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )}\end{matrix} ) + \\ 0.5 ( \begin{matrix}0.5 ( \frac{1}{2} \frac{{ℏ}^{2}}{4 {m}_{e} {r}_{0}^{3}} \sqrt{s ( s + 1 )} + \frac{1}{3} \frac{{ℏ}^{2}}{4 {m}_{e} {r}_{0}^{3}} \sqrt{s ( s + 1 )} ) + \\ 0.5 ( \frac{1}{2} \frac{{ℏ}^{2}}{4 {m}_{e} {r}_{0}^{3}} \sqrt{s ( s + 1 )} + \frac{2}{3} \frac{{ℏ}^{2}}{4 {m}_{e} {r}_{0}^{3}} \sqrt{s ( s + 1 )} )\end{matrix} )\end{matrix} )$$
$${r}_{0} = {a}_{0} ( 1 - ( \frac{1}{2} + \frac{1}{6} + \frac{1}{2} + \frac{1}{6} + \frac{1}{16} + \frac{1}{24} + \frac{1}{16} + \frac{1}{12} ) \frac{\sqrt{\frac{3}{4}}}{2} ) = 0.3144 {a}_{o}$$
$$and$$
$$Linear combination : ( {S}_{p} + l = 1 {m}_{l} = 1 ) + ( l = 1 {m}_{l} = 1 )$$
$$\frac{{ℏ}^{2}}{{m}_{e} {r}^{3}} = ( \begin{matrix}\frac{{e}^{2}}{4 {πɛ}_{0} {r}^{2}} + \frac{{ℏ}^{2}}{2 {m}_{e} {r}^{3}} \sqrt{s ( s + 1 )} + \frac{2}{3} \frac{{ℏ}^{2}}{4 {m}_{e} {r}_{0}^{3}} \sqrt{s ( s + 1 )} + \\ 0.5 ( \frac{1}{2} \frac{{ℏ}^{2}}{4 {m}_{e} {r}_{0}^{3}} \sqrt{s ( s + 1 )} + \frac{2}{3} \frac{{ℏ}^{2}}{4 {m}_{e} {r}_{0}^{3}} \sqrt{s ( s + 1 )} )\end{matrix} )$$
$${r}_{0} = {a}_{0} ( 1 - ( 1 + \frac{1}{3} + \frac{1}{8} + \frac{1}{6} ) \frac{\sqrt{\frac{3}{4}}}{2} ) = 0.2964 {a}_{o}$$

25. The apparatus of claim 24, wherein at least one of the radius of the incident electron (cylindrical coordinates) and the hyperbolic electron (spherical coordinates) in units of the Bohr radius a₀ is at least one of 0.5670, 0.5309, 0.4948, 0.4768, 0.4587, 0.4407, 0.4226, 0.4136, 0.4046, 0.3866, 0.3685, 0.3505, 0.3324, 0.3144, and 0.2964.

26. The apparatus of claim 25, wherein the velocity of the incident electron is given by
$${v}_{z} = \frac{ℏ}{{m}_{e} {ρ}_{o}}$$
where ρₒ is the radius of the corresponding hyperbolic electron.

27. The apparatus of claim 26, wherein the velocity of the incident electron in units of 10⁶ m/s is at least one of 3.8584, 4.1207, 4.4212, 4.5885, 4.7690, 4.9642, 5.1761, 5.2890, 5.4069, 5.6593, 5.9364, 6.2420, 6.5807, 6.9584, and 7.3820.

28. The apparatus of claim 27, wherein the kinetic energy of the incident electron is given by
$$T = \frac{1}{2} {m}_{e} {v}_{z}^{2}$$
where the electron velocity is v_{z}.

29. The apparatus of claim 28, wherein the kinetic energy T of the incident electron in units of eV is at least one of 42.32, 48.27, 55.57, 59.85, 64.65, 70.06, 76.17, 79.52, 83.11, 91.05, 100.18, 110.76, 123.11, 137.65, and 154.92.

30. The apparatus of claim 28, wherein the quantum numbers of the n=1 hyperbolic-electronic state is at least one of l=0 mₗ=0, (l=0 mₗ=0)+(l=1 mₗ=0), l=1 mₗ=0, Sₚ+(l=1 mₗ=0), Sₚ, Sₚ+(l=1 mₗ=1), l=1 mₗ=1, (((Sₚ+l=1 mₗ=0)+(l=1 mₗ=0))+(l=1 mₗ=1)), (Sₚ+l=1 mₗ=0)+(l=1 mₗ=0), (((Sₚ+l=1 mₗ=0)+(l=1 mₗ=0))+((Sₚ+l=1 mₗ=1)+(l=1 mₗ=0))), (Sₚ+l=1 mₗ=1)+(l=1 mₗ=0), (Sₚ+l=1 mₗ=1)+(l=1 mₗ=0). (((Sₚ+l=1 mₗ=1)+(l=1 mₗ=0))+((Sₚ+l=1 mₗ=0)+(l=1 mₗ=1))), (((Sₚ+l=1 mₗ=1)+(l=1 mₗ=0))+((Sₚ+l=1 mₗ=0)+(l=1 mₗ=1))), (Sₚ+l=1 mₗ=0)+(l=1 mₗ=1). (Sₚ+l=1 mₗ=0)+(l=1 mₗ=1), (((Sₚ+l=1 mₗ=0)+(l=1 mₗ=1))+((Sₚ+l=1 mₗ=1)+(l=1 mₗ=1))), and (Sₚ+l=1 mₗ=1)+(l=1 mₗ=1).

31. The apparatus of claim 30, wherein the hyperbolic electron is formed by inelastic scattering wherein the difference between the incidence energy Eᵢ and the excitation energy Eₗₒₛₛ of the species with which the free electron collides is one of the resonant production energies T, one of the resonance incident kinetic energies.

32. The method of claim 31, wherein the kinetic energy of the incident electron Eᵢ satisfies the relationship Eᵢ−Eₗₒₛₛ=T wherein T in units of eV is at least one of 42.32, 48.27, 55.57, 59.85, 64.65, 70.06, 76.17, 79.52, 83.11, 91.05, 100.18, 110.76, 123.11, 137.65, and 154.92.

33. The method of claim 21, wherein the electron beam is provided by an electron gun of adjustable energy.

34. The method of claim 21, wherein the atomic or molecular beam comprises at least one of helium, neon, argon, krypton, xenon, hydrogen and nitrogen.

35. The method of claim 20, wherein the means of applying energy from an energy source to said electron comprises,
a means to accelerate the electron.

36. The means of claim 35 to said electron comprising,
a means to provide an electric field.

37. The apparatus of claim 20, wherein the means to apply a field to provide a repulsive force against the hyperbolic electron and receive the repulsive force on said hyperbolic electron by said gravitating mass comprises,
an electric field means which produces a force on the said hyperbolic electron which is in a direction opposite that of the force of the gravitating body on the hyperbolic electron.

38. The apparatus of claim 20, further including
a circularly rotatable structure having a moment of inertia; and
means for applying said repulsive force to circulating rotatable structure, wherein
the angular momentum vector of said circularly rotatable structure is parallel to the central vector of the gravitational force produced by said gravitating body.

39. The apparatus of claim 38, further including
a means to change the orientation of said angular momentum vector to accelerate said circularly rotatable structure along a trajectory substantially parallel to the surface of said gravitating mass.

40. Apparatus for providing a repulsion from a gravitating body having:
a hyperbolic electron which experiences a repulsive force in the presence of the gravitating body; and
means for applying a field to said hyperbolic electron, wherein
a repulsive force is developed by said hyperbolic electron in response to said applied field and is impressed on said means for applying the field in a direction away from said gravitating body.
